(19) United States
(12) Patent Application Publication
(10) Pub. No.: US 2002/0171815 A1
(43) Pub. Date: Nov. 21, 2002

(54) Method for manufacturing exposure apparatus and method for manufacturing micro device

(75) Inventors: Tomoyuki Matsuyama, Saitama-ken (JP); Toru Kiuchi, Tokyo (JP); Hiroshi Chiba, Yokohama-shi (JP); Kazuyuki Kato, Toda-shi (JP)

Correspondence Address: OLIFF & BERRIDGE, PLC, P.O. Box 19928, Alexandria, VA, 22320, US

(73) Assignee: Nikon Corporation

(21) Appl. No.: 10/067,344

(22) Filed: Feb. 7, 2002

Related U.S. Application Data
(63) Continuation of application No. 09/487,996, filed on Jan. 20, 2000, now abandoned.

(30) Foreign Application Priority Data
Dec. 3, 1999 (JP) 11-345551

(51) Int. Cl. G03B 27/52

(52) U.S. Cl. 355/55; 355/53; 355/72; 355/76; 356/399; 356/401

(57) ABSTRACT

The invention includes a process which provides a projection system which projects an image of a predetermined pattern formed on a reticle to a photosensitive substrate; a setting process which sets a correction member which corrects residual aberration in the projection system at a predetermined position between a reticle setting position where the reticle is arranged and a substrate setting position where the photosensitive substrate is set; and a process which corrects degradation of optical characteristics of the projection system caused by setting the correction member at the predetermined position. Furthermore, the correction process includes a first adjusting process which adjusts at least one of the reticle setting position and the substrate setting position. Accordingly, even if a correction plate which corrects residual aberrations of the projection system is mounted into a projection optical path, deterioration of optical characteristics caused by mounting the correction plate is preferably corrected, and the invention makes it possible to manufacture an exposure apparatus equipped with a projection system adjusted in extremely high imaging quality.

### BACKGROUND OF THE INVENTION

1. Field of Invention

The invention relates to a method for manufacturing exposure apparatus and a method for manufacturing micro devices using an exposure apparatus manufactured by said method. In particular, the invention relates to a method for adjusting and manufacturing a projection system that projects a pattern of a reticle, mask or the like onto a photosensitive substrate, and to a method for manufacturing micro devices (a semiconductor element, a liquid crystal display element, a thin film magnetic head, or the like) using said exposure apparatus.

2. Description of Related Art

Currently, on a semiconductor device manufacturing scene, circuit device having a circuit pattern minimum line width of about 0.3 to 0.35 μm (256 M bit D-RAM) have been mass-produced with a reduction projection exposure apparatus, a so-called stepper, by using an i-line light having wavelength of 365 nm of a mercury lamp as an illumination light source. Simultaneously, it is under way to introduce an exposure apparatus for mass-producing the next generation device having a minimum line width less than 0.25 μm and having the integration degree such as 1 G bit D-RAM or 4 G bit D-RAM.

For the next generation circuit device, a step-and-scan projection exposure apparatus which scan-exposes the whole of a circuit pattern of a reticle to one shot area on a wafer by using an ultraviolet pulse laser beam having a wavelength of 248 nm from a KrF excimer laser light source or an ultraviolet pulse laser beam having a wavelength of 193 nm from an ArF excimer laser light source as an illumination light, and by performing one-dimensional scanning for a reticle (original version, mask substrate) and a semiconductor wafer, on which a circuit pattern is drawn relatively to a projection field of a reduction projection optical system, is a promising exposure apparatus for manufacturing a circuit device.

Such a step-and-scan projection exposure apparatus has been commercialized and marketed as a micra-scan exposure apparatus which is equipped with a reduction projection optical system composed of a dioptric element (lens component) and a catoptric element (concave mirror or the like), and is provided by Perkin Elmer Corporation. As explained in detail, for example, on pp. 424-433 in Vol. 1088 of SPIE in 1989, the micra-scan exposure apparatus exposes a shot area on a wafer by scanning and moving a reticle and the wafer at a speed ratio according to a projection magnification (reduced to one-fourth) while projecting part of the pattern of the reticle onto the wafer through an effective projection area restricted to an arc slit shape.

Additionally, as a step-and-scan projection exposure method, a method combined with the method which uses an excimer laser beam as an illumination light, restricts to a polygon (hexagon) shape the effective projection area of a reduced projection optical system having a circular projection view field, and makes both ends of the effective projection area in a non-scanning direction partially overlap, what is called, a scan-and-stitching method is known, for example, by Japanese Laid-Open Patent Application 2-229423 (U.S. Pat. No. 4,924,257). Additional examples of a projection exposure apparatus adopting such a scan-exposure method are disclosed in Japanese Laid-Open Patent Applications 4-196513 (U.S. Pat. No. 5,473,410), 4-277612 (U.S. Pat. No. 5,194,893), 4-307720 (U.S. Pat. No. 5,506,684), or the like.

With the apparatus which restricts an effective projection area of a projection optical system to an arc or a rectilinear slit shape among projection exposure apparatus of a conventional scan-exposure method, an image distortion of a pattern transferred onto a wafer as a result of scan-exposure depends on each aberration type of the projection optical system itself or an illumination condition of an illumination optical system as a matter of course. Such an image distortion became an important error budget also for a conventional stepper of a method (stationary exposure method) with which a circuit pattern image on a reticle, which is included in a projection view field, is collectively transferred in a shot area on a wafer.

Accordingly, a projection optical system mounted on a conventional stepper is optically designed so that the image distortion vector (the shifted direction and amount from the ideal position of each point image at an ideal lattice point), which occurs in each lattice point image, becomes small on average in an entire projection view field. Furthermore, lens components and optical members are processed with high accuracy, and assembled as the projection optical system by repeating complicated and time-consuming tests in order to include the image distortion vector within a tolerable range when being designed.

Therefore, to ease, however little, the difficulty in the manufacturing of such a projection optical system, which requires high accuracy, a method for actually measuring the image distortion characteristic of an assembled projection optical system, for inserting the optical correction plate (quartz plate), which is polished to partially deflect the principal light beam passing through each point in a projection view field, in a projection optical path so that the measured image distortion characteristic becomes a minimum at each point in the projection field is disclosed, for example, by Japanese Laid-Open Patent Application 8-203805 (European Laid-Open Patent Publication 0 724 199A1).

Additionally, Japanese Laid-Open Patent Application 6-349702 discloses a method for adjusting aberration characteristics of a projection optical system by rotating some lens components configuring the projection optical system about an optical axis in order to improve the image distortion characteristic occurring in a resist image on a photosensitive substrate, which is transferred by scan-exposure. Furthermore, as disclosed by Japanese Laid-Open Patent Applications 4-127514 (U.S. Pat. No. 5,117,255) and 4-134813 (U.S. Pat. No. 5,117,255), it is also known that a projection magnification, a distortion, and the like are adjusted by infinitesimally moving some lens components configuring a projection optical system.

However, even if an aberration characteristic is adjusted by rotating some lens components configuring a projection optical system or by decentering or tilting an opdical axis, this does not always guarantee that a satisfactory aberration characteristic (image distortion characteristic) can be obtained. Furthermore, such an adjusting method makes it difficult to keep stable accuracy, and the adjustment procedure is more likely to be a trial-and-error method and troublesome. The worst thing for the adjustment procedure is that although it is possible to uniformly adjust and modify image distortion characteristics as a whole to become certain characteristics within an effective projection area of the projection optical system, it is difficult to partially adjust and modify only the local image distortion within the effective projection area.

Therefore, if the optical correction plate disclosed by Japanese Laid-Open Application 8-203805 (European Laid-Open Patent Application 0724 199A1) is manufactured and inserted in a projection optical path, it is anticipated that a local image distortion characteristic within an effective projection area can be easily improved. However, the conventional optical correction plate explained in Japanese Laid-Open Patent Application 8-203805 (European Laid-Open Patent Application 0724 199A1) is not assumed to be applied to the projection optical system used for scan-exposure. Accordingly, if an optical correction plate is manufactured by the method disclosed here, as it is, its design and manufacturing become extremely complicated. In particular, the accuracy for processing the shape of a local surface of the optical correction plate with a wavelength order (order of nanometer to micrometer) becomes stricter.

Then, Japanese Laid-Open Patent Application 11-45842 (PCT Publication WO 99/05709) discloses a method to easily reduce image distortion produced while performing scanning exposure by using a projection optical system equipped with an optical correction plate suitable for a scanning exposure method. In detail, when a pattern of a reticle is scan-exposed on a photosensitive substrate by a projection exposure apparatus, in consideration of the fact that a static image distortion characteristic in the scanning direction within the effective projection area is averaged, and becomes a dynamic image distortion characteristic, at least a random component of the dynamic image distortion characteristic is corrected by mounting an image distortion correction plate, made by locally polishing a surface of a transparent plane parallel plate, in the projection optical path. Additionally, in aberrations other than distortion, a dynamic aberration characteristic is corrected in the same way in consideration of the fact that the static aberration characteristic is averaged at the time of scan-exposure, and becomes a dynamic distortion characteristic.

According to conventional methods disclosed in the aforementioned Japanese Laid-Open Patent Application 8-203805 (European Laid-Open Patent Application 0724 199A1) and Japanese Laid-Open Patent Application 11-45842 (PCT Publication WO 99/05709), the projection optical system is designed on the assumption of mounting an optical correction plate. In other words, an optical correction plate is included in the projection optical system as a constituent member in advance.

However, on the occasion of manufacturing an exposure apparatus, a projection optical system thereof is not always designed and manufactured on the assumption of mounting an optical correction plate. Rather, it there is the a case that each optical member composing a projection optical system designed for satisfying sufficient optical characteristics (aberration characteristics or the like) is manufactured and assembled with high precision, and, as a result, there are cases that desired optical characteristics can be obtained. In this case, not only is an optical correction plate not necessary to be mounted, but mounting of an optical correction plate also had better be avoided in order to simplify the construction.

In practice, on the occasion of assembling a single projection optical system, lens components and optical members are adjusted in a way called the reduction correction by infinitesimally moving them so that each aberration can be reduced to “0” as close as possible. Further, on attaching the lens barrel of the projection optical system to the main body of the apparatus, linear aberration (aberration characteristics able to be approximated by function) is removed as much as possible by infinitesimally adjusting the position of lens component and optical members in the lens barrel. Mounting an optical correction plate disclosed in Japanese Laid-Open Patent Application 8-203805 (European Laid-Open Patent Application 0724 199A1) or Japanese Laid-Open Patent Application 11-45842 (PCT Publication WO 99/05709) is required only when a random aberration component (random distortion component unable to be approximated by function) having no directionality or regularity relative to the basic optical axis after the aforementioned reduction correction and infinitesimal adjustment are performed.

Accordingly, on the occasion of manufacturing an exposure apparatus, a projection optical system thereof is not normally designed on the assumption of mounting an optical correction plate. In this kind of exposure apparatus, if unallowable random aberration components remain in the projection optical system after the above-mentioned reduction correction and infinitesimal adjustment are performed, it is necessary to mount an optical correction plate in order to correct the remaining random components. In other words, an optical correction plate is mounted on a projection optical system that designed on the assumption of mounting no optical correction plate. As a result, the variation in object-to-image distance caused by inserting an optical correction plate having a predetermined optical thickness into the projection optical path of the projection optical system causes degradation of optical characteristics (aberration characteristics and the like) of the projection optical system.

Meanwhile, there is a case that a micro device with high specifications having improved integration degree and minuteness cannot be manufactured anymore by an exposure apparatus, which had previously been sold to device manufacturers. In this case, the micro device with high specifications cannot be manufactured unless the specifications (imaging quality) of the projection optical system is improved by further correcting the designed optical errors (designed residual aberration components) of the projection optical system, in other words, unless measures to make a retrofit are taken. At this time, the method of mounting the above-mentioned optical correction plate on an already-existed projection optical system is conceivable as a method for further correcting the designed optical errors of the projection optical system. In this case also, since an optical correction plate, which is a completely different member, is newly added to a projection optical system designed on the assumption of mounting an optical correction plate, the optical characteristics of the projection optical system becomes worse.

The invention reflects on the aforementioned problems and has an object to provide a method for manufacturing an exposure apparatus equipped with a projection system adjusted in extremely high imaging quality, even when an optical correction plate is mounted into a projection optical path in order to correct residual aberrations of the projection system, by correcting deterioration of optical characteristics of the projection system caused by mounting the optical correction plate.

It is also an object of the invention to provide a method for manufacturing a micro device, by the using an exposure apparatus manufactured by the above-mentioned method, capable of exposing a reticle pattern onto a photosensitive substrate with extremely high fidelity through a projection system with extremely high imaging characteristics.

### SUMMARY OF THE INVENTION

The invention is made in view of the aforementioned problems. A first aspect of the invention provides a method for manufacturing an exposure apparatus comprising the steps of:

a providing step for providing a projection system projecting and exposing an image of a predetermined pattern formed on a reticle to a photosensitive substrate;

a setting step for setting a correction member correcting residual aberration in said projection system on a predetermined position between a reticle setting position where said reticle is set and a substrate setting position where said photosensitive substrate is set; and

a correcting step for correcting degradation of optical characteristic of said projection system caused by setting said correction member on said predetermined position;

wherein said correcting step includes a first adjusting step for adjusting at least one of said reticle setting position and said substrate setting position.

In one preferred embodiment of the first invention, it is preferable that said correcting step further includes a second adjusting step for adjusting said projection system for correcting degradation of said optical characteristic unable to be corrected by said first adjusting step.

Further, it is preferable that said correcting step further includes a first calculating step, prior to said setting step, for calculating an adjusting amount of at least one of said reticle setting position and said substrate setting position in order to correct degradation of said optical characteristic produced in accordance with the thickness of said correction member, and; said first adjusting step includes a step for adjusting at least one of said reticle setting position and said substrate setting position based on first calculated information obtained in said first calculating step.

Furthermore, it is preferable that said correcting step further includes a second calculating step, prior to said setting step, for calculating an adjusting amount for said projection system for correcting degradation of said optical characteristic unable to be corrected by said first adjusting step; and said second adjusting step includes a step for adjusting said projection system based on second calculated information obtained in said second calculating step. Further, it is preferable that it further includes a support member arranging step, prior to said setting step, for arranging a support member supporting said correction member in order to set said correction member on said predetermined position. Further, it is preferable that said correcting step is performed prior to said setting step. Furthermore, it is preferable that said first adjusting step includes a step for moving at least one of a reticle stage to set said reticle to said reticle setting position and a substrate stage to set said photosensitive substrate to said substrate setting position.

Additionally, a second invention of the invention provides a method for manufacturing an exposure apparatus comprising the steps of:

a providing step for providing a projection system projecting and exposing an image of a predetermined pattern formed on a reticle to a photosensitive substrate;

a measuring step for measuring residual aberration in said projection system;

a processing step for processing a correction member for correcting said residual aberration in said projection system based on measured information obtained in said measuring step;

an inserting step for inserting a correction member obtained in said processing step on a predetermined position between a reticle setting position where said reticle is set and a substrate setting position where said photosensitive substrate is set; and

a first adjusting step for adjusting at least one of said reticle setting position and said substrate setting position in accordance with a change in an object-to-image distance of said projection system produced by inserting said correction member.

In one preferred embodiment of the second invention, it is preferable that a second adjusting step is further included for adjusting said projection system for correcting degradation of optical characteristic of said projection system produced by inserting said correction member in said inserting step.

Further, it is preferable that a first calculating step is included, prior to said measuring step, said processing step and said inserting step, for calculating an amount of change in an object-to-image distance of said projection system produced by inserting said correction member;

and said first adjusting step includes a step, prior to said measuring step, said processing step and said mounting step, for adjusting at least one of said reticle setting position and said substrate setting position based on first calculated information obtained in said first calculating step. On the other hand, it is preferable that a first calculating step is further included, independent from said measuring step, said processing step and said inserting step, for calculating an amount of change in an object-to-image distance of said projection system produced by inserting said correction member, and said first adjusting step includes a step for adjusting at least one of said reticle setting position and said substrate setting position based on first calculated information obtained in said first calculating step.

Furthermore, it is preferable that a second calculating step is further included, prior to said processing step, said processing step and said inserting step, for calculating an amount of adjustment for said projection system for correcting degradation of optical characteristic of said projection system produced by inserting said correction member and said second adjusting step includes a step, prior to said measuring step, said processing step and said inserting step, for adjusting said projection system based on second calculated information obtained in said second calculating step. On the other hand, it is preferable that a second calculating step is further included, independent from said measuring step, said processing step and said inserting step, for calculating an amount of adjustment for said projection system for correcting degradation of optical characteristic of said projection system produced by inserting said correction member, and said second adjusting step includes a step for adjusting said projection system based on second calculated information obtained in said second calculating step.

Further, it is preferable that said measuring step includes a step for measuring residual aberration in said projection system while an optical member exclusively for measurement having same optical thickness as said correction member is inserted to said predetermined position. Alternatively, it is preferable that a step is further included for measuring residual aberration in said projection system while a unprocessed correction member in said processing step is being inserted to said predetermined position. Further, it is preferable that a support member arranging step is further included, prior to said measuring step, for arranging a support member supporting said correction member in order to set said correction member at said predetermined position. Furthermore, it is preferable that said first adjusting step further includes a step for moving at least one of said reticle stage to set said reticle to said reticle setting position and said substrate stage to set said photosensitive substrate to said substrate setting position.

Additionally, a third invention of the invention provides a method for manufacturing an exposure apparatus comprising the steps of:

a measuring step for measuring optical capability of a projection system projecting and exposing an image of a predetermined pattern formed on a reticle to a photosensitive substrate;

an improving step for improving optical capability of said projection system based on a measured result by said measuring step;

an adjusting step for adjusting illumination characteristic for illuminating said reticle in accordance with said improving step.

In one preferred embodiment of the third invention, it is preferable that said improving step includes; an arranging step for arranging a processed correction member based on measured result by said measuring step in order to correct residual aberration in said projection system. Alternatively, it is preferable that said improving step includes; a step for processing at least one of optical members in said projection system based on measured result by said measuring step in order to correct residual aberration in said projection system.

Another aspect of the invention provides a method for manufacturing a micro device comprising the steps of:

a preparing step for preparing an exposure apparatus manufactured by using a method for manufacturing an exposure apparatus according to one of the first, second and third inventions;

a reticle setting step for setting a reticle at said reticle setting position;

a substrate setting step for setting a photosensitive substrate at said substrate setting position;

an exposing step for exposing a pattern image of said reticle to said photosensitive substrate by using a projection system of an exposure apparatus prepared in said preparing step; and

a developing step for developing said photosensitive substrate exposed by said exposing step.

### BRIEF DESCRIPTION OF THE DRAWINGS

FIG. 1 is a perspective view illustratively showing the entire appearance of a projection exposure apparatus preferable for practicing the invention.

FIG. 2 is a diagram showing the detailed configuration of the main body of the projection exposure apparatus shown in FIG. 1.

FIG. 3 is a diagram illustratively exemplifying a distortion characteristic which occurs within the projection view field of the projection optical system shown in FIGS. 1 and 2.

FIG. 4 is a diagram explaining the averaging of the distortion characteristic (image distortion vector) by using a scan-exposure method.

FIGS. 5(A), (B), (C), and (D) are diagrams explaining several typical examples of averaged dynamic distortion characteristics.

FIGS. 6(A) and (B) are diagrams explaining the cases where a dynamic image distortion vector which occurs at random is corrected to be approximated to a predetermined function.

FIG. 7 is a diagram explaining how to obtain a correction vector for correcting a dynamic image distortion vector.

FIG. 8 is a partially enlarged view explaining the correction of an imaging light beam by an image distortion correction plate.

FIG. 9 is partially cross-sectional enlarged view which exaggeratedly shows the state where the surface of the image distortion correction plate shown in FIG. 8 is locally polished and processed.

FIG. 10 is a plan view illustratively exemplifying the distribution state of locally polished areas of the image distortion correction plate which is ultimately polished and processed.

FIG. 11 is a diagram showing the simplified configuration of a polishing processor preferable for polishing the image distortion correction plate shown in FIG. 10.

FIG. 12 is a plan view showing the configuration of a support plate on which the image distortion correction plate shown in FIG. 10 is mounted.

FIG. 13 is a partially cross-sectional view showing the state of the image distortion correction plate mounted in the optical path of the projection optical system of the projection exposure apparatus along with the support plate of FIG. 12, and its holding structure.

FIG. 14 is a diagram showing the specific lens configuration of a projection optical system PL on which each manufacturing method of the invention applies.

FIG. 15 are diagrams showing various aberrations of the projection optical system before mounting the image distortion correction plate G1 according to each manufacturing method.

FIG. 16 is a flow chart showing the manufacturing flow of the first manufacturing method of the exposure apparatus in accordance with this embodiment.

FIGS. 17(A) and (B) are diagrams explaining calculation of required shift amount of the reticle surface when the image distortion correction plate G1 is inserted into the projection optical system PL.

FIG. 18 is a diagram corresponding to FIG. 14 and shows a state where a distortion correction plate G1 having a thickness of 1 mm is inserted into a predetermined position of the projection optical system PL.

FIG. 19 is a diagram of various aberrations of the projection optical system PL in the state before the reticle R is moved after mounting the image distortion correction plate G1 having a thickness of 1 mm.

FIG. 20 is a diagram of various aberrations of the projection optical system PL in the state where the reticle R is moved and the image distortion correction plate G1 having a thickness of 1 mm is inserted.

FIG. 21 is a flow chart showing a manufacturing flow of a second manufacturing method of an exposure apparatus in accordance with the embodiment.

FIG. 22 is a flow chart showing a manufacturing flow of a third manufacturing method of an exposure apparatus in accordance with the embodiment.

FIG. 23 is a diagram corresponding to FIG. 14 and shows a state where an image distortion correction plate G1 having a thickness of 5 mm is inserted into a predetermined position of the projection optical system PL.

FIG. 24 is a diagram of various aberrations of the projection optical system PL in the state before the reticle R is moved after mounting the image distortion correction plate G1 having a thickness of 5 mm is inserted.

FIG. 25 is a diagram of various aberrations of the projection optical system PL in the state where the reticle R has been moved and the image distortion correction plate G1 having a thickness of 5 mm is inserted.

FIG. 26 is a diagram of various aberrations of the projection optical system PL in the state where the reticle R is moved after mounting the image distortion correction plate G1 having a thickness of 5 mm, and each adjusting optical member is moved for only required adjustment amount.

FIG. 27 is a flow chart showing a manufacturing flow of a fourth manufacturing method of an exposure apparatus in accordance with the embodiment.

FIG. 28 is a flow chart showing an example of a method for obtaining a semiconductor device as a micro device.

FIG. 29 is a flow chart showing an example of a method for obtaining a liquid crystal display element as a micro device.

FIG. 30 is a diagram showing a structure of a spatial image detector mounted on a wafer stage of a projection exposure apparatus and a configuration of the processing circuit.

FIG. 31 is a plan view showing a configuration of a test reticle on which measurement marks for measuring respective aberration characteristics are formed and the state of a measurement pattern group formed within one measurement mark area.

FIG. 32 is a diagram explaining that the image of an L&S pattern on a test reticle, which is projected onto one location on a projection image plane, is detected by a spatial image detector.

FIG. 33 is a wave form diagram exemplifying the waveform of the photoelectric signal output from the spatial image detector.

FIGS. 34(A) and (B) are wave form diagrams showing the signal waveform from the spatial image detector and its differential signal, respectively.

FIG. 35 is a timing chart showing the relationship between the measurement pulse of a laser interferometer for a wafer stage and the trigger pulse of an excimer laser light source.

FIG. 36 is a circuit block diagram exemplifying the modification of the processing circuit which digitally converts the photoelectric signal from the spatial image detector and stores.

FIG. 37 is a partially cross-sectional enlarged diagram exaggeratedly exemplifying the case where both sides of an image distortion correction plate are polished.

FIG. 38 is a diagram showing one example of a telecentric error of a projection optical system, which is measured by a spatial image detector.

FIG. 39 is a partially cross-sectional view showing a state of an astigmatism/coma correction plate and an image plane curvature correction plate arranged on an image plane side of a projection optical system.

FIG. 40 is a diagram explaining a difference of a numerical aperture (NA) according to an image height of an imaging light beam (or illumination light beam) projected onto a projection image plane side through a projection optical system.

FIG. 41 is a diagram showing a structure of a measurement sensor for measuring an NA difference according to an image height of the illumination light beam and its processing circuit.

FIGS. 42(A) and (B) illustratively show an example of a light source image within an illumination optical system, which is measured by the measurement sensor of FIG. 41.

FIG. 43 is a diagram explaining an optical path from a fly eye lens configuring an illumination optical system to an irradiated surface and an NA difference of an illumination light focusing on one point on the irradiated surface

FIGS. 44(A) and (B) are diagrams showing the arrangement of an illumination NA correction plate for correcting an NA difference according to an image height of an illumination light and a plan structure of the correction plate, respectively.

FIG. 45 is a diagram illustratively explaining the exchange and adjustment mechanisms of various aberration correction plates installed in a projection exposure apparatus.

FIGS. 46(A), (B) and (C) are diagrams illustratively explaining other types of projection optical system to which the invention is applied.

FIG. 47 is a diagram showing the arrangement of shot areas on a wafer onto which a test reticle pattern is scanned and exposed at the time of test printing, and the state of one shot area within the arrangement.

FIG. 48 is a diagram explaining the grouping and averaging state when respective projection images of a measurement mark pattern within one shot area, which is test-printed, are measured.

FIG. 49 is a diagram schematically showing a specific configuration of a projection exposure apparatus, using an ArF excimer laser light source and filled with inert gas in the projection optical path, preferable for practicing a method for manufacturing an exposure device of the invention.

FIG. 50 is a plan view showing a structure of a test reticle, according to the second method, used for measuring various aberrations other than distortion.

FIG. 51 is a plan view showing a structure of a test reticle, according to the second method, used for measuring distortion.

FIG. 52 shows the state of a pattern on a wafer which is formed by using the test reticle of FIG. 51.

FIGS. 53(a) and (b) are explanatory diagrams of a curved surface interpolation method of the second method. FIG. 53(a) shows a case when a conventional curved surface interpolation method is used, and FIG. 53(b) shows a case when a curved surface interpolation method of this method is used.

FIG. 54 is a diagram showing a curved surface interpolation method of the second method.

FIG. 55 is a diagram showing a curved surface interpolation method of the second method.

FIG. 56 is a diagram showing a curved surface interpolation method of the second method.

FIG. 57 is a diagram showing a curved surface interpolation method of the second method.

FIG. 58 is a diagram showing a curved surface interpolation method of the second method.

FIG. 59 is a diagram showing the arrangement of an apparatus to process the distortion correction plate according to the second method.

FIG. 60 is a perspective view showing an entire configuration of a reticle stage device on which an image distortion correction plate and its support frame are mounted by retrofit.

### DETAILED DESCRIPTION OF PREFERRED EMBODIMENTS

In the invention, a correction member for correcting residual aberration in the projection optical system is inserted (mounted) into the projection optical path located between a reticle and a photosensitive substrate. Specifically, an optical correction plate for correcting random components of an image surface curvature characteristic, dynamic distortion characteristics, or the like is arranged at predetermined position between a reticle and the most object side lens of the projection optical system, or between a photosensitive substrate and the most image side lens component of the projection optical system, or the like.

In this case, as the optical correction plate is mounted into the projection optical path, the optical characteristics of the projection optical system deteriorate. If the optical correction plate is made from, for example, a plane parallel plate, the object-to-image distance of the projection optical system varies according to the thickness, and various aberrations including spherical aberration become worse. Therefore, in the invention, in order to correct variation in the object-to-image distance caused by inserting the optical correction plate into the projection optical path, the reticle or the photosensitive substrate is moved for only necessary shift amount. As a result, the variation in the object-to-image distance caused by inserting the optical correction plate into the projection optical path is corrected, and various aberrations including spherical aberration are also corrected.

Additionally, the object-to-image distance of the invention means the distance between the object (object point) and the image (image point) of the projection optical system in view of an imaging relation of the projection optical system in a paraxial area, in other words, the distance (on-axis distance) between the object (object point) and the image (image point) of the projection optical system when the total length of the projection optical system is shown by reduced air interval.

In particular, when the thickness of the optical correction plate to be inserted is relatively thin, various aberrations including spherical aberration can be sufficiently corrected changes of by correcting changes of the object-to-image distance by moving the reticle or the photosensitive substrate for only required shift amount. As a result, severely degraded various aberrations such as spherical aberration and distortion by inserting the optical correction plate can be sufficiently corrected, random components such as dynamic distortion characteristics or the like are corrected, and other aberrations are returned to a preferable state before mounting the optical correction plate. In other words, although the projection optical system is designed and assembled without the assumption of mounting an optical correction plate, the substantially same state where a prearranged optical correction plate is inserted into a projection optical system designed on the assumption of inserting an optical correction plate can be implemented by moving the reticle or the photosensitive substrate for only required shift amount.

On the other hand, when the thickness of the optical correction plate to be inserted is relatively thick, although various aberrations including spherical aberration can be corrected to a certain extent by changes of changes of the object-to-image distance by moving the reticle or the photosensitive substrate for only required shift amount, a preferable aberration state before inserting the optical correction plate cannot be recovered. In this case of this invention, degraded optical characteristics of the projection optical system, which cannot be sufficiently corrected by only moving the reticle or the photosensitive substrate for only required shift amount, is corrected by adjusting optical members which structure the projection optical system. Specifically, various aberrations, such as spherical aberration or distortion, remained in the projection optical system are corrected with a good balance by infinitesimally moving, for example, at least one or a plurality of lens components of large number of lens components which structure(s) the projection optical system for only required adjustment amount along the optical axis (or by tilting or decentering about an axis perpendicular to the optical axis) after the reticle or the photosensitive substrate is moved for only required shift amount. Then, a preferable aberration state before inserting the optical correction plate can be returned.

Therefore, even if it is found that unallowable random aberration components remain in the projection optical system, which is designed without the assumption of mounting an optical correction plate, after being finished its assembling, imaging performance capability (quality) of the projection optical system can be well adjusted with significantly high accuracy by applying the invention. As a result, an exposure apparatus equipped with the projection optical system adjusted with extremely high imaging quality can be manufactured.

In addition, even if a micro device with specifications highly improved integration degree and minuteness cannot be manufactured anymore with respect to exposure apparatus which have already been sold to device manufacturers, the specifications (imaging quality) of the projection optical system can be improved by further correcting the optical errors which occurred during the design process (residual aberration components or the like) of the projection optical system by means of taking measures to meet to retrofit applying the invention.

Thus, the invention makes it possible to manufacture an exposure apparatus equipped with a projection optical system adjusted in extremely high imaging quality, because even when an optical correction plate is mounted into a projection optical path which corrects residual aberrations of the projection optical system, deterioration of optical characteristics of the projection optical system caused by mounting the optical correction plate is preferably corrected. Accordingly, it is possible to manufacture a preferable micro device, by using an exposure apparatus manufactured by the above-mentioned manufacturing method, capable of exposing a reticle pattern on a photosensitive substrate with extremely high fidelity through a projection optical system with extremely high imaging characteristics.

Embodiments of the invention are described in accordance with attached drawings.

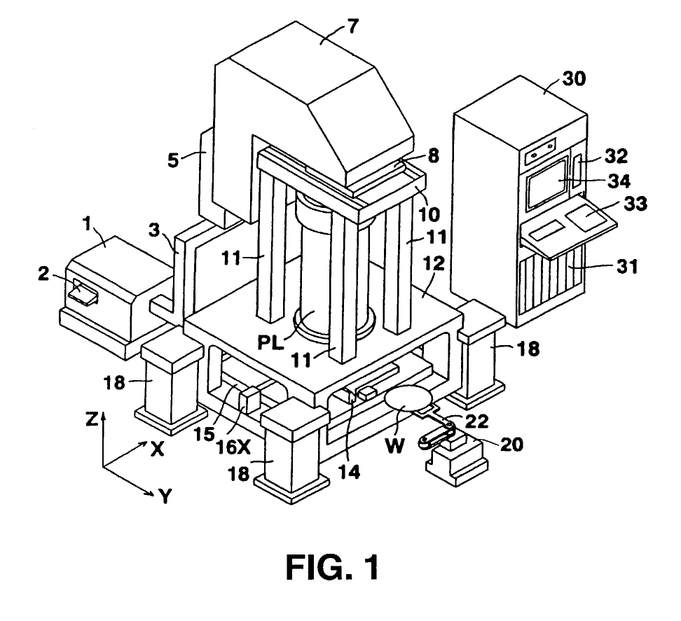

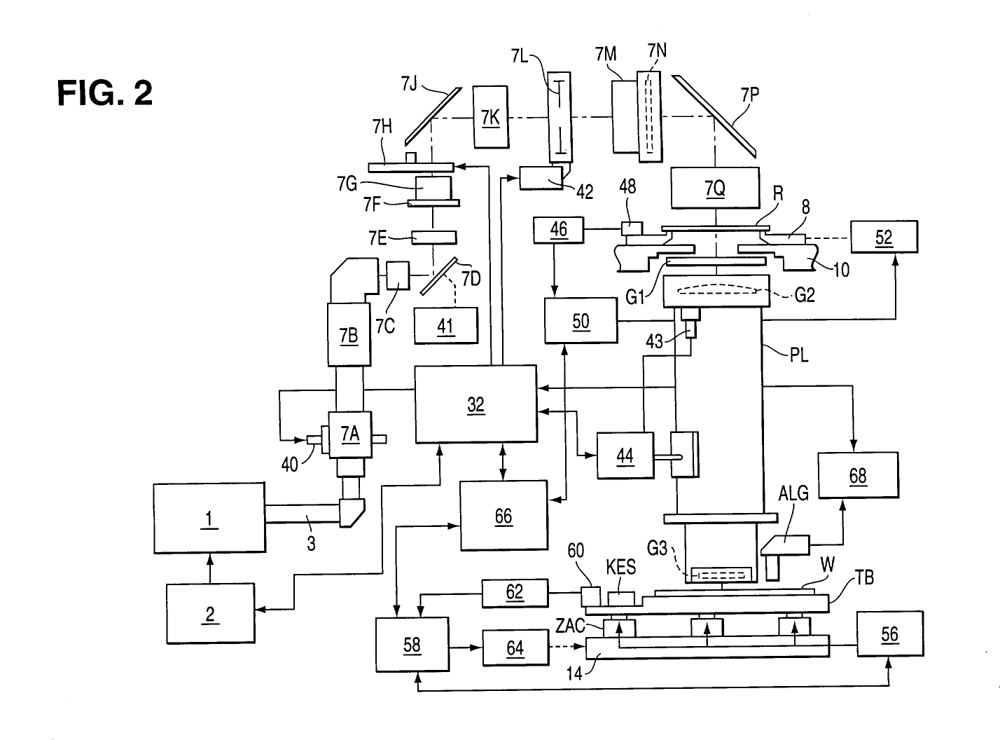

FIGS. 1 and 2 are diagrams schematically showing the entire structure of a projection exposure apparatus preferable for practicing the invention.

A projection exposure apparatus of FIG. 1 transfers the entire reticle circuit pattern onto a plurality of shot areas on a wafer W with a step-and-scan method by relatively scanning the reticle and the wafer W in one-dimensional direction (Y direction) against a view field of a projection optical system PL while projecting a partial image of the circuit pattern drawn on the reticle as a mask substrate onto the semiconductor wafer W as a photosensitive substrate through the projection optical system PL.

Furthermore, the projection exposure apparatus of FIG. 1 uses an ultraviolet area pulse laser beam from the excimer laser light source 1 in order to obtain the pattern resolution of the minimum line width of approximately 0.3 to 0.15 μm, which is required to mass-produce a micro circuit device having the integration degree and minuteness equivalent to a semiconductor memory element (D-RAM) of 64M to 1 G bit class or more. The excimer laser light source 1 pulse-emits a KrF excimer laser beam having a wavelength of 248 nm, an ArF excimer laser beam having a wavelength of 193 nm, or an F2 excimer laser beam having a wavelength of 157 nm, respectively.

The wavelength width of the excimer laser beam is narrowed so that the color aberration caused by various dioptric elements configuring the illumination system and the projection optical system PL of the exposure apparatus can be within the tolerable range. The absolute value of the central wavelength to be narrowed or the value of the width to be narrowed (between 0.2 pm to 300 pm) is displayed on an operation panel 2 and can be infinitesimally adjusted by using the operation panel 2 depending on need. Additionally, a pulse emitting light mode (typically, three modes such as self-excited oscillation, external trigger oscillation, and maintenance oscillation) can be set by the operation panel 2.

Additionally, because the excimer laser light source 1 is normally arranged in a room (service room with a lower cleanness degree) isolated from a super-clean room where an exposure apparatus is installed, the operation panel 2 is also arranged within the service room. Furthermore, a control computer interfaced with the operation panel 2 is stored in the excimer laser light source 1. While normal exposure operations are performed, this computer controls pulse emitting light of the excimer laser light source 1 in response to the instruction from a mini computer 32 for controlling the exposure apparatus, which will be described later.

Incidentally, the excimer laser beam from the excimer laser light source 1 is guided to a beam reception system 5 of the exposure apparatus via a shading tube 3. Within the beam reception system 5, a plurality of movable reflection mirrors are arranged so as to optimally adjust the incident position and angle of the excimer laser beam to the illumination optical system 7 so that the excimer laser beam can be constantly incident to the optical axis of the illumination optical system 7 in a predetermined positional relationship.

Thus, examples of an exposure apparatus which uses an excimer laser as a light source are disclosed by Japanese Laid-Open Patent Applications 57-198631 (U.S. Pat. No. 4,458,994), 1-259533 (U.S. Pat. No. 5,307,207), 2-135723 (U.S. Pat. No. 5,191,374), 2-294013 (U.S. Pat. No. 5,383,217), or the like. Examples of an exposure apparatus which uses an excimer laser light source for step-and-scan exposure are disclosed by Japanese Laid-Open Patent Applications 2-229423 (U.S. Pat. No. 4,924,257), 6-132195 (U.S. Pat. No. 5,477,304), 7-142354 (U.S. Pat. No. 5,534,970), or the like. Accordingly, with respect to the exposure apparatus of FIG. 1 as well, the basic technology disclosed by the above-described applications can be applied as-is or by being partially modified.

Incidentally, within the illumination optical system 7, as explained in detail later by referring to FIG. 2, a variable beam attenuator for adjusting average energy for each pulse of the excimer laser beam, a fly eye lens (optical integrator) system for making the excimer laser beam into an illumination light having a uniform intensity distribution, a reticle blind (illumination view field diaphragm) for restricting a reticle illumination light at the time of scan-exposure to a rectangular-slit shape, an imaging system (including a condenser lens) for imaging the rectangular-slit-shaped aperture of the blind in a circuit pattern area on a reticle, and the like are arranged.

The rectangular-slit-shaped illumination light irradiated onto the reticle is set to extend long and narrow in the X direction (non-scanning direction) in the center of the circular projection view field of the projection optical system PL of FIG. 1. The width of the illumination light in the Y direction (scanning direction) is set to be substantially constant. Furthermore, when the width of the shading band in the periphery of a circuit pattern area on the reticle is desired to be narrowed or if the scan moving stroke of the reticle is desired to be reduced as short as possible, it is preferable that the mechanism for changing the width of the scanning direction of the reticle blind during scan-exposure is arranged, for example, as recited in Japanese Laid-Open Patent Application 4-196513 (U.S. Pat. No. 5,473,410).

The reticle is absorbed and held on a reticle stage 8 of FIG. 1, which linearly moves on a reticle surface plate 10 along the Y direction with a large stroke by a linear motor, or the like, for being scan-exposed and is set to be infinitesimally movable by a voice coil motor (VCM), a piezoelectric element or the like also in the X and the θ directions. The reticle surface plate 10 is fixed on the top of four columns 11 standing upward from a main body column surface plate 12 which fixes the flange of the projection optical system PL.

The main body column surface plate 12 is formed in a box shape in which the inside is made hollow in this embodiment, and a base surface plate 15 for supporting a movable stage 14 on which a wafer W is mounted is fixed in the hollow space. Furthermore, FIG. 1 shows only a laser interferometer 16X for measuring the position of the movable stage 14 in the X direction, and a laser interferometer 16Y for measuring the position of the movable stage 14 in the Y direction is arranged in the same manner. Additionally, the movable stage 14 of FIG. 1 stops at the loading position for receiving the wafer W supported by the tip of an arm 22 of a wafer conveying robot 20 or the unloading position for handing the wafer on the holder of the movable stage 14 to the arm 22.

Furthermore, a mounting table 18 with a vibration prevention function to support the entire apparatus from the floor, is arranged at each of the four corners of the main body column surface plate 12. The mounting table 18 supports the weight of the entire apparatus via an air cylinder and is provided with an actuator and various sensors for correcting the tilt of the entire apparatus, the displacement of the Z direction, the displacement of the entire apparatus in the X and Y directions by using feedback or feed forward control in an active manner.

The entire operations of the main body of the exposure apparatus shown in FIG. 1 are managed by a control rack 30 which includes a plurality of unit control boards 31 for individually controlling the constituent elements (the excimer laser light source 1, the illumination optical system 7, the reticle stage 8, the wafer movable stage 14, the conveying robot 20, or the like) within the main body of the apparatus, the mini computer 32 for integratedly controlling various control boards 31, an operation panel 33, a display 34, or the like. A unit side computer such as a micro processor, or the like is arranged within various control boards 31. The unit side computers function with the mini computer 32, so the sequence of an exposure process is performed for a plurality of wafers.

The entire sequence of the exposure process is managed by the process program stored in the mini computer 32. The process program stores information about a wafer to be exposed (number of wafers to be processed, shot size, shot arrangement data, alignment mark arrangement data, alignment condition, or the like), information about a reticle to be used (data type of a pattern, arrangement data of each mark, size of a circuit pattern area, or the like), and information about exposure conditions (exposure amount, focus offset amount, offset amount of scanning speed, offset amount of projection magnification, correction amount of various aberration and image distortion, setting of a σ value and an illumination light NA, or the like of an illumination system, setting of an NA value of a projection lens system, or the like) as a parameter group package under the exposure processing file name created by an operator.

The mini computer 32 decodes a process program instructed to be executed and instructs corresponding unit side computers to perform operations of the respective constituent elements, which are required for wafer exposure processing one after another as a command. At this time, when each unit side computer finishes one command in a normal state, the status is sent out to the mini computer 32. The mini computer 32 which receives this status sends the next command to the unit side computer. When a wafer exchange command is sent from the mini computer 32 in the series of the operation, the control units of the movable stage 14 and the wafer conveying robot 20 collaborate with each other, and the movable stage 14 and the arm 22 (wafer W) are set at the positional relationship shown in FIG. 1.

Furthermore, a plurality of utility software related to the implementation of the invention are installed in the mini computer 32. Typical software are: (1) a measurement program for automatically measuring optical characteristics of a projection optical system or an illumination optical system and evaluating quality (distortion characteristic, astigmatism/coma characteristic, telecentric characteristic, illumination numerical aperture characteristic, and the like) of a projection image and (2) the correction program for implementing various correction processes according to evaluated projection image quality). These programs are configured to operate in cooperation with the corresponding constituent elements of FIG. 2 which shows the details of the configuration of the apparatus of FIG. 1. This operation is mentioned later.

In the structure of FIG. 2, the same symbols are given to the constituent elements having the same function as in FIG. 1. In FIG. 2, after an ultraviolet pulse light output from an excimer laser light source 1 goes through a tube 3 and is adjusted to be a predetermined peak intensity by a variable beam attenuator 7A, it is modified to be a predetermined cross-sectional shape by a beam modifier 7B. The cross-sectional shape is set to be approximate to the entire shape of an incident end of a first fly eye lens system 7C for making the intensity distribution of an illumination light uniform.

An ultraviolet pulse light dispersed from many point light sources, which is generated on an emitting end side of the first fly eye lens system 7C, is incident to a second fly eye lens system 7G via a vibration mirror 7D for smoothing interference fringes and a weak speckle occurring on an irradiated plane (a reticle plane or a wafer plane), a collective light lens system 7E, an illumination NA correction plate 7F for adjusting the directionality (illumination NA difference) of a numerical aperture on the plane irradiated by an illumination light. The second fly eye lens system 7G structures a double fly eye lens system together with the first fly eye lens system 7C and the collective light lens system 7E. The configuration where such a double fly eye lens system and the vibration mirror 7B are combined is disclosed in detail, for example, by Japanese Laid-Open Patent Applications 1-235289 (U.S. Pat. No. 5,307,207) and 7-142454 (U.S. Pat. No. 5,534,970).

On the emitting end side of the second fly eye lens system 7G, a switching type illumination a diaphragm plate 7H for restricting the shape of a light source plane in Koehler illumination to a ring shape, a small circle shape, a large circle shape, 4 holes, or the like is arranged. The ultraviolet pulse light which went through the diaphragm plate 7H is reflected by a mirror 7J, made to be an even intensity distribution by a collective lens 7K, and irradiates the aperture of an illumination view field diaphragm (reticle blind) 7L.

However, with respect to the intensity distribution interference fringes or a weak speckle depending on the coherence of the ultraviolet pulse light from the excimer laser light source 1 may be superposed by approximately several percentage of contrast. Accordingly, on the wafer plane, exposure amount unevenness may occur due to the interference fringes or weak speckles. However, the exposure amount unevenness can be smoothed by vibrating the vibration mirror 7D in synchronization with the moving of the reticle and the wafer W at the time of scan-exposure and the oscillation of an ultraviolet pulse light, as disclosed by the above-described Japanese Laid-Open Patent Application 7-42354 (U.S. Pat. No. 5,534,970).

Further, it is also acceptable to structure at least one of two integrator systems (7C, 7G) composing the optical integrator system from a micro fly eye lens system formed of aggregation of minute micro lenses. It is also acceptable to structure at least one of two integrator systems (7C, 7G) composing the optical integrator system from a diffractive optical element. Furthermore, it is also possible to construct at least one of two integrator systems (7C, 7G) composing the optical integrator system from a micro fly eye lens system and the other one from a diffractive optical element. Additionally, it is possible to construct at least one of two integrator systems (7C, 7G) composing the optical integrator system from an optical element (a diffractive optical element, and the like) converting an incident light beam to a predetermined-shaped light beam (a ring light beam, a small circle light beam, a large circle light beam, or 4 holes light beam). The optical element (a diffractive optical element, or the like) can be constructed to be interchangeable with a plurality of optical elements (diffractive optical elements, or the like) converting a light beam to a different-shaped light beam with each other. With this construction, the shape of the light source at the pupil plane (two-dimensional light source plane, and the like) of the illumination system can be effectively made to a predetermined shape (a ring shape, a small circle shape, a large circle shape, a 4-hole shape, or the like). Further, it is possible to construct at least one of two integrator systems (7C, 7G) composing the optical integrator system from an internal reflection type optical member (an internal reflection type hollow member, an internal reflection type glass rod, or the like).

The ultraviolet pulse light which thus went through the aperture of the reticle blind 7L is irradiated onto the reticle R via a collective lens system 7M, an illumination telecentric correction plate (a quartz parallel flat plate which can be tilted) 7N, a mirror 7P, and a main condenser lens system 7Q. At that time, an illumination area similar to the aperture of the reticle blind 7L is formed on the reticle R. However, in this preferred embodiment, the illumination area is a slit shape or a rectangular shape which linearly extends in the X direction orthogonal to the moving direction (Y direction) of the reticle R at the time of scan-exposure.

Therefore, the aperture of the reticle blind 7L is set to be conjugate to the reticle R by the collective light lens system 7M and the condenser lens system 7Q. This aperture also is formed to be a slit shape or a rectangular shape extending in the X direction. By such an aperture of the reticle blind 7L, part of the circuit pattern area on the reticle R is illuminated, and the imaging light beam from the illuminated circuit pattern part is reduced to ¼ or ⅕ and projected onto the wafer W through the projection lens system PL.

In this embodiment, the projection lens system PL is a telecentric system on both of the object plane (reticle R) side and the image plane (wafer W) side and has a circular projection view field. Additionally, the projection lens system PL is formed of only a dioptric element (lens component) in this embodiment. However, a catadioptric system can also be used where a dioptric element and a catoptric element are combined (such as a concave mirror and a beam splitter, or the like), as disclosed by Japanese Laid-Open Patent Application 3-282527 (U.S. Pat. No. 5,220,454).

In a position close to the object plane of this projection lens system PL, a telecentric part lens system G2 which can be infinitesimally moved or tilted in the optical axis direction is included. By the movement of the lens component G2, the magnification (isotropic distortion) or non-isotropic distortion such as a barrel-shaped, a spool-shaped, a trapezoid-shaped distortion, or the like of the projection lens system PL can be adjusted to be infinitesimal. Additionally, in a position close to the image plane of the projection lens system PL, an astigmatism/coma aberration correction plate G3 for reducing an astigmatism/coma aberration, which may easily occur in a large portion (portion close to the periphery of a projection view field) where an image height an image to be projected is particularly high, is included.

Furthermore, in this embodiment, an image distortion correction plate G1 for effectively reducing a random distortion component included in a projection image formed on an effective image projection area (regulated by the aperture portion of the reticle blind 7L) within a circular view field is arranged between the lens component L1 which is closest to the object side of the projection lens system PL and the reticle R. This optical correction plate G1 as a correction member locally polishes the surface of a parallel quartz plate having a thickness of approximately several millimeter and infinitesimally deflects the imaging light beam which goes through the polished portion.

An example of the method for manufacturing this type of correction plate G1 is disclosed by Japanese Laid-Open Patent Application 8-203805 (U.S. patent application Ser. No. 08/581016, filed on Jan. 3, 1996: European Laid-Open Patent Application 0724 199A1) and by Japanese Laid-Open Patent Application 11-45842 (PCT Publication No. WO 99/05709). The method disclosed here by Japanese Laid-Open Pat. Application 11-45842 (PCT Publication No. WO 99/05709) is basically an application of the method disclosed by Japanese Laid-Open Patent Application 8-203805 (U.S. patent application Ser. No. 08/581016, filed on Jan. 3, 1996: European Laid-Open Patent Application No. 0724 199A1). However, there is a difference in manufacturing method on that point where the correction plate G1 is applied to the projection optical system for scanning exposure apparatus. In other words, the method disclosed by Japanese Laid-Open Patent Application 8-203805 (U.S. patent application Ser. No. 08/581016, filed on Jan. 3, 1996: European Laid-Open Patent Application No. 0724 199A1) can be applied to both a projection optical system for collective exposure and that for scanning exposure. However, the method disclosed by Japanese Laid-Open Patent Application 11-45842 (PCT Publication No. WO 99/05709) can be applied to only a projection optical system for scanning exposure. These methods, however, are described later in detail. The method disclosed by Japanese Laid-Open Patent Application 11-45842 (PCT Publication No. WO 99/05709) is used in this embodiment.

In this embodiment, members for the respective optical which configure the above-described illumination and projection optical paths, a driving mechanism 40 for switching or continually varying a beam attenuation filter of the variable beam attenuator 7A, a driving system 41 for controlling the vibrations (deflection angle) of the vibration mirror 7B, a driving mechanism 42 for moving a blind blade in order to continually vary the shape of the aperture of the reticle blind 7L, particularly a slit width, and a driving system 43 for infinitesimally moving the lens component G2 within the projection lens system PL as described above are arranged.

Additionally, in this embodiment, there is also a lens controller 44 for correcting an isotropic distortion (projection magnification) by sealing a particular air chamber within the projection lens system PL from outside air and applying a gas pressure within the sealed chamber, for example, in a range of approximately ±20 mm Hg. This lens controller 44 also serves as a control system for the driving system 43 of the lens component G2 and switches and controls magnification of a projection image by driving of the lens component G2 or by the pressure control of the sealed chamber within the projection lens system PL, or uses and controls both of them.

However, when the ArF excimer laser light source with a wavelength of 193 nm or the F2 excimer laser light source with a wavelength of 157 nm is used as an illumination light, the mechanism for increasing/decreasing the pressure within the particular air chamber within the projection lens system PL may be omitted. This is because the inside of the, illumination optical path and the inside of the lens barrel of the projection optical system PL are replaced with nitrogen or helium gas.

A moving mirror 48 for reflecting a dimension measurement beam from the laser interferometer 46 for measuring a moving position and a moving amount is fixed in part of the reticle stage 8 supporting the reticle R. In FIG. 2, the interferometer 46 is illustrated to be suitable for a measurement in the X direction (scanning direction). Actually, however, an interferometer for measuring a position in the Y direction and an interferometer for measuring the θ direction (rotation direction) are arranged, and moving mirrors corresponding to the respective interferometers are fixed disposed to the reticle stage 8. Accordingly, in the explanation provided below, the measurements of the X, Y, and θ directions are individually made by the laser interferometer 46 at the same time for the sake of convenience.

Positional information (or speed information) of the reticle stage 8 (that is, the reticle R) measured by the interferometer 46 is transmitted to a stage control system 50. The stage control system 50 fundamentally controls a driving system (a linear motor, a voice coil motor, a piezoelectric motor, or the like) 52 which moves the reticle stage 8 so that the positional information (or the speed information) output from the interferometer 46 matches an instruction value (target position, target speed).

Meanwhile, a table TB for holding the wafer W by flattening and correcting the wafer W with vacuum absorption is arranged on a wafer stage 14. This table TB is infinitesimally moved in the Z direction (the optical axis direction of the projection optical system PL) and the tilting direction for the XY plane by three actuators (a piezoelectric, a voice coil, or the like) ZAC arranged on the wafer stage 14. These actuators ZAC are driven by the driving system 56, and a driving instruction for the driving system 56 is output from a wafer stage control system 58.

Although not shown in FIG. 2, a focus leveling sensor for detecting a deviation (focus error) or a tilt (leveling error) in the Z direction between the image plane of the projection optical system PL and the surface of the wafer W is arranged in the vicinity of the projection optical system PL, and the control system 58 controls the driving system 56 in response to a focus error signal or a leveling error signal from that sensor. An example of such a focus/leveling detecting system is disclosed in detail by Japanese Laid-Open Patent Application 7-201699 (U.S. Pat. No. 5,473,424).

Additionally, a moving mirror 60 used to measure the coordinate position of the wafer W within the XY plane, due to movement of the wafer stage 14 is fixed. Furthermore, the position of the moving mirror 60 is measured by the laser interferometer 62. Here, the moving mirror 60 is arranged to measure the moving position (or speed) of the stage 14 in the X direction. Actually, however, a moving mirror for measuring a moving position in the Y direction is also arranged, and a dimension measurement beam from the laser interferometer is irradiated onto the moving mirror for the Y direction in the same manner. Additionally, the laser interferometer 62 of FIG. 2 corresponds to the laser interferometer 16X of FIG. 1.

Additionally, the laser interferometer 62 is also provided with a differential interferometer for measuring an infinitesimal rotation error (including also a yawing component), which can occur on the XY plane due to XY movement of the wafer stage 14 or an infinitesimal movement of the table TB, in real time. The respective measured positional information of the X, Y, and θ directions of the wafer W is transmitted to the wafer stage control system 58. This control system 58 outputs a driving signal to the driving system (e.g., three linear motors) 64 for driving the wafer stage 14 in the X and Y directions based on the positional or speed information measured by the interferometer 62 and an instruction value.

Furthermore, in order to reciprocally control the driving system 52 by the reticle stage control system 50 and the driving system 64 by the wafer stage control system 58 particularly when the reticle stage 8 and the wafer stage 14 are synchronously moved during scan exposure, a synchronizing control system 66 monitors the state of the respective positions and speeds of the reticle R and the wafer W, which are measured by the respective interferometers 46 and 62, in real time and manages the reciprocal relationship therebetween to be a predetermined one. The synchronizing control system 66 is controlled by various commands and parameters from the mini computer 32 of FIG. 1.

Additionally, in this embodiment, a spatial image detector KES for photoelectrically detecting a test pattern image or an alignment mark image on the reticle R which are projected through the projection optical system PL is fixed to part of the table TB. This spatial image detector KES is fixed so that the surface can be substantially the same height as the surface of the wafer W. However, actually, when the table TB is set to the central position of the entire moving stroke (e.g., 1 mm) along Z direction, it is arranged so that the image plane of the projection optical system PL coincides with the surface of the spatial image detector KES.

On the surface of the spatial image detector KES, a multi-slit or a rectangular aperture which goes through part of an image projected by the projection optical system PL is formed, and an image light beam which went through the slit or the aperture is detected by a photoelectric element light amount. In this embodiment, the imaging performance capability of the projection optical system PL or illumination characteristics of the illumination optical system can be measured by the spatial image detector KES, and various optical elements and mechanisms shown in FIG. 2 can be adjusted based on the measurement result.

Additionally, in the system configuration shown in FIG. 2 of this embodiment, an off-axis type alignment optical system ALG for optically detecting an alignment mark formed in each shot area on the wafer W or a reference mark formed on the surface of the spatial image detector KES is arranged closest to the projection optical system PL. This alignment optical system ALG irradiates a non-photosensitive illumination light (uniform or spot illumination) onto a resist layer on the wafer W through an objective lens and photoelectrically detects a light reflected from the alignment or reference mark through the objective lens.

The photoelectrically detected mark Detection signal is waveform processed by a signal processing circuit 68 according to a predetermined algorithm. The coordinate position (shot alignment position) of the wafer stage 14, so the center of the mark matches the detection center (an indication mark, a reference pixel on the image plane, a light reception slit, a spot light, or the like) within the alignment optical system ALG, or the positional shift amount of the wafer mark or the reference mark from the detection center is obtained in cooperation with the interferometer 62. The information of the alignment position or the positional shift amount which has been thus obtained is transmitted to the minicomputer 32 and is used to position the wafer stage 14, set the start position of scan-exposure for each shot area on the wafer W, and the like.

Next, before a characteristic of the method for manufacturing the exposure apparatus according to the embodiment is specifically described, a dynamic distortion characteristic of the projection optical system and processing of the image distortion correction plate G1 will be described.

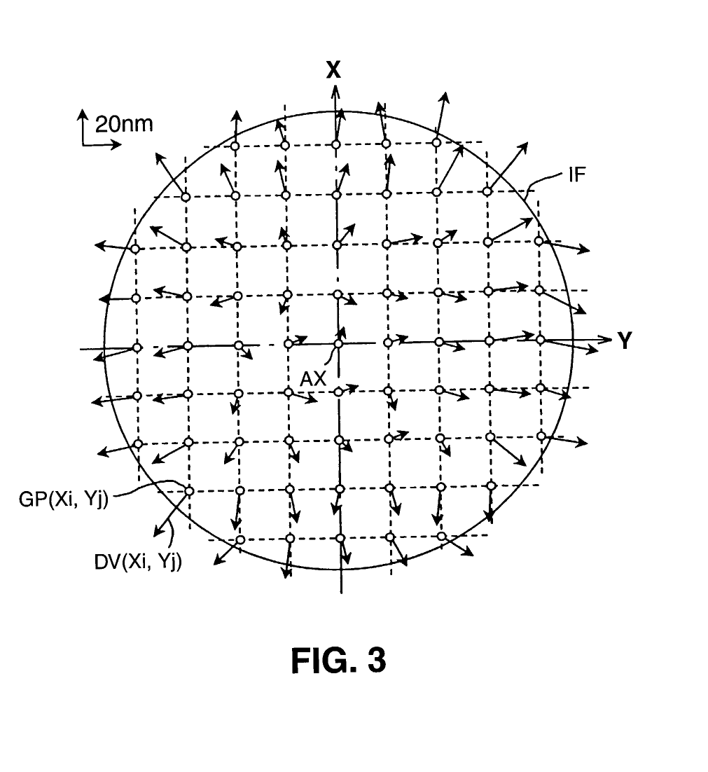

First of all, distortion characteristics of the projection optical system having a circular projection view field is briefly explained with reference to FIG. 3. In FIG. 3, a circular projection view field IF represents the view field of the wafer W side (image plane side), and the origin of a coordinate system XY matches the optical axis AX of the projection optical system PL. Additionally, a plurality of points GP(Xi, Yj) regularly arranged in the coordinate system XY of FIG. 3 represent the ideal lattice points with the optical axis AX as the origin. An arrow at each of the ideal lattice points GP(Xi, Yj) represents the distortion amount (image distortion vector) DV(Xi, Yj) at the position within the image plane.

As known from the distortion characteristic of FIG. 3, this type of projection optical system can control the image distortion vector to 20 nm or less in the vicinity of the optical axis AX. However, there is a tendency that the absolute value of the image distortion vector increases as it approaches the circumference of the projection view field IF. If image distortion vectors DV(Xi, Yj) follow a simple function according to the image height value (the distance from the optical axis AX) or the XY position, the image distortion vectors DV(Xi, Yj) can be overall made small within the projection view field IF by using the moving lens component G2 or the lens control system 44 in which correction can be made according to the function.

However, as understood from the distortion characteristic of FIG. 3, the respective image distortion vectors DV(Xi, Yj) includes mutually random components. Even if correction is made in response to a particular function, the random components still remain. Such remaining random error components included in the image distortion vectors DV(Xi, Yj) appear as random distortion errors as-is at respective points within a projected circuit pattern image in the case of stationary exposure.

In the meantime, in the case of scanning exposure, the image distortion vector which statically occurs at each of a plurality of image points arrayed in the moving direction of the wafer W during scanning exposure appears as a dynamic image distortion vector averaged or accumulated within an effective exposure view field (the width of the exposure slit). In this case as well, even if the static distortion characteristic conforming to a specified function is corrected, the random image distortion vector ultimately remains due to the random distortion error component remaining at each point on an image plane.

Therefore, arranged to reduce such a random image distortion vector and to obtain the best distortion characteristic at the time of scan-exposure is the image distortion correction plate G1 shown in FIG. 2. The correction plate G1 in this embodiment is structured that part of the surface of a quartz or fluorite parallel flat plate is polished with an accuracy of a wavelength order and a predetermined infinitesimal slope is formed in part of the surface. By deflecting the tilt of the principal ray of local image light beam which goes through the infinitesimal slope by an extremely slight amount, the static image distortion vector within the image plane is changed.

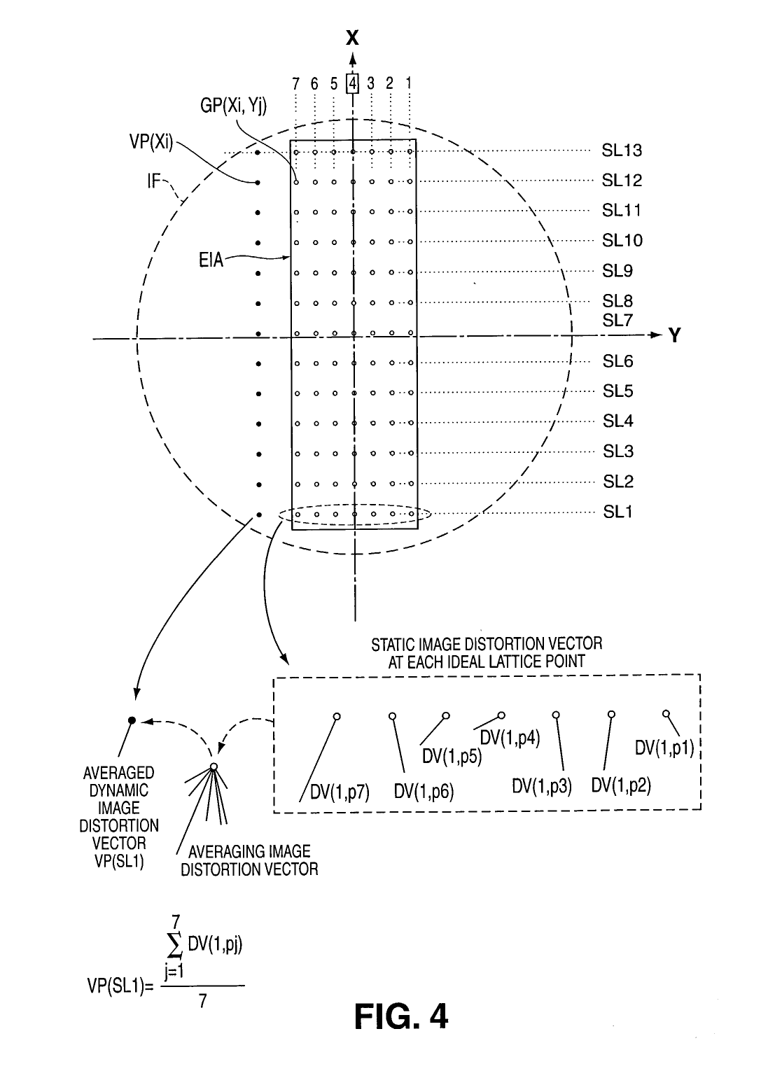

Here, the relationship between the static distortion characteristic occurring within the projection view field IF and the dynamic distortion characteristic occurring at the time of scan-exposure is explained by referring to FIG. 4. FIG. 4 assumes that the circular view field IF represents the view field on the image plane side of the projection optical system PL and the origin of the coordinate system XY exists in its center (the position of the optical axis AX).

The reticle R and the wafer W are relatively scanned in the Y direction in the apparatus of FIGS. 1 and 2, so the effective projection area EIA has a uniform width which is symmetrical to the Y direction as the X axis is the center within the view field IF and is set to be a long and thin rectangle or slit shape substantially extending over the diameter (approximately 30 mm) of the view field IF in the X direction. The area EIA is actually determined by the distribution shape of the illumination light to the reticle R, which is regulated by the aperture of the blind M shown in FIG. 2. However, this area may be regulated in the same manner as arranging a view field diaphragm with a rectangular aperture on the intermediate image plane within the projection optical system PL, depending on the configuration of the projection optical system PL.

In FIG. 4, ideal lattice points GP(Xi, Yj), which are arranged as 13 lines (SL1-SL13) in the X direction and as 7 lines (1-7) in the Y direction are set within the area EIA. The subscript “i” of the ideal lattice point GP(Xi, Yj) indicates any of integers 1 through 13 while the subscript “j” indicates any of integers 1 through 7. The lattice point GP(X7, Y4) of i=7 and j=4 is positioned in the center of the circular view field IF.

An example is shown which is the image distortion vector occurring at each of the ideal lattice points GP(Xi, Yj) is a static distortion characteristic. Here, static image distortion vectors DV(1, p1) to DV(1, p7) with respect to seven lattice points GP(X1, YI) to GP(X1, Y7) on the line SL1, which exist in sequence in the Y direction being the scan-exposure direction. The image distortion vectors DV(1, p1) to DV(1, p7) are represented as the segments extending from the white circles which represent the positions of the ideal lattice points on the line SLL.

In the static exposure, the pattern at one point on the reticle R is projected only with the image distortion vector at that point. In the meantime, in the scan-exposure, the pattern at one point on the reticle R is projected by moving, for example, along the line SL1 in the Y direction within the projection area EIA at an equal speed. Therefore, the pattern image at that point is affected by all of the static image distortion vectors DV(1, p1) to DV(1, p7) of FIG. 4 and formed on the wafer W.

The position of the reticle R is controlled in the X, Y, and θ directions by the laser interferometer 46 with an overall accuracy of ±15 nm or less, when the projection image of the pattern of one point on the reticle R linearly moves to the Y direction within the projection area EIA, as shown in FIG. 2. Accordingly, when the projection image of the pattern of one point on the reticle R linearly moves to the Y direction within the projection are EIA, linearity and rectilinear propagation are reduced by the projection magnification amount and can be sufficiently made smaller than the image distortion vectors DV(1, p1) to DV(1, p7). Therefore, the projection image of the pattern at one point on the reticle R, which is formed on the wafer W by scanning exposure accompanies the dynamic image distortion vector VP(SL1) obtained by averaging the image distortion vectors DV(1, p1) to DV(1, p7) possessed by the projection optical system PL in most cases.

Accordingly, the dynamic image distortion vector VP(SL1) obtained in the line SL1 of the scanning direction within the projection area EIA is obtained by calculating the average value of the X direction components of the static image distortion vectors DV(1, p1) to DV(1, p7) and the average value of the Y direction components. If such a dynamic image distortion vector VP(Xi) is obtained for each of the lines SL1 to SL13 in the X direction, the distortion characteristic of the pattern image (or the ideal lattice point image) to be transferred onto the wafer W as a result of the scanning exposure through the projection area EIA can be determined.

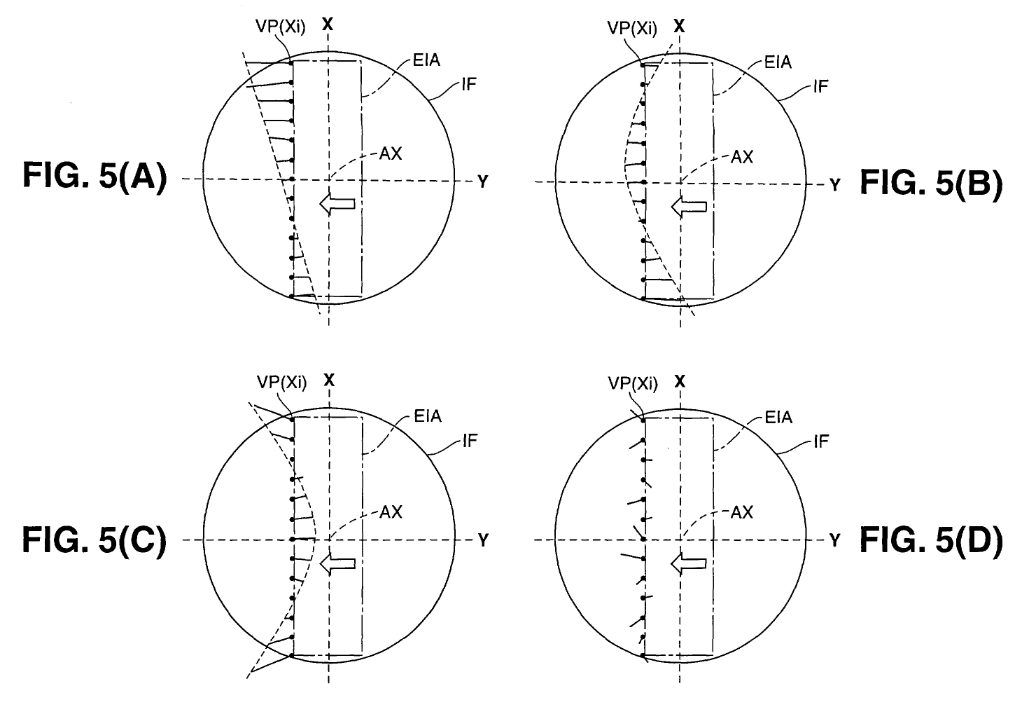

In the scan-exposure system, if the scanning movement of the reticle R and the wafer W is precisely performed, the distortion characteristic occurring in the entire area of one shot area on the wafer W conforms to the dynamic image distortion vector VP(Xi) at any point within that shot. Therefore, the distortion characteristic by the scan-exposure is specified as the dynamic image distortion vector VP(Xi) occurring at each of the ideal lattice points arrayed in the X direction, for example, as shown in FIG. 5.

FIGS. 5(A) to 5(D) exemplify the dynamic image distortion vector VP(Xi) (i=1 to 13) which has various tendencies depending on the static distortion characteristic in the projection area EIA within the circular view field IF. FIG. 5(A) exemplifies the distortion characteristic which has a tendency such that each dynamic image distortion vector VP(Xi) becomes almost parallel to the scanning direction (Y direction) and the absolute value is approximate to a linear function which varies almost at a constant ratio according to the position of the X direction.

FIG. 5(B) exemplifies the distortion characteristic which has a tendency such that each dynamic image distortion vector VP(Xi) becomes almost parallel to the scanning direction (Y direction) and the absolute value is almost approximate to a quadratic function according to the position of the X direction. FIG. 5(C) exemplifies the distortion characteristic which has a tendency such that the tendency of the distortion characteristic of FIG. 5(B) is superposed with the magnification error in the non-scanning direction. FIG. 5(D) exemplifies the distortion characteristic which has a tendency such that each dynamic image distortion vector VP(Xi) varies due to random directionality and size.

The dynamic distortion characteristic shown in FIG. 5(A) is, what is called, a skew. Except for correcting the characteristic of the projection optical system PL with the plane shape of the correction plate G1, the above-described distortion characteristic can be corrected by scan-exposing the reticle R and the wafer W in the state of being infinitesimally rotated relatively from the initial state. Additionally, for the dynamic distortion characteristic shown in FIG. 5(B), a correction can also be made by infinitesimally tilting the lens component G2, the astigmatism/coma correction plate G3, the image distortion correction plate G1, the reticle R, or the wafer W relatively to the plane vertical to the optical axis AX of the projection lens system PL, except for correcting the characteristic of the projection optical system PL with the plane shape of the correction plate G1.

Furthermore, for the dynamic distortion characteristic shown in FIG. 5(C), a correction can be made both by infinitesimally tilting the lens component G2, the astigmatism/coma correction plate G3, the image distortion correction plate G1, the reticle R, or the wafer W in the same manner as in FIG. 5(B) and by adjusting the magnification with the infinitesimal parallel movement toward the optical axis AX direction of the lens component G and with the pressure control of the air chamber within the projection optical system PL, except for correcting the characteristic of the projection optical system PL with the plane shape of the correction plate G1.

Additionally, if each dynamic image distortion vector VP(Xi) tends to be random as shown in FIG. 5(D), this can be corrected by the characteristic of the projection optical system PL with the plane shape of the correction plate G1. Furthermore, the random distortion characteristics of FIG. 5(D) are also superposed on and emerge as the distortion characteristics which can be approximated by a function as shown in FIGS. 5(A)-(C). Therefore, even if the distortion components which can be approximated by a function are corrected, random distortion components still remain. Accordingly, it is preferable that the distortion correction with the plane shape process of the correction plate G1 is performed mainly for the random component of the dynamic distortion characteristic.

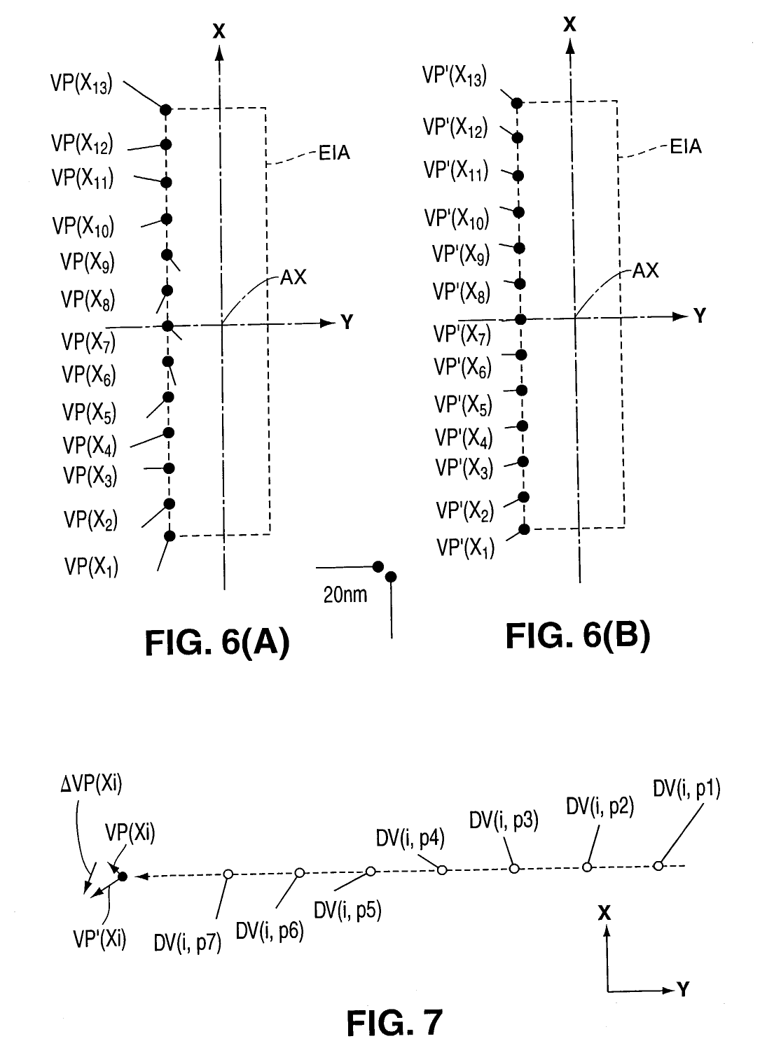

Therefore, the method for manufacturing a preferable image distortion correction plate G1 for correcting the dynamic random distortion characteristics shown in FIG. 5(D) is explained by referring to FIGS. 6, 7, and 8. FIG. 6(A) exemplifies the random distortion characteristics VP(X1) to VP(X13) measured in the state where an image distortion correction plate G1 yet to be processed is arranged in a predetermined position in the imaging optical path by the projection optical system PL. FIG. 6(B) exemplifies the dynamic distortion characteristics VP′(X1) to VP′(X13) after the characteristics of FIG. 6(A) are corrected by the image distortion correction plate G1.

As the correction of random distortion characteristics, two methods can be considered: a method for reducing to “0” as close as possible each of the dynamic image distortion vectors VP(X1) to VP(X13) at the respective integrated image points arrayed in the non-scanning direction (X direction) as shown in FIG. 6(A) (zero correction); and a method for approximating each of the image distortion vectors VP(X1) and VP(X13) to a certain tendency of a linear, a quadratic function, or the like (function correction).

Here, the function correction method shown in FIG. 6(B) is used to obtain the advantage that the polishing process of the image distortion correction plate G1 can relatively become easy. However, if the image distortion vectors VP(X1) to VP(X13) are not so large, the zero correction may be applied to reduce the random distortion characteristics (dynamic) to “0”. However, whichever method is adopted, the setting position (particularly tilt) of a processed image distortion correction plate G1 need to be adjusted by an infinitesimal amount when being re-set in the projection optical path.

Here, the distortion characteristics VP′(X1) to VP′(X13) of FIG. 6(B) are corrected so that a predetermined offset amount in the scanning direction (Y direction) and a constant magnification error in the non-scanning direction (X direction) can be provided at the same time. Both the offset amount and the magnification error are linear functions and can be sufficiently corrected with another correction mechanism such as an image shift adjustment by an infinitesimal tilt around the X axis of the image distortion correction plate G1, a magnification adjustment by the lens component G2 within the projection optical system PL, and the like.

To process the image distortion correction plate G1, an operation is needed in which the image distortion vectors VP(X1) to VP(X13) causing the dynamic distortion characteristics shown in FIG. 6(A) is measured. There are two types of the measurement methods: off-line measurement by test printing (test exposure); and on-body measurement using the spatial image detector KES which is fixed on the wafer table TB of the projection exposure apparatus shown in FIG. 2.

With the test exposure method, a test mark formed at an ideal lattice point on a test reticle is statically exposed onto the wafer W whose flatness is particularly managed, the exposed wafer W is developed and then conveyed to a measurement device different from the projection exposure apparatus, and the coordinate position and the positional shift amount of the transferred test mark are measured, so the static image distortion vectors at respective points within the circular view field IF or the effective projection area EIA of the projection optical system PL can be obtained.

Meanwhile, with the method using the spatial image detector KES, the wafer stage 14 is moved in the X and Y directions so as to scan the image of a test mark formed at each ideal lattice point on a test reticle with the edge of the knife of the spatial image detector KES while projecting the image with an exposure illumination light and the waveform of the photoelectric signal output from the spatial image detector KES at that time is analyzed, so a static image distortion vector can be obtained.

Thus, with the on-body measurement method using the spatial image detector KES, the data of the static image distortion vector at each ideal lattice point within the circular view field IF or the effective projection area EIA is sequentially stored in a memory medium of the main control system 32 of FIG. 2. Therefore, this method is convenient to the case when the process of the image distortion correction plate G1 is simulated on software by using the stored data or to the case when the image distortion correction plate G1 is actually polished and processed by a processing device. Furthermore, details of the test exposure or distortion characteristic measurement by the spatial image detector KES will be described later.

When static image distortion vectors are obtained, the dynamic distortion characteristics shown in FIG. 6(A) are obtained by averaging the image distortion vectors in the Y direction within the rectangular effective projection area EIA by a calculator (a computer, a workstation, or the like). Then, a modification vector (direction and size) ΔVP(Xn) for each of the image distortion vectors VP(X1) to VP(X13) of FIG. 6(A) is determined, for example, to obtain the dynamic distortion characteristics of FIG. 6(B). That is, the modification vector Δ VP(Xn) is determined, so VP′(Xn)=VP(Xn)−ΔVP(Xn) (n is any of integers 1 to 13).

Next, how to correct the static image distortion vector DV(i, pj) is determined for each averaged point in the non-scanning direction (X direction) based on the modification vector ΔVP(Xn). Various methods may be considered for this determination. Here, a correction is first made to the largest of the static image distortion vectors DV(i, p1) to DV(i, p7) at seven points which are averaged in the Y direction as shown in FIG. 4. The correction is also made to the image distortion vectors DV(i, pj) at the other points if the correction amount at the one point is larger than a predetermined allowable value.

FIG. 7 exemplifies the image distortion vectors DV(i, p1) to DV(i, p7) at the seven points arrayed in sequence in the Y (scanning) direction within the rectangular-shaped effective projection area EIA and the dynamic image distortion vector VP(Xi) obtained by averaging these vectors. The image distortion vector to be corrected is VP′(Xi) and the modification vector is ΔVP(Xi). For the distortion characteristics shown in FIG. 7, the correction based on the modification vector ΔVP(Xi) is mainly performed to the static image distortion vector DV(i, p1) at the point (i, p1). However, correction is also made to the static image distortion vector DV(i, p2) at the point (i, p2) depending on the case.

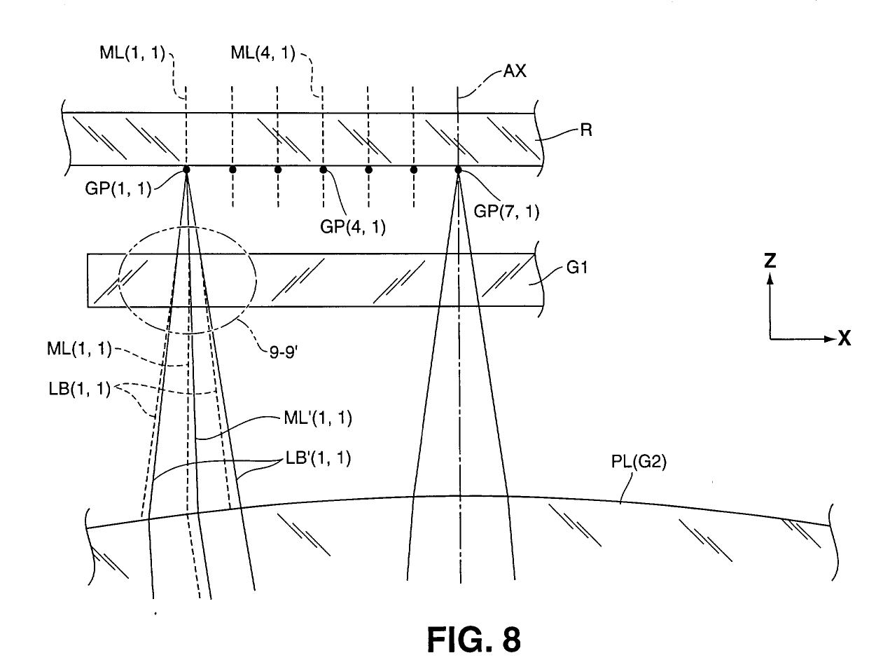

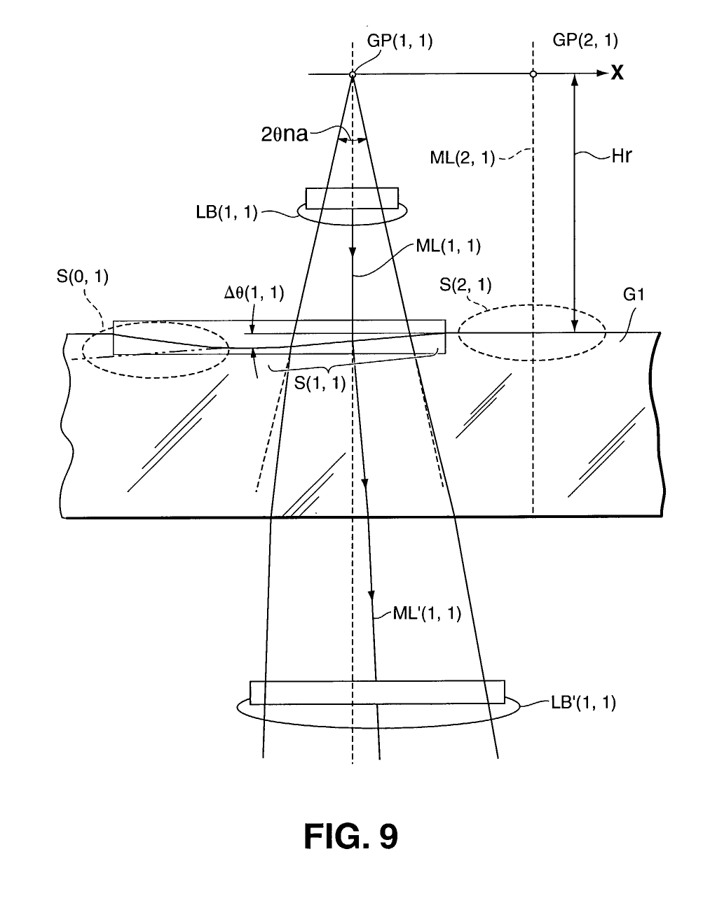

Specifically, correction is made so that the absolute value of the image distortion vector DV(i, p1) or DV(i, p2) is reduced and the directionality is infinitesimally changed. To implement this, a plane which infinitesimally deflects the principal ray going through the measurement point (ideal lattice point) within the projection view field, in which the image distortion vector DV(i, p1) or DV(i, P2) is observed, at the position of the image distortion correction plate G1 is determined. This is briefly explained with reference to FIGS. 8 and 9.

FIG. 8 is an enlarged diagram partially showing a positional relationship between the reticle R, the image distortion correction plate G1, and the projection optical system PL (movable lens component G2). Here, the first line in the Y direction among a plurality of lattice points GP(Xi, Yj) arranged in the rectangular projection area EIA of FIG. 4 is cross-sectioned in the X direction. Accordingly, the direction of scan-exposure of FIG. 8 is the direction vertical to the sheet of this figure.

In FIG. 8, a test mark (vernier pattern for measurement or the like) is formed at each position of an ideal lattice point under the reticle R. Here, correction is made by locally polishing a surface portion 9-9′ corresponding to the image distortion correction plate G1 for the image light beam LB(1, 1), which originates from the test mark at the lattice point GP(1, 1) in the line SL1, where the image distortion vector DV(i, p1) of FIG. 7 occurs and is incident to the projection optical system PL, and the principal ray ML(1, 1).

To be more specific, the principal ray ML(1, 1) is converted into a principal ray ML′(1, 1) which is tilted by an infinitesimal amount in a predetermined direction by the local slope of the surface portion 9-9′ in order to reduce the image distortion vector DV(i, p1) of FIG. 7. At this time, the image light beam LB(1, 1) from the lattice point GP(1, 1) is also converted into the image light beam LB′(1, 1) which is tilted by the infinitesimal amount by the local slope of the wavelength order of the surface portion 9-9′. Furthermore, in FIG. 8, the principal ray going through the lattice points GP(2, 1) to G (7, 1) among the other ideal lattice points GP(2, 1) to GP(13, 1) on the reticle R are indicated by broken lines. However, the correction is not made to these principal rays and image light beam here.

FIG. 9 is an enlarged diagram of the local surface portion 9-9′ of the image distortion correction plate G1 shown in FIG. 8 and exaggeratedly illustrates the tilt amount of the local slope formed in the surface portion 9-9′ to simplify the explanation. As explained in FIG. 8, above the image distortion correction plate G1, taper is formed in the portion S(1, 1), through which the principal ray ML(1, 1) and the image light beam LB(1, 1) from the ideal lattice point GP(1,1) on the reticle R go, by the tilt amount Δθ(1, 1) according to the tilts of the principal ray ML′(1, 1) and the image light beam LB′(1, 1) to be corrected.

As explained earlier by referring to FIG. 7, the static image distortion vector DV(1, p1) occurring at the lattice point GP(1, 1) must be reduced and corrected in a negative direction of the respective X and Y directions. Therefore, also the portion S(1, 1) shown in FIG. 9 is actually infinitesimally tilted both in the X and Y directions. Additionally, the area of the polishing portion S(1, 1) or the size of the X and Y directions on the image distortion correction plate G1 is determined, ideally, in consideration of a spread angle 2θ na of the image light beam LB(1, 1), which contributes to the projection exposure, so that the image light beam LB(1, 1) is almost entirely covered.

In an actual projection optical system PL, the numerical aperture (NAw) on the wafer W side is expected to be approximately 0.6 to 0.8. If projection magnification is reduced to ¼, the numerical aperture NAr on the reticle R side becomes approximately 0.15 to 0.2. Furthermore, since the numerical aperture NAr on the reticle side and the spread angle 2θ na of FIG. 9 have a relationship of NAr=sin(θ na), the area of the portion S(1, 1) to be polished and processed or the size of the X and Y directions is nonambiguously obtained from the relationship between Z direction interval Hr between the pattern plane (bottom plane) of the reticle R and the surface plane of the image distortion correction plate G1, and the numerical aperture NAr.

Here, correction is not made to the image distortion vector DV(2, p7) by the image light beam including the principal ray ML(2, 1) from the lattice point GP(2, 1) positioned adjacent to the ideal lattice point GP(1, 1) in the X direction. Therefore, needless to say, the portion S(2, 1)corresponding to the image light beam from the lattice point GP(2, 1) on the image distortion correction plate G1 is polished and processed so that the parallel plane can remain the same.

Additionally, in FIG. 9, the portion S(0, 1) at the left of the polished, processed portion S(1, 1) is polished to be a slope which rises to the left so as to return to the original parallel plane. However, there is a case that this portion may be moderately connected to the plane from the portion S(1, 1) as shown by imaginary lines, depending on the existence of the image light beam passing therebetween and the existence of the principal ray correction. Furthermore, in FIGS. 8 and 9, the parallel plane of the image distortion correction plate G1 is arranged perpendicular to the optical axis AX of the projection optical system PL. However, if the entire image distortion correction plate G1 is infinitesimally tilted by the adjustment mechanism, the distortion characteristic (static image distortion vector) emerging on the projection image plane side can be infinitesimally shifted in the X or Y direction.

With the above-described methods shown in FIGS. 8 and 9, the surface of the image distortion correction plate G1 is polished and processed to be locally tilted along each of the 13 lines SL1 to SL13 (see FIG. 4) arrayed in the non-scanning direction (X direction) so that the random distortion characteristic shown in FIG. 6(A) can be corrected to the regular distortion characteristic shown in FIG. 6(B).

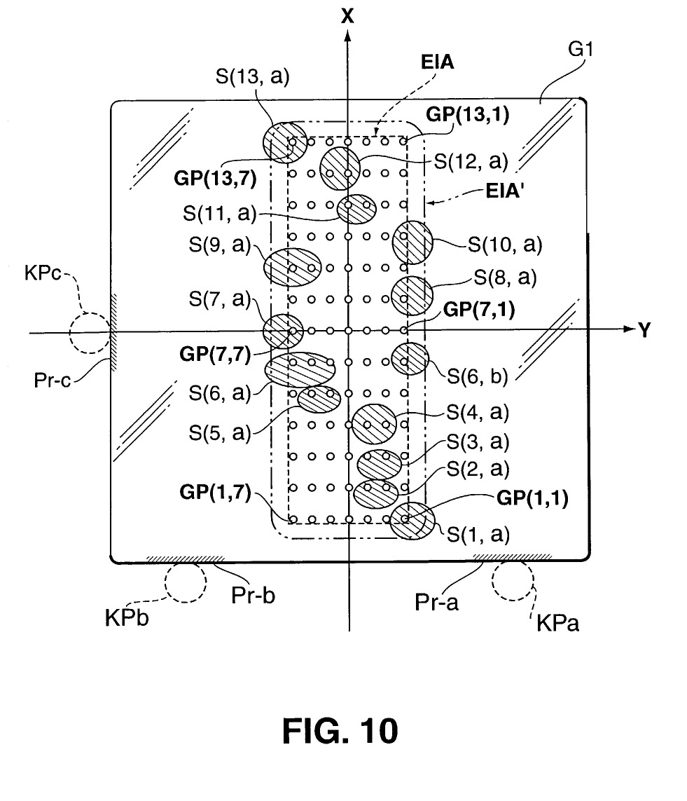

FIG. 10 is a plan view of the image distortion correction plate G1 manufactured by performing such a polishing process. In this embodiment, the entire shape of the image distortion correction plate G1 is set to be a square similar to the reticle R. This is because the blanks (base material) of the reticle R, which is manufactured by strictly managing the precision, the flatness degree, and the like of the parallel flat plane, can be used as-is as the image distortion correction plate G1. Needless to say, blanks particularly for both polished sides can be used.

In FIG. 10, the rectangular effective projection area EIA and the internal 13×7 points are the same as in FIG. 4. The ideal lattice points positioned at the four corners among the 13×7 points are GP(1, 1), (1, 7), (13, 1), and (13, 7), and the ideal lattice points positioned at both ends of the Y axis are GP(7, 1) and (7, 7). Furthermore, the area EIA′ spreading almost with a constant width outside the effective projection area EIA represents the spread portion of the image light beam reaching the image distortion correction plate G1 along with the numerical aperture NAr from the point positioned at the outermost circumference of the projection area EIA on the reticle R.

In FIG. 10, for the sake of convenience, round or elliptic-shaped diagonal-lined areas S(1, a), S(2, a), S(3, a), S(4, a), S(5, a), S(6, a), S(6, b), S(7, a), S(8, a), S(9, a), S(10, a), S(11, a), S(12, a), and S(13, a) are the parts which correct a static image distortion vector by the polishing process shown in FIG. 9. The area S(1, a) among the areas S(i, a) and S(i, b) is equivalent to the polishing area S(1, 1) previously shown in FIG. 9.

As shown in FIG. 10, the polishing process for correcting the static image distortion vector VD(i, j) is basically performed for any one point on the segments (scanning lines SL1 to SL13 shown in FIG. 4) which connect seven lattice points arrayed in the scanning direction (Y direction). However, there is a case that a polishing area (taper portion) may be set in a plurality of locations in the same scanning line as shown in the areas S(6, a) and S(6 b) of FIG. 10 when the correction amount (the tilt amount due to polishing) at one location becomes too large, or depending on the directionality of the image distortion vector to be modified.

Additionally, the area of the respective polishing areas S(i, a) and S(i, b) or the taper amount due to polishing and the tilt direction are determined by the method as previously explained in FIGS. 8 and 9. The polishing areas adjacent to each other are polished, so that the joint surface becomes smooth. Furthermore, in the case of FIG. 10, the respective polishing areas S(i, a) and S(i, b) are relatively dispersed and set. Such dispersion is advantageous to the polishing process.

For example, the tilt directions of the two polishing areas S(2, a) and S(3, a) which are adjacent each other in FIG. 10 are calculated to be almost the same, a relatively acute reverse taper occurs at the boundary between the two polishing areas S(2, a) and S(3, a). Such a reverse taper gives the correction component in a direction which is reverse to the originally intended image distortion vector correction, which also leads to the local deterioration of the image quality of a projected reticle pattern.

Accordingly, if polishing areas which are adjacent in the X direction on the image distortion correction plate G1 have the same tilt direction, it is preferable to review the static image distortion vector DV(i, j) which is selected to place the dynamic distortion characteristic shown in FIG. 6(A) into a desired state shown in FIG. 6(B) and make corrections to shift both polishing areas in the Y direction.

Thus, compared to the distortion characteristic correction assuming static exposure, the static distortion characteristic correction assuming scan-exposure can disperse the polishing areas S(i, a) and S(i, b) on the image distortion correction plate G1, which leads to the advantage that the precision of the polishing process (especially, joint of plane) can be relatively made moderate. On the other hand, this means that the plane shapes of the designated polishing areas S(i, a) and S(i, b) can be precisely processed regardless of the plane shapes of other polishing areas in the surrounding areas.

In the meantime, the blanks for the image distortion correction plate G1 shown in FIG. 10 is set on the XY stage of a special polishing processing machine, relatively precisely moved in the X and the Y directions to a rotation polishing head portion, and polished by pressing the rotation polishing head portion, to a desired polishing area at a calculated tilt angle with a predetermined force. In this case, the processed image distortion correction plate G1 needs to be accurately matched with the positions of the respective ideal lattice points within the projection view field. Therefore, reference edges Pr-a, Pr-b, and Pr-c respectively contacting reference pins (rollers) KPa, KPb, and KPc arranged on the XY stage of the polishing processing machine or the holding frame of the correction plate G1 within the projection exposure apparatus are set on one side parallel to the Y axis and one side parallel to the X axis of the image distortion correction plate G1.

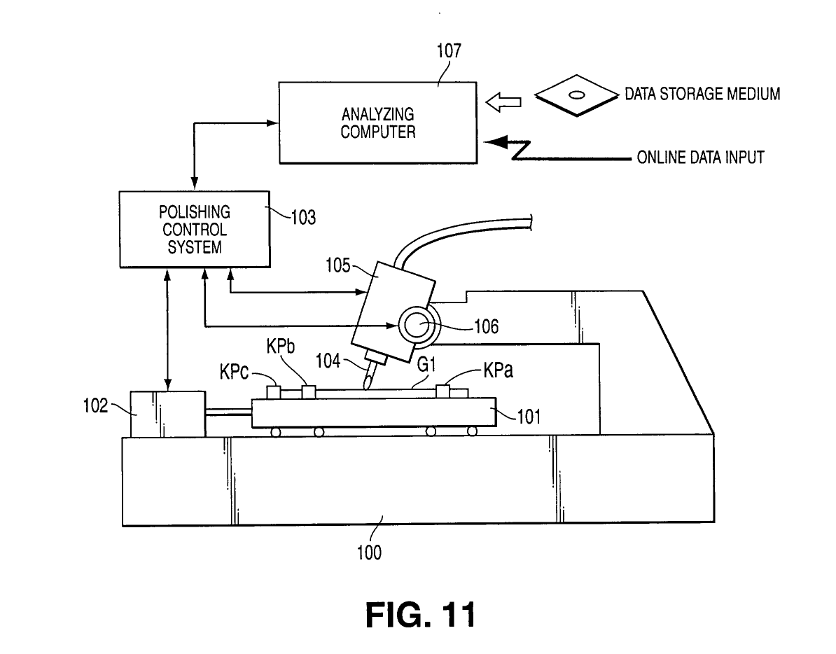

Here, one specific example of the polishing processing machine is explained by referring to FIG. 11, although this is also disclosed by Japanese Laid-Open Patent Application 8-203805 (U.S. patent application Ser. No. 08/581016, filed on Jan. 3, 1996: European Laid-Open Patent Application 0724 199A1). In FIG. 11, the blanks of the image distortion correction plate G1 is regulated and mounted by the reference pins KPa, KPb, and KPc on an XY stage 101 which is movable on the main body of the polishing processor in the X and the Y directions. The XY stage 101 is moved by a driving mechanism 102 and driven by the instruction from a polishing control system 103.

Additionally, the polishing control system 103 controls rotation of the rotation polishing head 104 fixed to the tip of a polishing portion 105 and an angle adjusting portion 106 which adjusts the angle contacted with the tip of the head 104 and the blanks (G1). Furthermore, the polishing control system 103 receives information on the moving position of the XY stage 101 and the moving speed during polishing, and the rotation speed and pressing force of the rotation polishing head 104, the contact angle of the head 104, or the like, which are analyzed by an analyzing computer 107 based on the distortion characteristic measurement data from a data memory medium (a disk, a tape, a card, or the like) or online communication.

The above-described polishing processing machine is arranged in the site where a projection exposure apparatus is assembled and manufactured and is used at the stage where the final imaging performance capability of the apparatus is tested and adjusted. As a matter of course, the polishing processor shown in FIG. 11 may be used for the assembly and manufacturing line of the projection optical system PL. In such a case, the imaging characteristic in a single body state before the projection optical system PL is fixed to the main body of the exposure apparatus can be corrected by the image distortion correction plate G1. However, the imaging characteristic in a single body state of the projection optical system PL may be slightly different from the state where the projection optical system PL is installed within the main body of the apparatus. Accordingly, it is desirable to process the image distortion correction plate G1 with the polishing processing machine of FIG. 11 based on the result (distortion characteristic) of testing the imaging characteristic by using an illumination system of the exposure apparatus after the projection optical system PL is installed within the exposure apparatus.

Meanwhile, the analyzing computer 107 of the polishing processing machine makes, for example, the determination of the respective polishing areas on the blanks of the image distortion correction plate G1 shown in FIG. 10, and the determination of the plane shape (mainly, the tilt amount and direction) in the respective polishing areas, or the like based on measured static distortion characteristics or dynamic distortion characteristics.

At that time, the program which simulates the final state of the polishing process is stored in the memory part of the analyzing computer 107, based on various measured distortion characteristic data, and the result of the simulation is displayed on a display for an operator. In this way, the operator can verify the simulated state and condition of the polishing process on the display and can set the most appropriate processing state by precisely changing and editing various parameters.

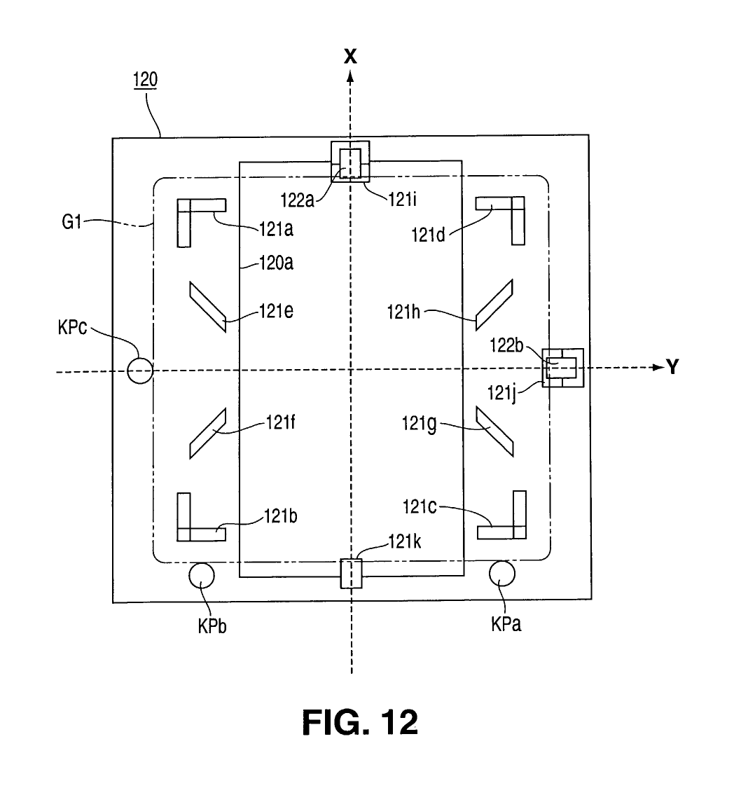

The image distortion correction plate G1 which has been thus manufactured on the support frame 120 as shown in FIG. 12. On the support frame 120, a rectangular aperture 120a which does not shield the imaging light beam going through the effective projection area EIA is formed, and a plurality of convex portions 121a to 121k that support the bottom of the image distortion correction plate G1 are formed in the vicinity of the aperture 120a.

The convex portions 121a-121d support almost four corners of the image distortion correction plate G1. The convex portions 121e-121h support the correction plate G1 in the neighborhood of the center of the aperture 120a. The convex units 121i and 121j respectively support the centers of the right edge and the top edge of the correction plate G1. The convex unit 121k supports the center of the bottom edge of the correction plate G1. With these convex units 121a to 121k, the image distortion correction plate G1 is mounted on the support frame 120 so that the flexure can be minimized.

Additionally, on the support frame 120, two reference rollers KPa and KPb contacting the reference side at the bottom of the image distortion correction plate G1 and one reference roller KPc contacting the reference side of the left of the image distortion correction plate G1 are arranged to be rotatable. The image distortion correction plate G1 is pressed toward the directions of the reference rollers KPa, KPb, and KPc by pressing elements 122a and 122b that are arranged to be slided in the X and Y directions, respectively, on the convex portions 121i and 121j on the support frame 120. Furthermore, an elastic member (leaf spring, spring, or the like) for pressing the image distortion correction plate G1 with a predetermined pressing force against the respective convex portions of the support frame 120 is arranged in the upper space of the surrounding image distortion correction plate G1, although this is not shown in FIG. 12.

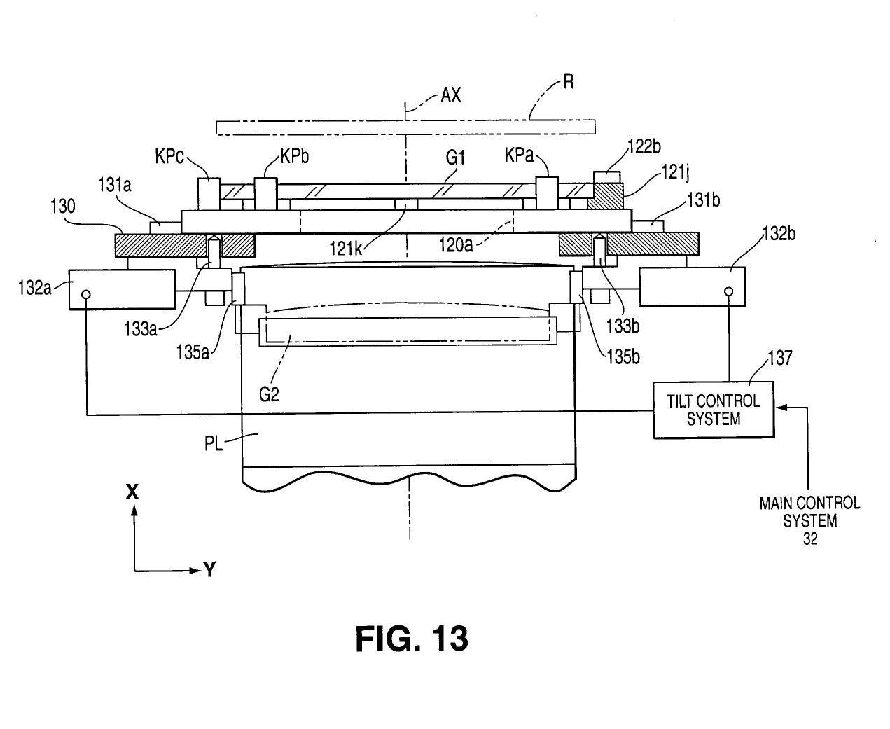

In addition, the support frame 120 shown in FIG. 12 is mounted on a support frame holding member 130 shown in FIG. 13. FIG. 13 is a partial cross-sectional view showing the structure of the upper end portion of the projection optical system PL. The holding member 130 is fixed via a plurality of spacers 135a and 135b not to move in the upward/downward direction (Z direction) and the X and Y directions with respect to the top end portion of the lens barrel of the projection optical system PL.

Furthermore, an aperture which does not shield the view field of the projection optical system PL is formed in the holding member 130, and a plurality of reference members 131a and 131b which position the support frame 120 in the X, Y, and θ directions are arranged on the top surface. Additionally, up/down moving driving elements 133a, 133b, and 133c (133c is not shown in the figure), which are implemented by a direct-acting piston, a piezoelectric element, and the like and are intended for infinitesimally tilting the support frame 120 against the XY plane, and driving units 132a, 132b, and 132c (132c is not shown in the figure) which drive the respective driving elements 133a, 133b (and 133c) are arranged in three locations under the holding member 130.

Each of the driving units 132a, 132b (and 132c) moves the respective driving elements 133a, 133b (and 133c) upward and downward by an optimum amount in response to the controlling instruction from a tilt control system 137 and tilts the support frame 120, that is, the image distortion correction plate G1 by a predetermined amount in a predetermined direction. The tilt direction and amount are determined by the main control system 32 based on preset information pre-stored in the main control system 32 of FIG. 2, or the re-measurement result of the distortion characteristic after the image distortion correction plate G1 is mounted. Additionally, the driving elements 133a and 133b (133c) in the three locations are arranged on the circumference with a predetermined radius which centers the optical axis of the projection optical system PL at an angle of approximately 120°, viewing on the XY plane. By simultaneously moving the driving elements 133a, 133b (and 133c) upward and downward, the interval (“Hr” shown in FIG. 9) between the image distortion correction plate G1 and the reticle R can also be adjusted.

Furthermore, the lens component G2 within the projection optical system PL, which is shown in FIG. 13, is arranged to be movable upward and downward along the optical axis AX of the projection optical system PL or to be tiltable as shown in FIG. 2, and can correct the magnification error of an image which is projected onto the wafer W and a symmetrical distortion (a spool-shaped, a barrel-shaped, a trapezoid-shaped distortion, or the like), which occurs within the entire effective projection area EIA.

Thus, when the polished image distortion correction plate G1 is returned to the initial position in the projection optical path, that is, the arrangement position when the distortion characteristics before the polishing process are measured, the distortion characteristics are re-measured by using the test reticle and it is confirmed whether the dynamic distortion characteristics is in a state, for example, which was shown in FIG. 6(B).

However, in the case of FIG. 6(b), the distortion components which can be approximated by a function are superposed. Therefore, the distortion components which can be approximated by a function need to be ultimately reduced almost to “0” with the infinitesimal adjustment of the magnification by the tilt of the image distortion correction plate G1, the up/down movement and the infinitesimal tilt of the lens component G2, and the pressure control. Then, it is confirmed how much the dynamic distortion characteristic to be re-measured after being reduced to “0” includes a random distortion component. If the random component is within the standard value, a series of the manufacturing process of the image distortion correction plate G1 is completed.

In the meantime, if the random component in the dynamic distortion characteristic is not within the standard value, simulation is again performed by using the computer 107 of FIG. 11 based on the data of the re-measured distortion error, and the image distortion correction plate G1 is re-polished, as needed.

As described above, attention is paid not to the static distortion characteristic (distortion characteristic) in the effective projection area EIA during scanning exposure, but to the dynamic distortion characteristic caused by integration (averaging) over the width of the scanning direction of the projection area EIA. The image distortion correction plate G1 is polished to mainly correct the random component included in the dynamic distortion characteristic. Because of this compared this to the case when the image distortion correction plate G1 is polished to minimize the image distortion vector, for example, at all of the 13×7 ideal lattice points in the effective projection area EIA, the polishing process significantly becomes easier, which leads to an advantage that the planes of polished areas can be joined with high accuracy.

Furthermore, the polishing areas on the image distortion plane G1, which need to have a state where the dynamic distortion characteristic is reduced to “0” or is approximated to a predetermined function can be dispersely set. Therefore, there will be less awkwardly joined planes which are adjacent to each other in the polishing areas. The deterioration of the local image quality of an image which is projected by the projection optical system PL can be minimized.

Additionally, awkwardly joined planes mean that the image distortion vector, which is generated as the imaging light beam from the object point simultaneously going through a plurality of adjacent polished areas, is awkwardly corrected depending on the position of the object point in the XY direction on the reticle R. In order to naturally correct the image distortion vector, it is necessary to smoothly connect all the planes of a plurality of adjacent polished areas by slightly modifying the polished planes of the respective polished areas from a state which is one-dimensionally determined in calculation.

On the base of above-described explanation concerned with basic matters, a method for manufacturing an exposure apparatus according to this embodiment will be specifically described.

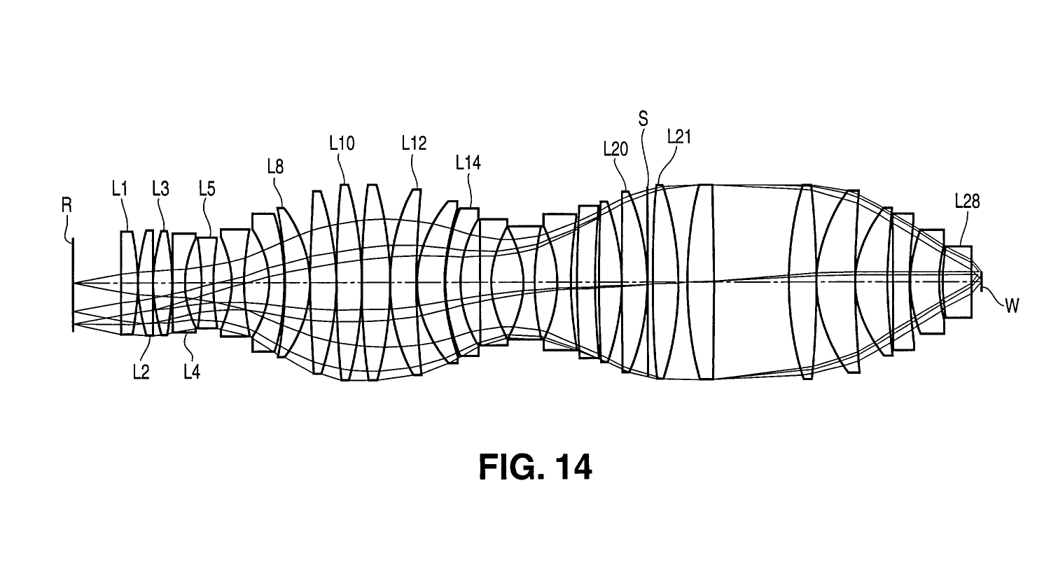

At first, before explaining each manufacturing method specifically, a specific lens structure of a projection optical system PL of an exposure apparatus to which each manufacturing method is applied is described in accordance with FIG. 14. As explained before, the projection optical system PL is not designed on the assumption of inserting (mounting) an image distortion correction plate G1. Because of this, in FIG. 14, the projection optical system PL before mounting an image distortion correction plate G1 is shown.

Furthermore, to simplify the explanation of each manufacturing method, in the exposure apparatus to which each manufacturing method is applied, the excimer laser light source 1 pulse-emits a KrF excimer laser beam with a wavelength of 248 nm, and an optical path is filled with air having normal pressure instead of inert gas.

Additionally, in first and second manufacturing methods, an image distortion correction plate G1 formed of a plane parallel plate with a central thickness (distance along the optical axis) of 1 mm is mounted into the projection optical path between the reticle R and the lens component which is closest to the object side of the projection optical system PL. In third and fourth manufacturing methods, an image distortion correction plate G1 formed of a plane parallel plate with a central thickness of 5 mm is mounted in the same manner.

The projection optical system PL has, in order from the object (reticle) side, twenty lens components L1 to L20, an aperture diaphragm S arranged in a pupil plane of the projection optical system PL, and eight lens components L21 to L28. Here, the lens component L1 is a plano-convex lens having a plane surface facing to the object side, and lens components L2 and L3 are both double convex lenses. The lens component L4 is a negative meniscus lens having a convex surface facing to the object side, and lens components L5 and L6 are both double concave lenses. However, the image (wafer side) side surface of the lens component L5 is formed in an aspherical state. Further, the lens component L7 is a negative meniscus lens having a concave surface facing to the object side, and the lens component L8 is a positive meniscus lens having a concave surface facing to the object side.

Furthermore, lens components L9 to L11 are all double convex lenses, and lens components L12 and L13 are both positive meniscus lenses having convex surfaces facing to the object side. Further, lens components L14 and L15 are both negative meniscus lenses having convex surfaces facing to the object side, and lens components L16 and L17 are both double concave lenses. However, the image side surface of the lens component L16 is formed in an aspherical state. The lens component L18 is a negative meniscus lens having a convex surface facing to the object side, lens component L19 is a double convex lens, and lens component L20 is a positive meniscus lens having a concave surface facing to the object side.

Further, the lens components L21 to L23 are both double convex lenses, and lens components L24 and L25 are both positive meniscus lenses having convex surfaces facing to the object side. Furthermore, the lens component L26 is a double concave lens, the lens component L27 is a positive meniscus lens having a convex surface facing to the object side, and the lens component L28 is a plano-convex surface having a plane surface facing to the image side.

Additionally, the respective lens components L1 to L28 are made of quartz glass having the same refractive index. Further, each space between each lens components is filled with air having normal pressure as described above.

Various values associated with the projection optical system PL are listed in Table 1. In Table 1, NA denotes a numerical aperture on the image side, B denotes a projection magnification, and Y denotes the maximum image height. Further, in Table 1, the first column denotes the lens surface number in order from object side, r in the second column denotes the radius of curvature (the reference radius of curvature, that is, the radius of curvature of vertex when the surface is aspherical) of the lens surface, d in the third column denotes an interval between the lens surfaces, n in the fourth column denotes refractive index for exposure wavelength 248 nm (KrF excimer laser beam), and φ in the fifth column denotes an effective diameter (radius) of the respective lens surfaces.

Furthermore, in each aspherical surface, y denotes the height of direction perpendicular to the optical axis, S(y) denotes a distance (sag amount) along the optical axis from the tangent plane on the vertex of the aspherical surface to a position on the aspherical surface at the height y, R denotes a reference radius of curvature (radius of curvature for the vertex), κ denotes a conical coefficient, and Cₙ denotes n^{th} order aspherical surface coefficient. An aspherical surface is denoted by the following equation (1)

S(y)=(y²/R)/{I+(1−κ−y²/R²}^{½})+C₄·y⁴+C₆·y⁶+C₈·y⁸+C₁₀·y¹0 (1).

In Table 1, the aspherical surface is denoted by adding a mark “*” to the right side of the surface number.

TABLE 1
(Overall information)
NA = 0.75
B = −1/4
Y = 13.2
(Lens information)
Various Values of the Projection Optical System

| Surface | | | | | |
|---|---|---|---|---|---|
| Number | r | d | n | φ | |
| | ∞ | 60.30364 | | | (Object plane: |
| | | | | | reticle plane) |
| 1 | ∞ | 19.50000 | 1.5083900 | 64.261 | (L1) |
| 2 | −367.43243 | 1.00000 | | 65.973 | |
| 3 | 231.88163 | 19.50000 | 1.5083900 | 67.605 | (L2) |
| 4 | −1597.7470 | 1.00000 | | 67.325 | |
| 5 | 301.48740 | 21.00672 | 1.5083900 | 66.504 | (L3) |
| 6 | −386.80818 | 1.00000 | | 65.467 | |
| 7 | 4978.51200 | 15.00000 | 1.5083900 | 63.378 | (L4) |
| 8 | 131.83698 | 20.90777 | | 57.811 | |
| 9 | −367.72545 | 15.00000 | 1.5083900 | 57.627 | (L5) |
| 10* | 237.11310 | 24.68197 | | 58.030 | |
| 11 | −118.35521 | 15.00000 | 1.5083900 | 58.390 | (L6) |
| 12 | 323.86747 | 31.17179 | | 68.225 | |
| 13 | −128.08868 | 19.90004 | 1.5083900 | 70.019 | (L7) |
| 14 | −330.57612 | 0.36522 | | 87.602 | |
| 15 | −451.70891 | 31.68617 | 1.5083900 | 90.155 | (L8) |
| 16 | −157.35194 | 0.50000 | | 95.322 | |
| 17 | 1804.59600 | 32.84090 | 1.5083900 | 113.379 | (L9) |
| 18 | −361.89016 | 0.50000 | | 116.212 | |
| 19 | 1395.82600 | 33.84206 | 1.5083900 | 122.599 | (L10) |
| 20 | −428.19202 | 0.50000 | | 123.947 | |
| 21 | 1277.41500 | 34.21877 | 1.5083900 | 125.157 | (L11) |
| 22 | −445.56748 | 0.50000 | | 125.165 | |
| 23 | 267.66756 | 33.13130 | 1.5083900 | 118.204 | (L12) |
| 24 | 1223.70800 | 0.50000 | | 115.324 | |
| 25 | 154.83354 | 35.00777 | 1.5083900 | 103.162 | (L13) |
| 26 | 273.93265 | 1.00831 | | 96.958 | |
| 27 | 250.84435 | 19.86408 | 1.5083900 | 95.602 | (L14) |
| 28 | 158.82624 | 23.13039 | | 82.303 | |
| 29 | 1773.51400 | 16.20034 | 1.5083900 | 81.329 | (L15) |
| 30 | 129.66539 | 39.64546 | | 70.046 | |
| 31 | −150.28890 | 15.45000 | 1.5083900 | 69.692 | (L16) |
| 32* | 355.16521 | 28.04686 | | 72.212 | |
| 33 | −164.72623 | 18.54000 | 1.5083900 | 72.713 | (L17) |
| 34 | 497.65278 | 7.73228 | | 86.849 | |
| 35 | 1690.25600 | 22.00000 | 1.5083900 | 88.636 | (L18) |
| 36 | 910.10668 | 5.93951 | | 98.274 | |
| 37 | 3604.34900 | 28.72670 | 1.5083900 | 99.813 | (L19) |
| 38 | −302.27256 | 0.50000 | | 103.687 | |
| 39 | −7696.8620 | 33.85812 | 1.5083900 | 112.114 | (L20) |
| 40 | −280.44103 | 0.50000 | | 115.075 | |
| 41 | ∞ | 6.41506 | | 120.672 | (aperture |
| | | | | | diaphragm S) |
| 42 | 1654.09600 | 32.14513 | 1.5083900 | 123.120 | (L21) |
| 43 | −402.98007 | 12.04038 | | 124.076 | |
| 44 | 554.48310 | 34.00000 | 1.5083900 | 125.664 | (L22) |
| 45 | −3270.3720 | 94.28269 | | 125.367 | |
| 46 | 437.38562 | 34.24186 | 1.5083900 | 125.901 | (L23) |
| 47 | −1346.6910 | 1.38280 | | 124.959 | |
| 48 | 197.34670 | 46.41082 | 1.5083900 | 116.010 | (L24) |
| 49 | 1449.38700 | 0.50000 | | 111.321 | |
| 50 | 143.91176 | 39.06481 | 1.5083900 | 94.701 | (L25) |
| 51 | 614.75179 | 7.52352 | | 88.368 | |
| 52 | −15264.654 | 19.00000 | 1.5083900 | 87.339 | (L26) |
| 53 | 387.64835 | 1.61162 | | 72.908 | |
| 54 | 179.44020 | 36.15992 | 1.5083900 | 67.005 | (L27) |
| 55 | 218.60720 | 4.48000 | | 48.700 | |
| 56 | 388.90493 | 34.85555 | 1.5083900 | 47.358 | (L28) |
| 57 | 2402.23200 | 13.48328 | | 28.283 | |
| | ∞ | | | | (Image plane: |
| | | | | | wafer plane) |

[Aspherical Surface]
(Aspherical data in the tenth surface)

| | | |
|---|---|---|
| R | | C₄ |
| 237.11310 | 1.00000 | −0.8373161 × 10⁻⁷ |
| C₆ | C₈ | C₁₀ |
| 0.1702031 × 10⁻¹² | 0.5442826 × 10⁻¹⁶ | −0.9012297 × 10⁻²⁰ |

(Aspherical data in the 32nd surface)

| | | |
|---|---|---|
| R | | C₄ |
| 355.16521 | 1.00000 | 0.6963418 × 10⁻⁷ |
| C₆ | C₈ | C₁₀ |
| −0.3456547 × 10⁻¹¹ | −0.1099178 × 10⁻¹⁵ | 0.6974466 × 10⁻²⁰ |

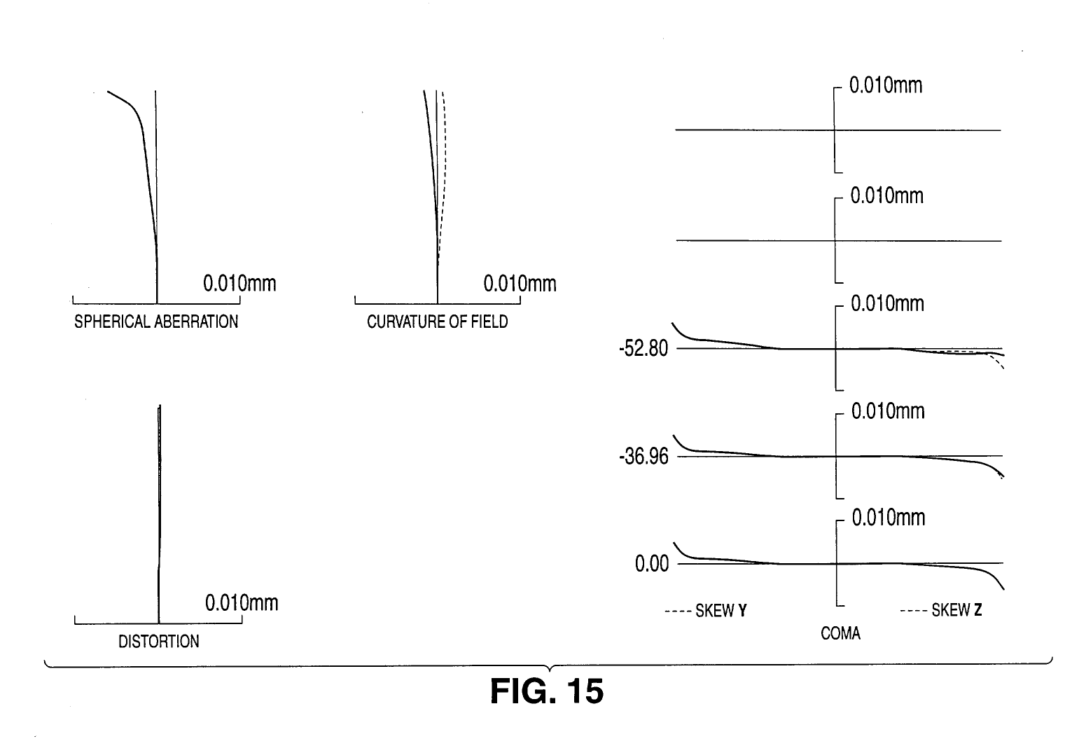

FIG. 15 show various aberrations of the projection optical system PL before mounting the image distortion correction plate G1. In the aberration diagrams showing curvature of field, a solid line indicates a sagittal image plane and a dotted line indicates a meridional image plane.

As described earlier, in the case of assembling the projection optical system PL, the reduction correction is performed by infinitesimally moving lens components and optical members in order to reduce each aberration as small as possible. Further, with the lens barrel of the projection optical system PL being attached to the main body of the apparatus, the adjustment work or the like is performed such that the position of lens components or optical members in the lens barrel is infinitesimally adjusted, and the linear aberration (aberration characteristics which can be approximated by function) is removed as much as possible. Accordingly, as clarified from each aberration diagram, before mounting the image distortion correction lage G1 in the projection optical system PL, various aberrations including spherical aberration can be preferably corrected, and superior imaging quality can be obtained.

However, as described earlier, when the dynamic distortion characteristic measurement, for example, using test reticle is performed and it is confirmed how much random distortion component is contained, if the random distortion component is not within the standard value, the image distortion correction plate G1 is mounted to the projection optical system PL in accordance with a method for manufacturing an exposure apparatus of the invention. Hereafter, the first to fourth manufacturing methods will be described as a typical example of the manufacturing method according to the invention.

[The First Manufacturing Method]

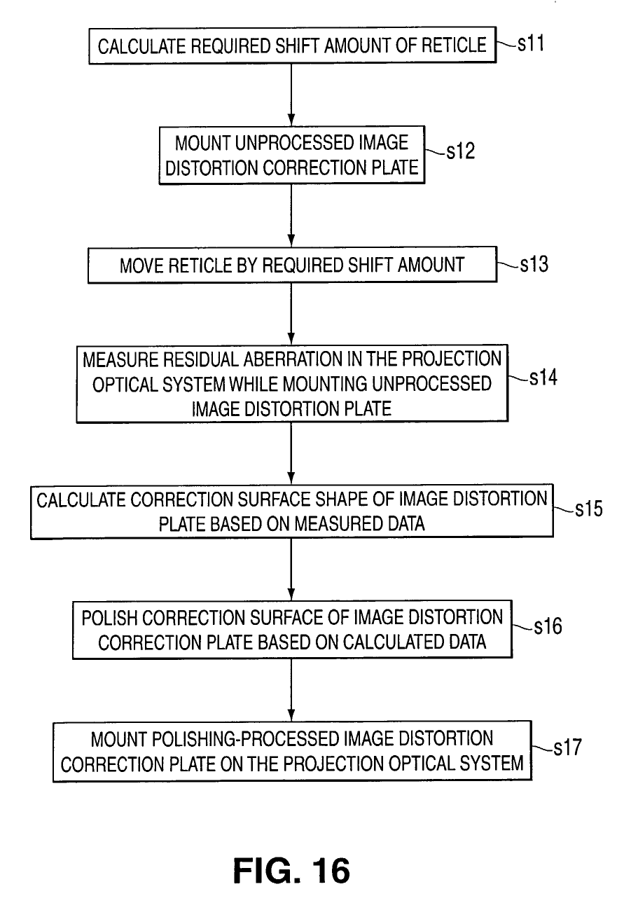

FIG. 16 is a flow chart showing a manufacturing flow of the first manufacturing method of an exposure apparatus in accordance with this embodiment. The first manufacturing method is described below with reference to the flow chart of FIG. 16.

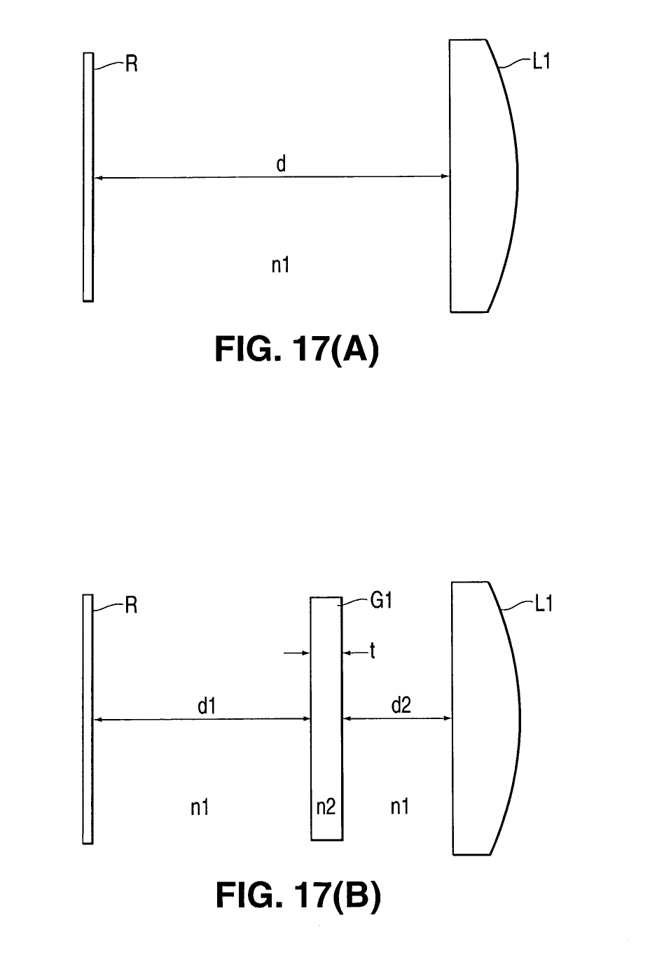

As shown in FIG. 16, in the first manufacturing method, a predetermined shift amount of the reticle plane for correcting variation of aberrations (spherical aberration and the like) generated on the wafer plane along with the thickness of the image distortion correction plate G1 by inserting the image distortion correction plate G1 into the projection optical system PL is calculated (S11). In general, mounting of a plane parallel plate on an optical system changes the object-to-image distance and various aberrations such as spherical aberration, and, as a result, the optical quality becomes worse. When the image distortion correction plate G1 is inserted to the projection optical system PL, the calculation of a predetermined amount of the reticle plane is described below with reference to FIG. 17.

FIG. 17(a) shows a positional relationship between the reticle R and the lens component L1 which is closest to the object side before mounting the image distortion correction plate G1. In this case, an on-axis interval d between the reticle R and the lens component L1 is 60.30364 mm as shown in Table 1, and the refractive index n1 of a medium (in this case, air) between the reticle R and the lens component L1 is 1. Therefore, the reduced air interval D between the reticle R and the lens component L1 can be shown by the following equation (2):

D=d/n1=60.30364 mm (2).

Meanwhile, FIG. 17(b) shows a positional relationship between the reticle R, the image distortion correction plate G1, and the lens component L1 after mounting the image distortion correction plate G1. Here, the thickness t of the image distortion correction plate G1 is 1 mm, and the refractive index n2 is 1.50839 as shown in Table 1. Furthermore, an on-axis interval between the reticle R and the image distortion correction plate G1 is d1, and an on-axis interval between the image distortion correction plate G1 and the lens component L1 is d2. Needless to say, the relationship of the following equation (3) can be established:

d−d1+t+d2 (3).

In addition, the reduced air interval D1 between the reticle R and the lens component L1 shown in FIG. 17(b) can be shown by the following equation (4):

D1=(d1+d2)/n1+t/n2 (4).

Accordingly, the changing amount ΔD of the reduced air interval between the reticle R and the lens component L1 caused by mounting the image distortion correction plate G1 is expressed by the following equation (5):

ΔD=D1−D=(d1+d2)−(1/n1−1)+t−(1/n2−1) (5).

Here, because n1=1, the changing amount ΔD of the reduced air interval can be shown by the following equation (6):

ΔD=t−(1/n2−1)=1×(1/1.50839−1)=−0.3370415 mm (6).

In other words, by mounting the image distortion correction plate G1, the reduced air interval between the reticle R and the lens component L1 becomes shorter by 0.3340415 mm. As a result, it is understood that the object-to-image distance of the projection topical system PL also becomes shorter by 0.3340415 mm.

Thus, in the first manufacturing method, the predetermined shift amount of the reticle plane for correcting variation in aberration generated on the wafer plane along with the thickness of the image distortion correction plate G1 by mounting the image distortion correction plate G1 on the projection optical system PL considered as a changing amount of the reduced air interval between the reticle R and the lens component L1, that is, the changing amount of the object-to-image distance of the projection optical system PL and calculated from above-mentioned equation (6) which depends on the thickness t of the image distortion correction plate G1 to be inserted and the refractive index n2 (S11).

Then, an unprocessed image distortion correction plate G1 or a measurement optical member with the same optical thickness as the image distortion correction plate G1 to be mounted (i.e., a dummy plane parallel plate with thickness of 1 mm) is mounted in a predetermined position in the projection optical system PL and, positioned (S12).

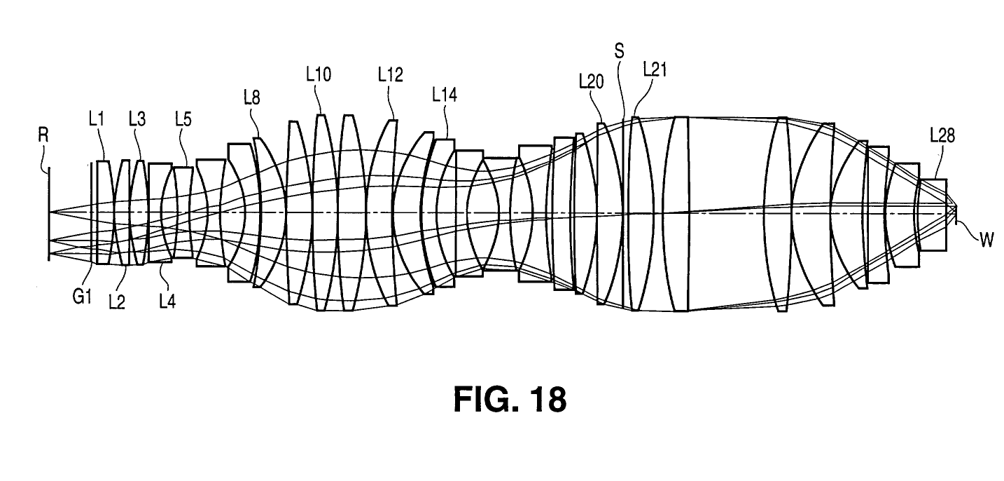

Hereafter, the unprocessed image distortion correction plate G1 instead of the measurement optical member is arranged in a predetermined position in the projection optical system PL. At this time, it is needless to say that a holding member (the support frame 120 described earlier) to hold the unprocessed image distortion correction plate G1 in a predetermined position is arranged in advance prior to the process that the unprocessed image distortion correction plate G1 is set in a predetermined position in the projection optical system PL. FIG. 18 shows a state where an image distortion correction plate G1 with a thickness of 1 mm is inserted in a predetermined position in the projection optical system PL. Specifically, the unprocessed image distortion correction plate G1 is positioned so that the on-axis interval d2 with the lens component L1 is 8.39368 mm.

Further, in order to correct variation in aberration generated on the wafer plane caused by mounting the image distortion correction plate G1, the reticle stage 8, as a result, reticle R is moved by the predetermined shift amount calculated in step S11 (S13). Specifically, as shown in equation (6), since the reduced air interval between the reticle R and the lens component L1 become shorter by 0.337045 mm due to insertion of the image distortion correction plate G1, in order to correct the change of the object-to-image distance, the reticle R is moved in the direction away from the lens component L1 by 0.337045 mm along the optical axis. Meanwhile, step S12 for mounting the unprocessed image distortion correction plate G1 and step S13 for moving the reticle R are interchangeable, and step S13 for moving the reticle R can be performed prior to step S12 for mounting the unprocessed image distortion correction plate G1.

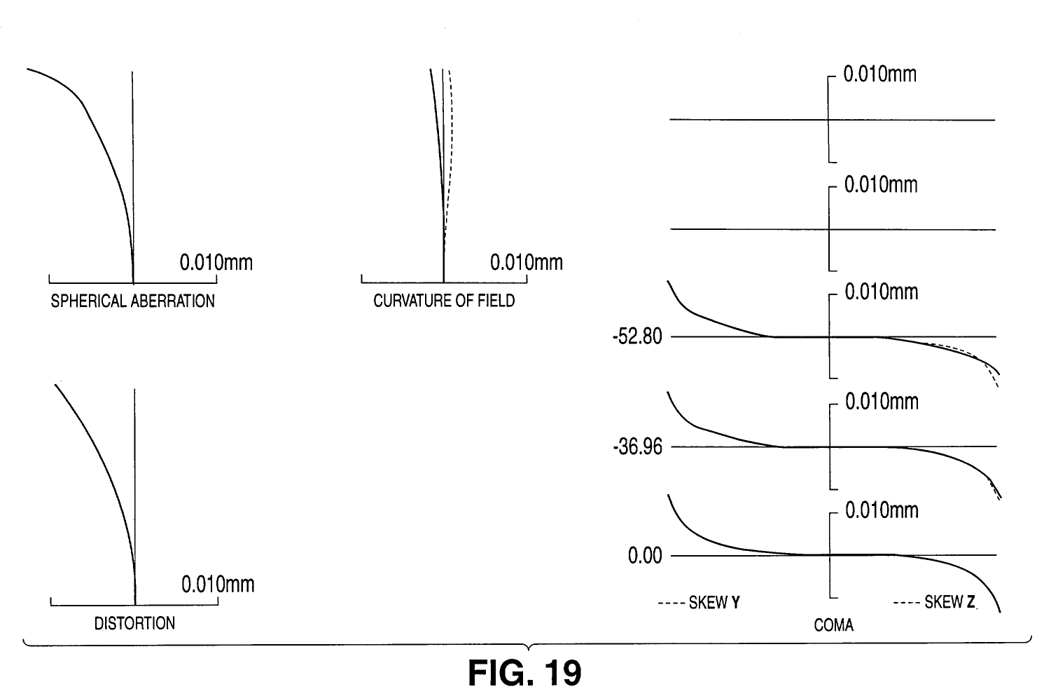

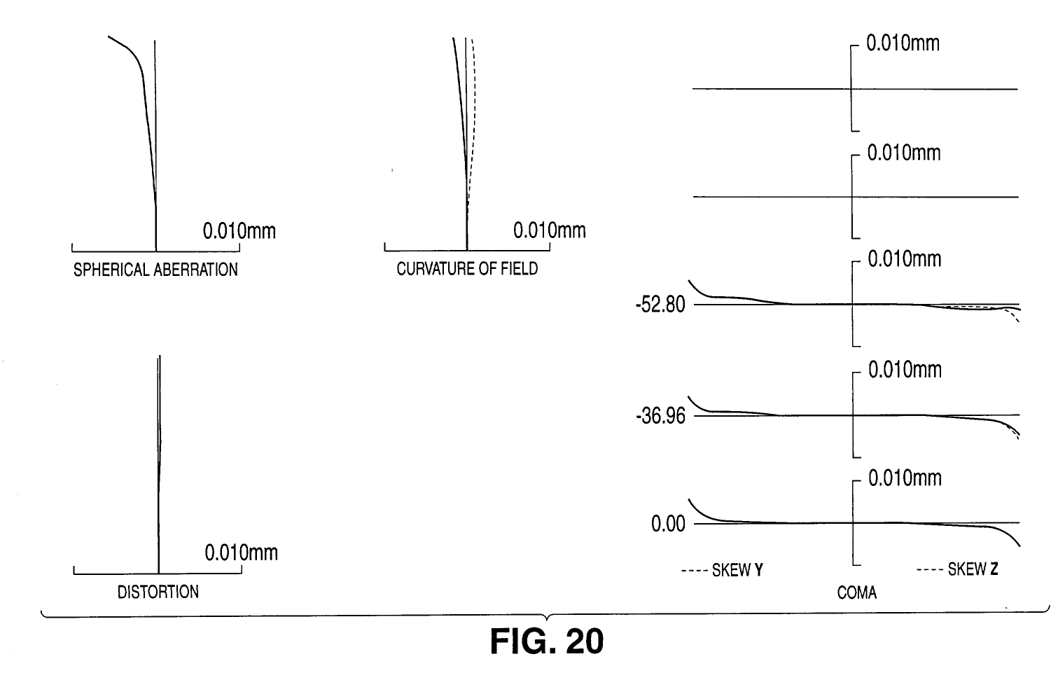

FIG. 19 shows various aberration diagrams of the projection optical system PL in a state before the reticle R is moved after the distortion correction plate G1 is mounted. Furthermore, FIG. 20 shows various aberration diagrams of the projection optical system PL in a state where the reticle R has been moved and the image distortion correction plate G1 is mounted. In FIGS. 19 and 20, in the same manner as in FIG. 15, in the aberration diagrams showing curvature of an image plane, a solid line indicates a sagittal image plane and a dotted line indicates a meridional image plane.

In comparison between FIGS. 19 and 15, particularly spherical aberration and distortion become significantly poor due to insertion of the image distortion correction plate G1. Further, in comparison between FIGS. 20, 19 and 15, by correcting the change of the object-to-image distance due to insertion of the image distortion correction plate G1 by moving the reticle R by a predetermine shift amount, significantly degraded spherical aberration and distortion due to insertion of the image distortion correction plate G1 can be preferably corrected, and the preferable aberration state (state of FIG. 15) before the image distortion correction plate G1 is inserted is returned. In other words, even if the projection optical system PL has been designed and assembled without the assumption of mounting the image distortion correction plate G1, substantially the same aberration state, where the prearranged unprocessed image distortion correction plate is inserted, which is designed on the assumption of mounting an image distortion correction plate can be realized.

Then, in the first manufacturing method, aberration remained in the projection optical system PL is measured in a state where an unprocessed image distortion correction plate G1 is inserted in the projection optical system PL(S14). Specifically, as described above, a measuring operation of distortion characteristic, for example, using a test reticle, is performed. Random distortion components, that is, distortion errors, included in dynamic distortion characteristics are obtained. Then, based on the distortion error data which was obtained in step S14 of the residual aberration of the projection optical system PL, simulation is performed by the computer 107 of FIG. 11, and a correction surface shape of the image distortion correction plate G1 is calculated (S15).

Then, the unprocessed image distortion correction plate G1 mounted on the projection optical system PL is removed and set on the XY stage of the polishing processing machine shown in FIG. 11. Then, by pressing the rotation polishing head portion by a predetermined force into a desired polishing area at a calculated tilt angle, based on the calculation in step S15, the correction surface of the image distortion correction plate G1 is polished in a predetermined surface shape (S16). Further, predetermined coating (reflection prevention film or the like) is performed in the correction surface of the polished image distortion correction plate G1, as needed

Finally, the polished image distortion correction plate G1 is mounted and positioned in a predetermined position in the projection optical system PL (S17). In other words, the polished image distortion correction plate G1 is returned to a position where the unprocessed image distortion correction plate G1 has been arranged when distortion characteristics are measured prior to the polishing process.

In this state, the measuring operation of the distortion characteristics using a test reticle is again performed and it is confirmed whether the dynamic distortion characteristic is in a state, for example, shown in FIG. 6(B). When the dynamic distortion characteristic are in a state, for example, shown in FIG. 6(B), the distortion components which can be approximated by a function is reduced almost to “0” by the magnification infinitesimal adjustment due to the tilt of the image distortion correction plate G1, up/down movement and the infinitesimal tilt of the lens component G2, or the pressure control. Then, it is confirmed how much random components are included in the dynamic distortion characteristic to be re-measured after the reduction adjustment. If the random component is within the standard value, a series of the manufacturing process related to the first manufacturing method is completed.

[The Second Manufacturing Method]

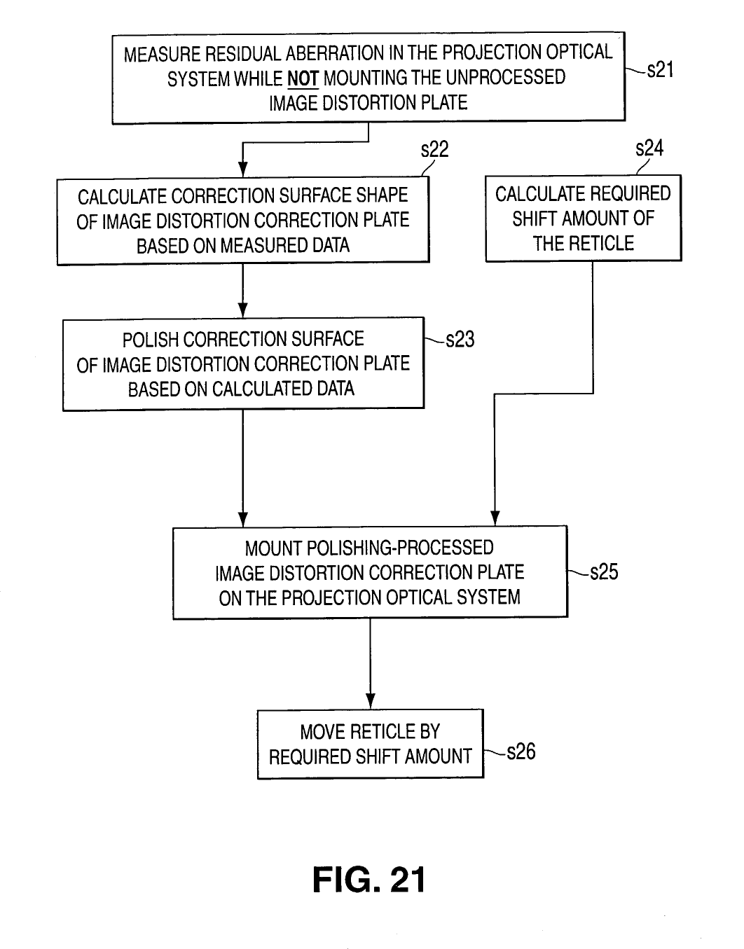

FIG. 21 is a flow chart showing a manufacturing flow of a second manufacturing method of an exposure apparatus in accordance with this embodiment.

The second manufacturing method is similar to the first manufacturing method because the image distortion correction plate G1 which is formed of a plane parallel plate with the thickness of 1 mm is arranged in a predetermined position of the projection optical system PL. However, the measurement in the first manufacturing method that residual aberration is measured while the unprocessed image distortion correction plate G1 (or a measurement optical member) is mounted on the projection optical system PL is basically different from that in the second manufacturing method that residual aberration is measured while the unprocessed image distortion correction plate G1 (or a measurement optical member) is not mounted on the projection optical system PL. The second manufacturing method is described below in view of the difference from the first manufacturing method with reference to the flow chart of FIG. 21.

In the second manufacturing method different from the first manufacturing method as shown in FIG. 21, residual aberration in the projection optical system PL is measured while the unprocessed image distortion correction plate G1 or the measurement optical member is not mounted on the projection optical system PL (S21). Specifically, measuring operation of distortion characteristics, for example, using a test reticle is performed. Random distortion components included in the dynamic distortion characteristics are obtained. Then, based on the obtained distortion error data, a correction surface shape of the image distortion correction plate G1 to be inserted and arranged in the projection optical system PL is calculated (S22).

Then, a blank for the image distortion correction plate G1 shown in FIG. 10 is set on the XY stage of the polishing processing machine. Furthermore, by pressing the rotation polishing head portion into a desired polishing area at a calculated tilt angle by a predetermined force, the correction surface of the image distortion correction plate G1 is polished in a predetermined surface shape based on the calculation result of step S22 (S23). Additionally, predetermined coating is performed in the correction surface of the polished image distortion correction plate G1, as needed.

Meanwhile, independent from the measurement of the residual aberration of the projection optical system PL (S21), the calculation of the correction surface shape of the image distortion correction plate G1 (S22), and the polishing process of the correction surface of the image distortion correction plate G1 (S23), a predetermined shift amount of the reticle plane for correcting degradation of the optical characteristics (variation in aberration on the wafer plane or the like) generated due to insertion of an image distortion correction plate G1 to the projection optical system PL is calculated (S24).

Then, the polished image distortion correction plate G1 is inserted to a predetermined position in the projection optical system PL and positioned (S25). In other words, in the same manner as in the first manufacturing method, the processed image distortion correction plate G1 is positioned so that the on-axis interval d2 with the lens component L1 is 8.39368 mm.

Furthermore, the reticle stage 8, namely, the reticle R is moved by a predetermined shift amount calculated in step S24 in order to correct degradation of optical characteristics generated due to insertion of the image distortion correction plate G1 (S26). Specifically, in the same as in the first manufacturing method, the reticle R is moved in the direction away from the lens component L1 by 0.337045 mm along the optical axis. Step (S25) of mounting the polished image distortion correction plate G1 and step (S26) of moving the reticle R are interchangeable, and step S26 of moving the reticle R can be performed before performing step S25 of mounting the polished image distortion correction plate G1.

In this state, the measuring operation of the distortion characteristics using a test reticle is re-performed and it is confirmed whether the dynamic distortion characteristics are in a state, for example, shown in FIG. 6(B). When the dynamic distortion characteristics are in a state, for example, shown in FIG. 6(B), the distortion components which can be approximated by function is reduced almost to “0” with the magnification infinitesimal adjustment by the tilt of the image distortion correction plate G1, up/down movement and the infinitesimal tilt of the lens component G2, or the pressure control. Then, it is confirmed how much random components are included in the dynamic distortion characteristic to be re-measured after reduction adjustment. If the random component is within the standard value, a series of the manufacturing process of the second manufacturing method is completed.

[The Third Manufacturing Method]

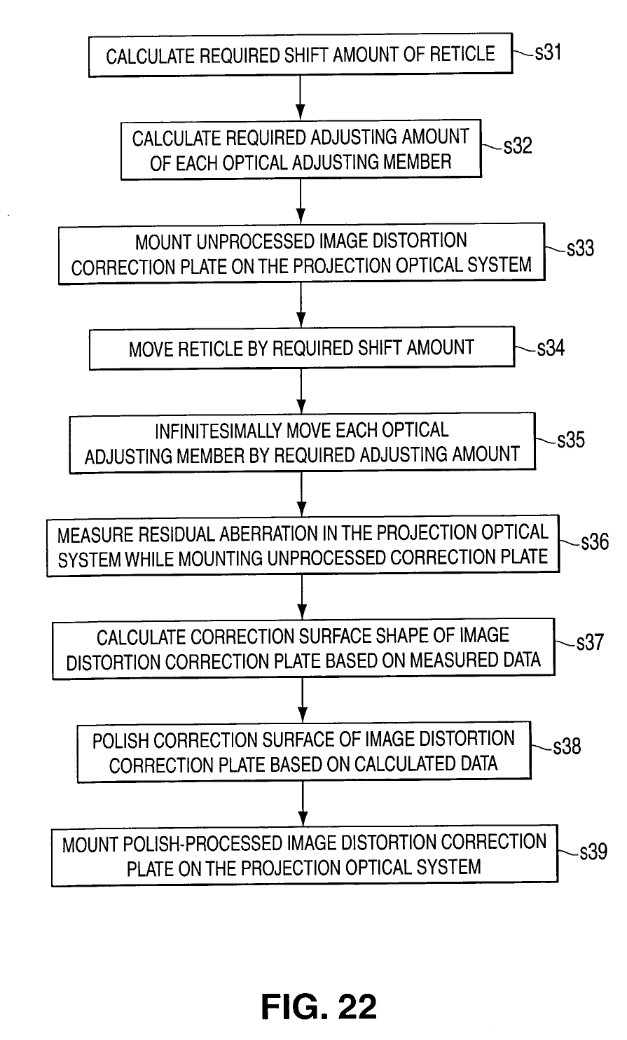

FIG. 22 is a flow chart showing a manufacturing flow of a third manufacturing method of an exposure apparatus in accordance with this embodiment.

The third manufacturing method is similar to the first manufacturing method because residual aberration is measured while the unprocessed image distortion correction plate (or a measurement optical member) is inserted to the projection optical system PL. However, in the first manufacturing method, an image distortion correction plate G1 formed of a plane parallel plate with the thickness of 1 mm is arranged in a predetermined position of the projection optical system PL. This is basically different from the second manufacturing method because an image distortion correction plate G1 formed of a plane parallel plate with the thickness of 5 mm is arranged in a predetermined position of the projection optical system PL. The third manufacturing method is described below aiming at the difference from the first manufacturing method with reference to the flow chart shown of FIG. 22.

As shown in FIG. 22, in the third manufacturing method, in the same manner as in the first manufacturing method, a predetermined shift amount of the reticle plane for correcting degradation of optical characteristics (variation in aberration on the wafer plane or the like) generated due to insertion of the image distortion correction plate G1 to the projection optical system PL is calculated (S31). In the third manufacturing method, the thickness t of the image distortion correction plate G1 is 5 mm, and the refractive index n2 is 1.50839 as shown in Table 1. Therefore, a predetermined shift amount to be calculated based on the above-mentioned equation (6) is 1.6852075 mm.

Thus, in the third manufacturing method, compared to the first manufacturing method, the thickness of the image distortion correction plate G1 to be inserted to the projection optical system PL is five times. In response to this, the required shift amount of the reticle R also becomes five times. Therefore, it is assumed that various aberrations such as a spherical aberration, or a distortion, which may become severely worse due to insertion, the image distortion correction plate G1 cannot be completely corrected by correcting the change of the object-to-image distance due to insertion of the image distortion correction plate G1 by moving the reticle R by a predetermined shift amount, and a preferable aberration state (the state of FIG. 15) before the image distortion correction plate G1 is inserted cannot be returned.

Accordingly, in the third manufacturing method, when the change of the object-to-image distance due to insertion of the image distortion correction plate G1 is corrected by moving the reticle R by a predetermined shift amount, in order to correct residual aberration in the projection optical system PL, a predetermined adjusting amount (correction amount) of optical members (adjusting optical members) which structures the projection optical system PL is calculated (S32). Furthermore, in the third manufacturing method, the lens components L3, L8, L10, L12 and L14 among 28 lens components L1 to L28 which structure the projection optical system PL can be moved along the optical axis. Then, in step (S32) of calculating a predetermined adjustment amount of the adjustment optical members, in order to correct residual aberration in the projection optical system PL after the reticle R is moved by a predetermined shift amount, each predetermined adjustment amount of the lens components L3, L8, L10, L12 and L14 which structure the projection optical system PL is calculated.

Next, the unprocessed image distortion correction plate G1 or the measurement optical member with the same optical thickness as the image distortion correction plate G1 to be inserted (i.e., a dummy plane parallel plate with thickness of 5 mm) is inserted in a predetermined position of the projection optical system PL and positioned (S33). The unprocessed image distortion correction plate G1 instead of the measurement optical member is positioned in a predetermined position of the projection optical system PL.

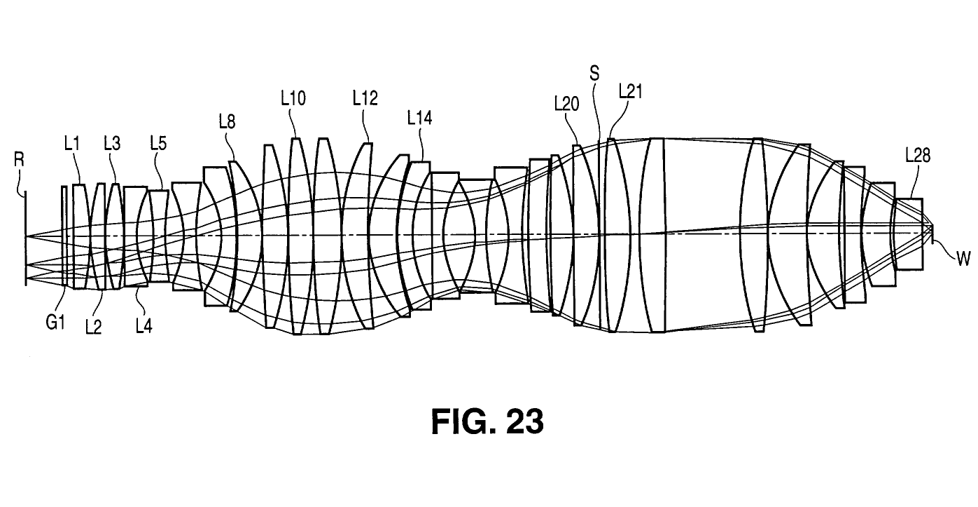

Furthermore, FIG. 23 shows a state where an distortion correction plate G1 with thickness of 5 mm is inserted in a predetermined position of the projection optical system PL. Specifically, in the same manner as in first manufacturing method, the unprocessed image distortion correction plate G1 is positioned so that the on-axis interval d2 to the lens component L1 becomes 8.39368 mm.

Further, in order to correct changes of aberration generated on the wafer plane due to insertion of the image distortion correction plate G1, the reticle stage 8, as a result, the reticle R is moved by a predetermined shift amount calculated in step S31 (S34). Specifically, since the reduced air interval between the reticle R and the lens component L1 becomes shorter by 1.6852075 mm due to insertion of the image distortion correction plate G1, in order to correct the change of the corresponding object-to-image distance, the reticle R is moved in the direction away from the lens component L1 by 1.6852075 mm along the optical axis.

Further, in order to correct residual aberration in the projection optical system PL after the reticle R is moved by a predetermined shift amount, the lens components L3, L8, L10, L12 and L14 as adjustment optical members are infinitesimally moved along the optical axis (S35), respectively. Specifically, in order to correct residual aberration in the projection optical system PL, the lens component L3 is moved to the wafer side by 0.0119374 mm, the lens component L8 is moved to the wafer side by 0.0072187 mm, the lens component L10 is moved to the reticle side by 0.1027939 mm, the lens component L12 is moved to the reticle side by 0.0154154 mm, and the lens component L14 is moved to the wafer side by 0.0124903 mm, respectively.

Additionally, step S33 for mounting the unprocessed image distortion correction plate G1, step S34 for moving the reticle R, and step S35 for infinitesimally moving adjustment optical members are interchangeable, step S34 for moving the reticle R and step S35 for infinitesimally moving adjustment optical members can be performed before step S33 for mounting the unprocessed image distortion correction plate G1.

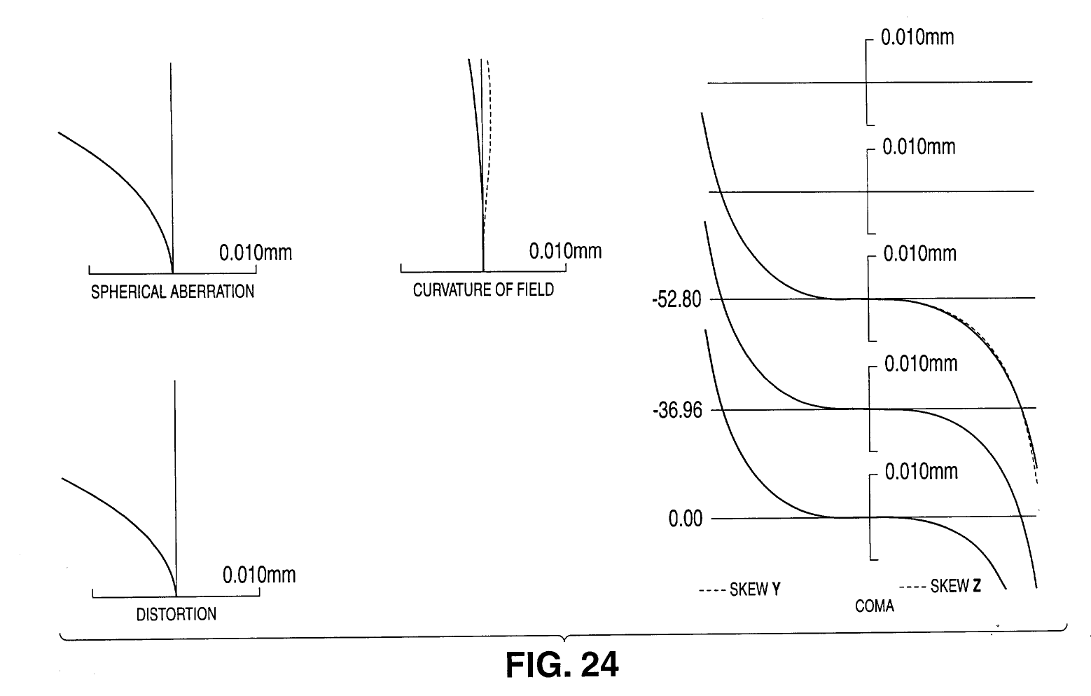

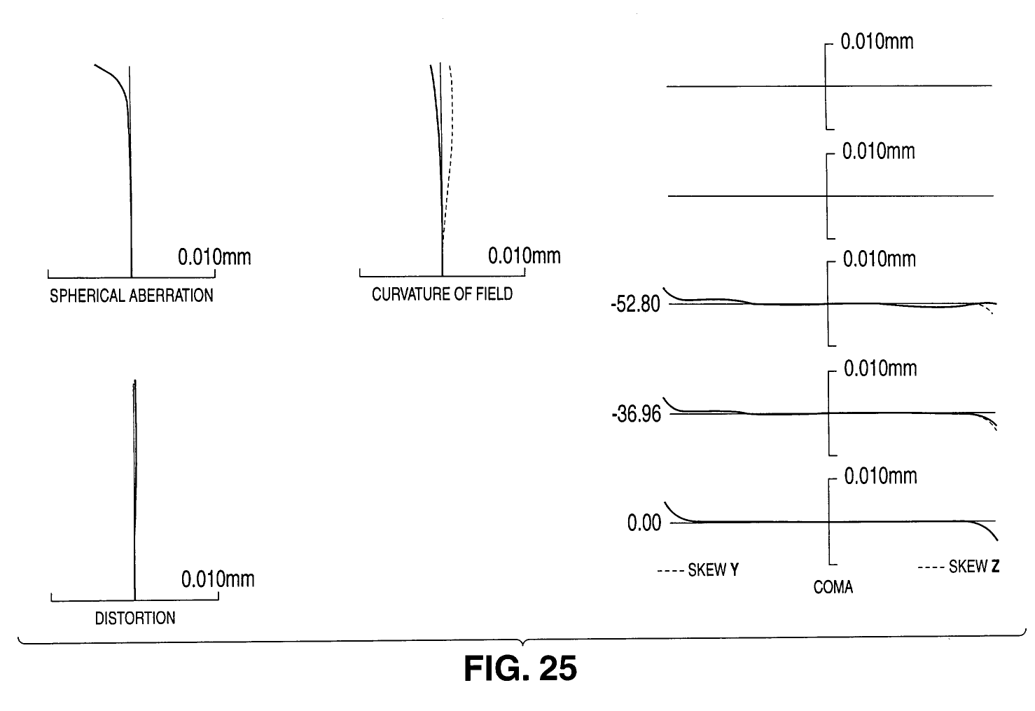

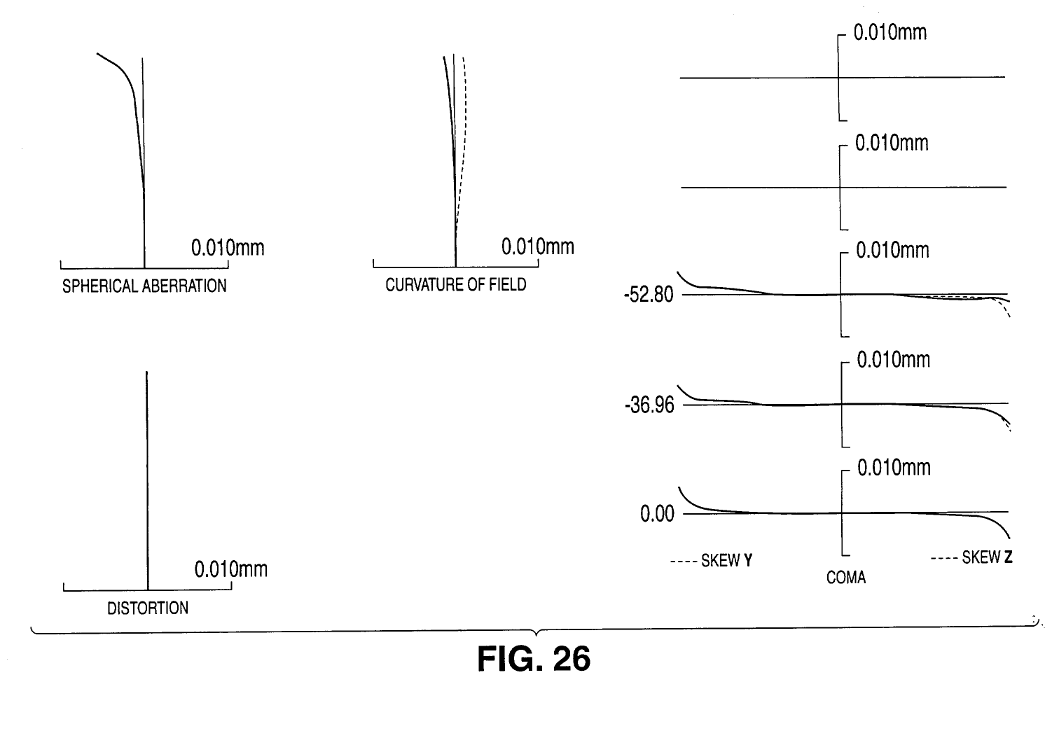

FIG. 24 shows various aberration diagrams of the projection optical system PL in a state where the reticle R is moved after the image distortion correction plate G1 is inserted. Furthermore, FIG. 25 shows various aberration diagrams of the projection optical system PL in a state where the reticle R has been moved after the distortion correction plate G1 is inserted. FIG. 26 shows various aberration diagrams of the projection optical system PL in a state where the reticle R has been moved and the respective adjustment optical member have been infinitesimally moved by a predetermined adjusting amount after the image distortion correction plate G1 is inserted.

In FIGS. 24 to 26 as well, in the same manner as in FIG. 15, in the aberration diagrams showing curvature of an image plane, a solid line indicates a sagittal image plane, and a broken line indicates a meridional image plane.

In comparison between FIGS. 24 and 15, particularly spherical aberration and distortion become severely worse due to insertion of the image distortion correction plate G1. Further, in comparison between FIGS. 24 and 19, since the third manufacturing method has larger thickness of the image distortion correction plate G1 than that of the first manufacturing method, the third manufacturing method shows more severe degradation of various aberrations such as spherical aberration and distortion.

Further, in comparison between FIGS. 25 and 24, by correcting the change of the object-to-image distance due to insertion of the image distortion correction plate G1 by moving the reticle R by a predetermined shift amount, severely degraded spherical aberration and distortion due to insertion of the image distortion correction plate G1 can be preferably corrected.

However, in comparison between FIGS. 25 and 15, the spherical aberration is excessively corrected by moving the reticle R. As a result, the entire aberration becomes unbalanced, and the state of other various aberrations has not returned to a preferable aberration state (state of FIG. 15) before the image distortion correction plate G1 is inserted.

Furthermore, in comparison between FIGS. 26 and 15, by moving the reticle R (S34) and infinitesimal moving the respective adjustment optical members (S35), severely degraded spherical aberration and distortion due to insertion of the image distortion correction plate G1 (S33) can be preferably corrected, and the preferable aberration state (state of FIG. 15), before the image distortion correction plate G1 is not inserted, is returned.

Therefore, in the third manufacturing method as well, in the same as in the first manufacturing method, aberration remained in the projection optical system PL is measured in a state where the unprocessed image distortion correction plate G1 is inserted in the projection optical system PL (S36). Specifically, as described above, a measuring operation of distortion characteristics, for example, using a test reticle, is performed. Random distortion components included in the dynamic distortion characteristics are obtained. Then, based on the distortion error data obtained in step S36 of the measuring process of the residual aberration in the projection optical system PL, a correction surface shape of the image distortion correction plate G1 is calculated (S37).

Next, the unprocessed image distortion correction plate G1 mounted on the projection optical system PL is removed and set on the XY stage of the polishing processing machine shown in FIG. 11. Then, by pressing the rotation polishing head portion into a desired polishing area at a calculated tilt angle with a predetermined force, the correction surface of the image distortion correction plate G1 is polished in a predetermined surface shape, based on the calculation result of step S37 (S38). Further, predetermined coating is performed in the correction surface of the polished image distortion correction plate G1, as needed.

Finally, the polished image distortion correction plate G1 is inserted in a predetermined position in the projection optical system PL and positioned (S39). In other words, the polished image distortion correction plate G1 is returned to a position where the unprocessed distortion characteristics are measured.

In this state, a measuring operation of the distortion characteristics using a test reticle is re-performed and it is confirmed the dynamic distortion characteristic is in a state, for example, shown in FIG. 6(B). When the dynamic distortion characteristic is in a state, for example, shown in FIG. 6(B), the distortion component which can be approximated by function is reduced almost to “0” with the magnification infinitesimal adjustment by the tilt of the image distortion correction plate G1, up/down movement and the infinitesimal tilt of the lens component G2, or the pressure control. Then, it is confirmed how much random distortion components are included in the dynamic distortion characteristics to re-measure after the reduction adjustment. If the random component is within the standard value, a series of the manufacturing process related to the third manufacturing method is completed.

[The Fourth Manufacturing Method]

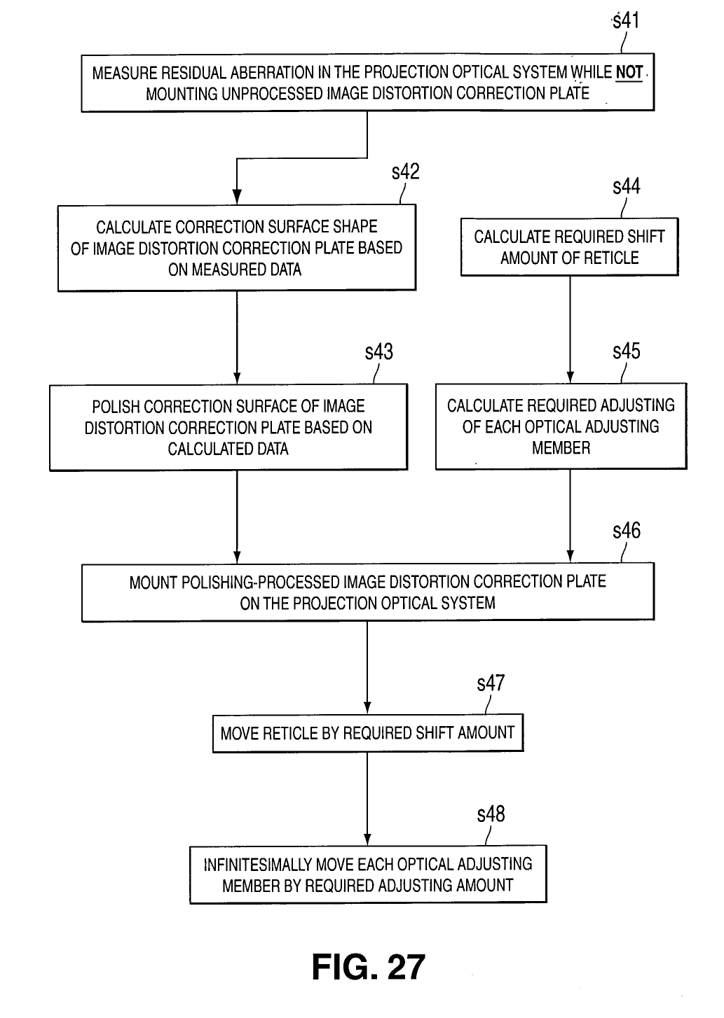

FIG. 27 is a flow chart showing a manufacturing flow of a fourth manufacturing method of an exposure apparatus in accordance with this embodiment.

The fourth manufacturing method is similar to a third manufacturing method because an image distortion correction plate G1 formed of a plane parallel plate with the thickness of 5 mm is arranged in a predetermined position in the projection optical system PL. However, in the third manufacturing method, residual aberration is measured while an unprocessed image distortion correction plate (or a measurement optical member) is inserted to the projection optical system PL. This is basically different from the fourth manufacturing method because residual aberration is measured while an unprocessed image distortion correction plate (or a measurement optical member) is not inserted in the projection optical system PL. The fourth manufacturing method is described below aiming at the difference from the third manufacturing method with reference to the flow chart of FIG. 27.

As shown in FIG. 27, in fourth manufacturing method which is different from the first and third manufacturing method, residual aberration in the projection optical system PL is measured while an unprocessed image distortion correction plate or a measurement optical member is not inserted in the projection optical system PL (S41). Specifically, in the same as in the second manufacturing method, a measuring operation of distortion characteristics, for example, using a test reticle is performed. Random distortion characteristics included in the dynamic distortion characteristics are obtained. Then, based on the obtained distortion error data, a correction surface shape of the image distortion correction plate G1 to be inserted and arranged to the projection optical system PL is calculated (S42).

Next, a blank for the image distortion correction plate G1 shown in FIG. 10 is set on the XY stage of the processing polishing machine. Then, by pressing the rotation polishing head portion in a desired polishing area at a calculated tilt angle with a predetermined force, the correction surface of the image distortion correction plate G1 is polished in a predetermined surface shape, based on the calculation result of step S42 (S43). Further, predetermined coating is performed in the correction surface of the polished image distortion correction plate G1, as needed.

Meanwhile, independent from the measurement of the residual aberration in the projection optical system PL (S41), the calculation of the correction surface shape of the image distortion correction plate G1 (S42), and the polishing process of the correction surface of the image distortion correction plate G1 (S43), a predetermined shift amount of the reticle plane for correcting degradation of the optical characteristics generated due to insertion of the image distortion correction plate G1 to the projection optical system PL is calculated (S44).

Further, while the change of the object-to-image distance due to insertion of the image distortion correction plate G1 is corrected by moving the reticle R by a predetermined shift amount, in order to correct residual aberration in the projection optical system PL, a predetermined adjusting amount of adjustment optical members comprising the projection optical system PL is calculated (S45), independent from the measurement of the residual aberration in the projection optical system PL (S41), the calculation of the correction surface shape of the image distortion correction plate G1 (S42), and the polishing process of the correction surface of the image distortion correction plate G1 (S43). Furthermore, in the fourth manufacturing method, the lens components L3, L8, L10, L12 and L14 among the lens components L1 to L28 composing the projection optical system PL can be moved along the optical axis. Then, in calculation step of a predetermined adjustment amount of the adjustment optical members (S45), in order to correct residual aberration in the projection optical system PL after the reticle R is moved by a predetermined shift amount, each predetermined adjustment amount for the lens components L3, L8, L10, L12 or L14 composing the projection optical system PL is calculated.

Next, the polished image distortion correction plate G1 is inserted to the predetermined position in the projection optical system PL and positioned (S46). In other words, in the same case as in the first to third manufacturing methods, the polished image distortion correction plate G1 is positioned so that the on-axis interval d2 to the lens component L1 becomes 8.39368 mm.

Furthermore, the reticle stage 8, namely, the reticle R is moved by a predetermined shift amount calculated in step S44 in order to correct degradation of optical characteristics generated due to insertion of the image distortion correction plate G1 (S47). Specifically, in the same case as in the third manufacturing method, the reticle R is moved in the direction away from the lens component L1 by 1.6852075 mm along the optical axis.

Further, in order to correct residual aberration in the projection optical system PL after the reticle R is moved by a predetermined shift amount, the lens components L3, L8, L10, L12 and L14 as adjustment optical members are infinitesimally moved along the optical axis (S48). Specifically, in the same case as in the third manufacturing method, in order to correct residual aberration in the projection optical system PL, the lens component L3 is moved to the wafer side by 0.0119374 mm, the lens component L8 is moved to the wafer side by 0.0072187 mm, the lens component L10 is moved to the reticle side by 0.1027939 mm, the lens component L12 is moved to the reticle side by 0.0154154 mm, and the lens component L14 is moved to the wafer side by 0.0124903 mm, respectively.

Additionally, step S46 for mounting an unprocessed image distortion correction plate G1, step S47 for moving the reticle R, and step S48 for infinitesimally moving the respective adjustment optical members are interchangeable. Step S47 for moving the reticle R or step S48 for infinitesimally moving the respective adjustment optical members can be performed before step S46 for mounting an unprocessed image distortion correction plate G1.

In this state, a measuring operation of the distortion characteristics using a test reticle is again performed and whether the dynamic distortion characteristic shows a case, for example, shown in FIG. 6(B) or not is confirmed. When the dynamic distortion characteristic shows a case, for example, shown in FIG. 6(B), the distortion component able to be approximated by analytical function is reduced almost to “0” with the infinitesimal adjustment of the magnification by the tilt of the image distortion correction plate G1, by up/down movement and the infinitesimal tilt of the lens component G2, or by the pressure control. Then, the ratio of a random distortion component included in the dynamic distortion characteristic that is re-measured after the reduction adjustment is examined. If the random distortion component is within the standard value, the sequence of the manufacturing process of the fourth manufacturing method is completed.

As described above, in each manufacturing method, a correction member for correcting residual aberration in the projection optical system PL is arranged in a predetermined position in the projection optical path between the reticle R and the wafer W. Specifically, an image distortion correction plate G1 for correcting random component of the dynamic distortion characteristic is arranged between the reticle R and the most object side lens component L1 of the projection optical system PL. In this case, when the image distortion correction plate G1 is mounted into the projection optical path, the optical characteristic of the projection optical system PL becomes worse. That is, because of the thickness of the image distortion correction plate G1 made from a plane parallel plate, as the object-to-image distance of the projection optical system PL varies according to the thickness, and various aberrations including spherical aberration become worse. Therefore, in each manufacturing method, in order to correct variation in the object-to-image distance caused by mounting the image distortion correction plate G1 into the projection optical path, the reticle R is moved by necessary shift amount. As a result, the variation in the object-to-image distance is corrected, and various aberrations including spherical aberration are also corrected.

In particular, in the case such as the first and second manufacturing method, when the thickness of the image distortion correction plate G1 to be mounted is relatively small, various aberrations including spherical aberration can be preferably corrected by correcting the object-to-image distance by means of moving the reticle R by necessary shift amount. As a result, severely degraded various aberrations such as spherical aberration and distortion caused by mounting the image distortion correction plate G1 is preferably corrected, random components such as dynamic distortion characteristics or the like are corrected, and other aberrations are returned to a preferable state before mounting the image distortion correction plate G1. In other words, although the projection optical system PL is designed and assembled without the assumption of mounting an image distortion correction plate G1, almost same state where a prearranged image distortion correction plate is mounted on a projection optical system designed on the assumption of mounting an image distortion correction plate is realized by moving the reticle R by necessary shift amount.

Meanwhile, when the thickness of the image distortion correction plate G1 to be mounted is relatively large in the same manner as in the third and fourth manufacturing method, although various aberrations including spherical aberration can be corrected to a certain extent by correcting variation in the object-to-image distance by means of moving the reticle R by necessary shift amount, a state of a preferable aberration before mounting of the image distortion correction plate G1 cannot be revived. Therefore, in the third and fourth manufacturing method, degraded optical characteristics of the projection optical system PL, which cannot be fully corrected by moving the reticle R by necessary shift amount, can be corrected by adjusting optical members which structure the projection optical system PL. Specifically, various aberrations remained in the projection optical system PL such as spherical aberration or distortion are corrected with a good balance by infinitesimally moving a predetermined plurality of lens components among large number of lens components composing the projection optical system PL by necessary amount for adjustment along the optical axis after the reticle R is moved by necessary shift amount. Then, a state of a preferable aberration before mounting the image distortion correction plate G1 can be revived.

Thus, each manufacturing method makes it possible to manufacture an exposure apparatus equipped with a projection optical system PL adjusted in extremely high imaging performance capability, even when the optical correction plate G1 is mounted into the projection optical path which corrects residual aberrations of the projection optical system PL, by preferably correcting deterioration of optical characteristics of the projection optical system PL caused by mounting the optical correction plate G1. Accordingly, it is possible to manufacture a preferable micro device, by using an exposure apparatus manufactured by above-mentioned manufacturing method, capable of exposing a pattern of a reticle R onto a wafer W with extremely high fidelity through a projection optical system PL with extremely high imaging characteristic.

Furthermore, the installing position of the image distortion correction plate G1 in the first to fourth manufacturing method can be any air space between the reticle plane (object) and the projection optical system PL (lens component L1). However, it is preferable that the installing position of the image distortion correction plate G1 should be arranged on a predetermined agreeable position because the surface shape for processing of the image distortion correction plate G1 is determined in accordance with the installing position of the image distortion correction plate G1 (the processing surface shape varies in accordance with the installing position of the image distortion correction plate G1 even in the same aberration correction amount) in the processing surface-shape-calculation steps (S15, S22, S37, and S42).

Meanwhile, although the variation in the object-to-image distance is corrected by moving the reticle R in each manufacturing method described above, it is possible to integrally move the projection optical system PL and the wafer W without moving the reticle R.

Further, since the optical correction plate G1 is mounted between the reticle R and the most object side lens component L1 in each manufacturing method described above, variation in the object-to-image distance is corrected by moving the reticle R. However, when the optical correction plate G1 is mounted between the wafer W and the most image side lens component L28, variation in the object-to-image distance is corrected by moving the wafer W or by integrally moving the projection optical system PL and the wafer W.

Meanwhile, although it is described in calculation step (S11, S24, S31 and S44) of variation in the object-to-image distance in the aforementioned first to fourth manufacturing method that the medium between the reticle surface (object) position and the projection optical system PL was air and the image distortion correction plate G1 is mounted in the air space, it is needless to say that the distortion correction plate G1 can be mounted in the space other than air. In this case, it is sufficient that the reticle surface (object) is moved to satisfy the above-mentioned equation (5) wherein ΔD denotes the amount for adjustment (variation) of the reticle surface (object) position, d1 denotes the distance (on-axis distance) between the reticle surface (object) position and the image distortion correction plate G1, d2 denotes the distance (on-axis distance) between the image distortion correction plate G1 and the projection optical system PL (the lens component L1), n1 denotes refractive index of the correction plate G1, and n2 denotes refractive index of the medium of the space (the space between the reticle surface and the projection optical system PL) where the image distortion correction plate G1 is mounted.

Similarly, when the image distortion correction plate G1 is mounted between the substrate surface (wafer surface) and the projection optical system PL, it is also sufficient that the substrate surface position (image) is changed to satisfy the above-mentioned equation (5), wherein ΔD denotes the amount for adjustment (variation) of the substrate surface position (image), d1 denotes the distance (on-axis distance) between the substrate surface position (image) and the correction plate G1, d2 denotes the distance (on-axis distance) between the correction plate G1 and the projection optical system PL (final lens component), n1 denotes refractive index of the correction plate G1, and n2 denotes refractive index of the medium of the space (the space between the projection optical system PL and the substrate surface) where the correction plate G1 is mounted.

Furthermore, when the correction plate G1 is mounted in a telecentric optical path in the projection system, it is possible to sufficiently correct degradation of aberration according to the thickness of the correction plate G1 by adjusting the object-to-image distance. It is possible to make the step of adjusting each optical member composing the projection system unnecessary as shown in the first and second manufacturing methods. On the contrary, when the correction plate G1 is mounted in a non-telecentric optical path in the projection system, there is a case that degradation of aberration according to the thickness of the correction plate G1 cannot be fully corrected by adjusting the object-to-image distance. In this case, it is preferable that the step of adjusting each optical member composing the projection system shown in the third and fourth manufacturing methods is performed.

Further, in the explanation of each manufacturing method described above, although a plurality of lens components are infinitesimally moved along the optical axis when adjusting the projection optical system PL, the number of the optical member for adjustment or the method of adjustment (tilt movement with respect to the optical axis) is not limited to this way, and various modifications are possible.

Furthermore, in the explanation of each manufacturing method described above, the excimer laser light source 1 pulse-emits a KrF excimer laser beam having a wavelength of 248 nm, and the projection optical path is filled with normal pressured air. However, when an ArF excimer laser light source having a wavelength of 193 nm or an F2 excimer laser light source having a wavelength of 157 nm is used as the excimer laser source 1, the projection optical path need to be filled with inert gas such as nitrogen gas or helium gas. In this case, variation in the reduced air space is obtained by using refractive index of the inert gas relative to the exposure wavelength as refractive index n2 of the medium between lens components, and the required shift amount of the reticle R or the wafer W can be derived. Furthermore, a specific construction of an exposure apparatus using an ArF excimer laser light source, having a projection optical path filled with inert gas and suitable for the manufacturing method of the exposure apparatus according to the invention will be described later.

Furthermore, according to the above-mentioned respective manufacturing methods, the optical correction plate G1 which corrects the residual aberration of the projection optical system PL is arranged in the projection optical path, deterioration of the optical characteristics of the projection optical system PI due to the arrangement of the optical correction plate G1 is preferably corrected, and the imaging performance capability of the projection optical system PL is adjusted with extremely high accuracy.

An exposure apparatus according to the invention can be assembled by connecting each optical member and each stage shown in FIGS. 1 and 2 electrically, mechanically and optically to accomplish aforementioned function.

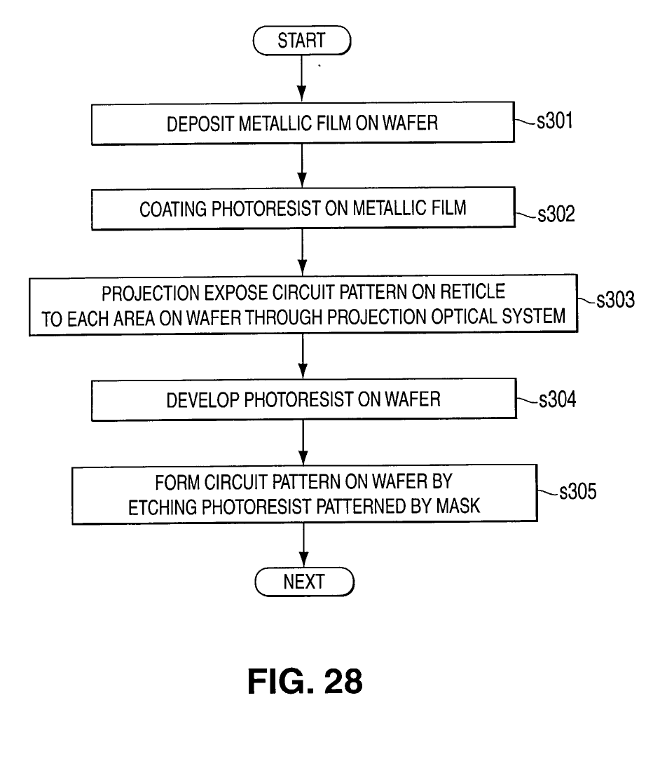

Then, an example for obtaining a semiconductor device as a micro device by forming a predetermined circuit pattern on a wafer as a photosensitive substrate using an exposure apparatus shown in FIGS. 1 and 2 is described with reference to the flow chart shown in FIG. 28.

First, in step 301 of FIG. 28, a metallic film is deposited on a wafer of one lot. In next step 302, photoresist is coated on the metallic film on the wafer of one lot. Then, in step 303, a pattern image on a mask (reticle) is successively exposed and transferred to each shot area on the wafer of one lot through the projection optical system (projection optical unit) by the projection exposure apparatus shown in FIGS. 1 and 2. Then, in step 304, the photoresist on the wafer of one lot is developed. In step 305, a circuit pattern corresponding to the pattern on the reticle is formed on each shot area of each wafer by etching the resist pattern as a mask on the wafer of one lot. After that, by forming a circuit pattern of an upper layer or the like, a device such as a semiconductor element or the like is fabricated.

Above described semiconductor manufacturing method makes it possible to fabricate semiconductor device having extremely fine circuit pattern with high throughput.

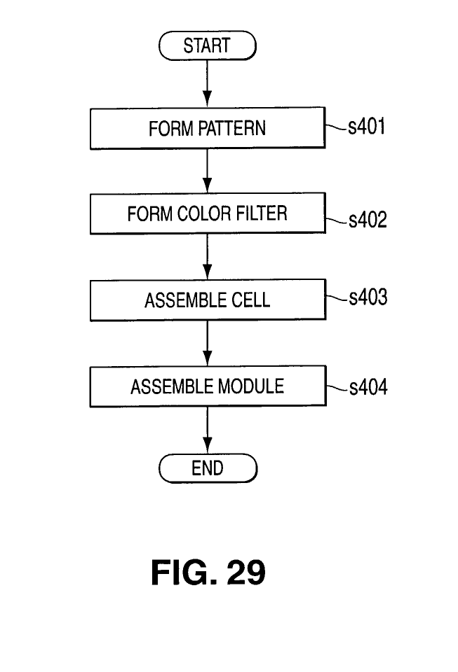

Further, the exposure apparatus shown in FIGS. 1 and 2 makes it possible to fabricate a liquid crystal display element as a micro device by forming a predetermined pattern (a circuit pattern or an electrode pattern) on a plate (glass substrate). An example of this method is described below with reference to the flow chart of FIG. 29.

In step 401 for forming a pattern in FIG. 29, a reticle pattern is transferred and exposed on a photosensitive substrate (a glass substrate or the like coated with photoresist) by using an exposure apparatus according to the present embodiment, that is, a so-called photolithography process is performed. With the photolithography process, a predetermined pattern including many electrodes or the like is formed on the photosensitive substrate. Then, by going through processes such as a developing process, an etching process, and a reticle (peeling) exfoliation process, a predetermined pattern is formed on the substrate and moved to step 402 for forming a color filter.

Then, in the color filter forming process of step 402, color filters are formed in which many three-dot groups corresponding to R (red), G (green), and B (blue) are arranged in a matrix, and three-stripe filter groups with R, G, and B are arranged in a plurality of directions of horizontal scanning line. Then, after the color filter forming process of step 402, a cell assembling process of step 403 is performed.

In the cell assembling process of step 403, a liquid crystal panel (a liquid crystal cell) is assembled by using a substrate having a predetermined pattern obtained in the pattern forming process of step 401, color filters obtained in the color filter forming process of step 402, or the like. In the cell assembling process of step 403, for example, a liquid crystal panel (a liquid crystal cell) is manufactured by filling liquid crystal between a substrate having a predetermined pattern obtained in the pattern forming process of step 401 and color filters obtained in the color filter forming process of step 402.

Then, in a module assembling process of step 404, an electric circuit performing a display operation of the assembled liquid crystal panel (liquid crystal cell) and a back light, and the like are attached for completion of a liquid crystal element.

Above described manufacturing method makes it possible to fabricate liquid crystal element having an extremely fine circuit pattern with high throughput.

The above-described embodiment is dedicated to the explanation about the manufacturing and adjustment methods of the image distortion correction plate (optical correction plate) G1. However, when the image distortion correction plate G1 is manufactured, static distortion errors must be precisely measured at a plurality of ideal lattice points by using a test reticle as described above. The measurement of such distortion characteristics may be made with the method using the spatial image detector KES shown in FIG. 2, other than the method using test printing.

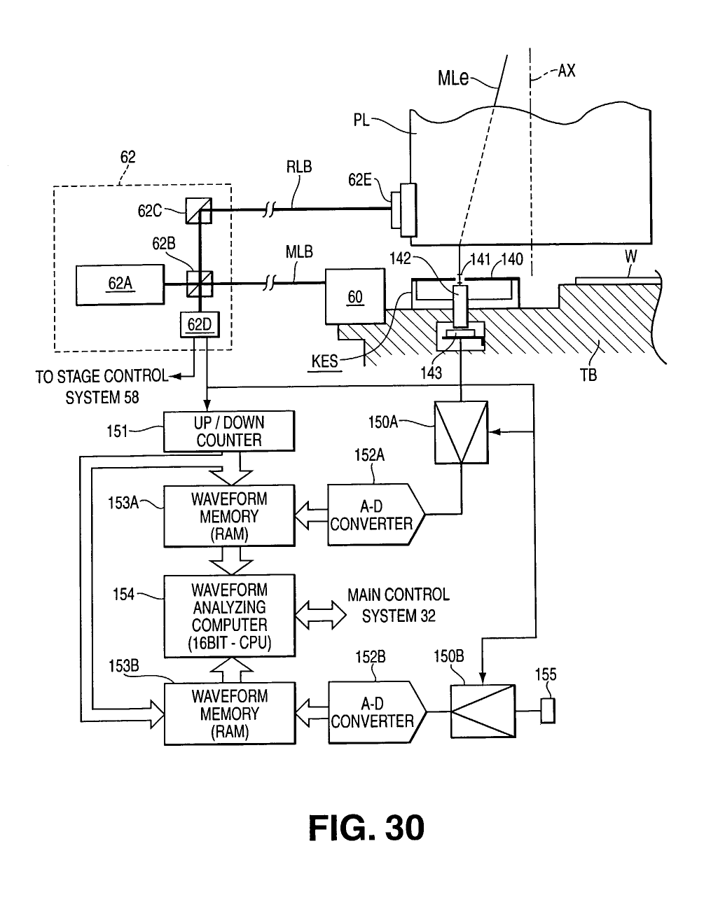

Therefore, the distortion measurement using the spatial image detector KES is briefly explained by referring to FIG. 30. FIG. 30 shows the configuration of the spatial image detector KES mounted on the wafer table TB of the exposure apparatus of FIG. 2, and the configuration of the signal processing system relating thereto. In this embodiment, the coordinate position of the test pattern image projected from the projection optical system PL is obtained by using the knife-edge measurement method.

In FIG. 30, the spatial image detector KES comprises: a shading plate 140 which is arranged to be almost as tall as (for example, in a range of ±1 mm or so) the surface of the wafer W on the table TB; a rectangular aperture (knife-edge aperture) of approximately several tens to several hundreds of μm, which is formed in a predetermined position on the shading plate 140; a quartz optical pipe 142 into which the imaging light beam from the projection optical system PL is incident, which passes through the aperture 141 with a large NA (numerical aperture); and a semiconductor reception element (silicon photodiode, PIN photodiode, or the like) 143 which photoelectrically detects the light amount of the imaging light beam transmitted by the optical pipe 142 with almost no loss.

In the above-described configuration of the spatial image detector KES, the shading plate 140 is configured by depositing a chromium layer onto the surface of a quartz or fluorite plate having a high transparency ratio for the light in an ultraviolet range and while the optical pipe 142 is configured by gathering many quartz optical fibers as a bundle having an entire thickness of approximately several millimeters, or by cutting quartz into a long and thin square pillar section of which is a square and making its inside into an total reflection plane.

If the shading plate 140 and the reception element 143 are spatially arranged apart with such an optical pipe 142, the influence on the reception element 143 with the temperature rising of the shading plate 140, which is caused by the irradiation of the imaging light beam on the shading plate 140 for a long time, can be reduced. Therefore, it is possible to keep the temperature of the reception element 143 almost constant, and it is possible to allow the imaging light beam going through the aperture 141 to be received without any loss.

In the meantime, for the projection image detection using the spatial image detector KES, the laser interferometer 62 shown in FIG. 2 is used. The laser interferometer 62 is configured by a laser light source 62A in which frequency is stabilized, beam splitters 62B and 62C which split the laser beam toward a movable mirror 60 fixed on the table TB and a reference mirror 62E fixed to the lower portion of the lens barrel of the projection optical system PL, and a receiver 62D for receiving the beams which are respectively reflected by the movable mirror 60 and the reference mirror 62E and interfere with each other at the beam splitter 62B, or the like as shown in FIG. 30.

The receiver 62D comprises a high-speed digital counter which incrementally counts the move amount of the table TB based on the photoelectric signal according to the change of the fringe of an interfered beam by the resolution of 10 nm and transmits the digital calculating value by the counter to the wafer stage control system 58 shown in FIG. 2 as the coordinate position of the table TB (wafer W) in the X (or Y) direction.

If the illumination light for exposure is obtained from the excimer laser light source 1 as shown in FIGS. 1 and 2, the photoelectric signal from the reception element 143 of the spatial image detector KES becomes a pulse waveform in response to the pulse light emission of the excimer laser light source 1. That is, assuming that the image optical path from a certain object point on the test reticle arranged on the object plane of the projection optical system PL is MLe as shown in FIG. 30, the excimer laser light source 1 of FIG. 2 is made to pulse-light-emit in the state where the table TB (that is, the wafer stage 14) is positioned in the X and Y directions in order to make the image optical path MLe agree with the rectangular aperture 141 of the spatial image detector KES, so also the photoelectric signal from the reception element 143 becomes a pulse waveform with the time interval of approximately 10 to 20 ns.

Accordingly, the photoelectric signal from the reception element 143 is configured to be input to a sample/hold (hereinafter referred to as S/H) circuit 150A having an amplification operation shown in FIG. 30, and the S/H circuit 150A is configured to be switched between the sample and hold operation in response to every 10-nm pulse signal for counting, which is generated by a receiver 62D in the laser interferometer 62.

Then, the control system 2 of the excimer laser light source 1 shown in FIG. 2 triggers pulse light emission according to the coordinate position information transmitted from the laser interferometer 62 to the synchronization control system 66 and the main control system 32 in FIG. 2 via the stage control system 58. Namely, this embodiment is on figured so that the pulse light emission of the excimer laser light source 1 is performed according to the coordinate position of the table TB, and the S/H circuit 150A holds the peak value of the pulse signal waveform from the reception element 143 in synchronization with the pulse light emission.

The peak value held by the S/H circuit 150A is converted into a digital value by an analog-digital (A-D) converter 152A, and the digital value is stored in a waveform memory circuit (RAM) 153A. An address when the RAM 153A performs a storage operation is generated by an up/down counter 151 which counts every 10-nm pulse signal for counting transmitted from the laser interferometer 62, and the move position of the table TB and the address when the RAM 153A performs a storage operation are nonambiguously corresponded to each other.

In the meantime, the peak intensity of the pulse light from the excimer laser light source 1 has a fluctuation of approximately several percent for each pulse. Therefore, in the processing circuit in this embodiment, a photoelectric detector 155 for detecting an intensity is arranged within the illumination optical system (7A to 7Q) shown in FIG. 2 in order to prevent the image measurement accuracy from being deteriorated due to this fluctuation. The photoelectric signal (pulse waveform) from the photoelectric detector 155 is captured by an S/H circuit 150B, an A-D converter 152B, and a RAM 153B (the address generation at the time of the storage operation is common to that of the RAM 153A), which are respectively equivalent to the above-described S/H circuit 150A, the A-D converter 152A, and the RAM 153A.

In this way, the peak intensity of each pulse light from the excimer laser light source 1 is stored in the RAM 153B in the state where the move position of the table TB and the address at the time of the storage operation of the RAM 153B are nonambiguously corresponded.

The photoelectric detector 155 uses the mirror 7J within the illumination optical system shown in FIG. 2 as a partial transparent mirror and is arranged to receive the pulse light of approximately 1 to several percent, which passes through the rear side of the mirror 7J through a collective light lens. If the photoelectric detector 155 is arranged in such a position, it serves also as a light amount monitor for controlling the amount of exposure when each shot area on the wafer W is exposed.

As described above, the digital waveform stored in the RAM 153A or 153B is read into a waveform analyzing computer (CPU) 154, and the measured waveform according to the image intensity stored in the RAM 153A is standardized (divided) by the intensity fluctuation waveform of the illumination pulse light stored in the RAM 153B. The standardized measured waveform is temporarily stored in the memory within the CPU 154, and at the same time, the central position of the image intensity to be measured is obtained by respective types of a waveform processing program.

In this embodiment, a test pattern image on the test reticle is detected with the edge of the aperture 141 of the spatial image detector KES. Therefore, the central position of the image, which is analyzed by the CPU 154, is obtained as the coordinate position of the table TB (wafer stage 14) measured by the laser interferometer 62, when the center of the test pattern image and the edge of the aperture 141 agree with on the XY plane.

The information of the central position of the analyzed test pattern image is transmitted to the main control system 32 shown in FIG. 2. The main control system 32 instructs the control system 2 of the excimer laser light source 1 and the wafer stage control system 58 in FIG. 2, and the CPU 154 in FIG. 30 of the operations for sequentially measuring the position of each projection image of the test pattern formed at a plurality of points (for example, ideal lattice points) on the test reticle.

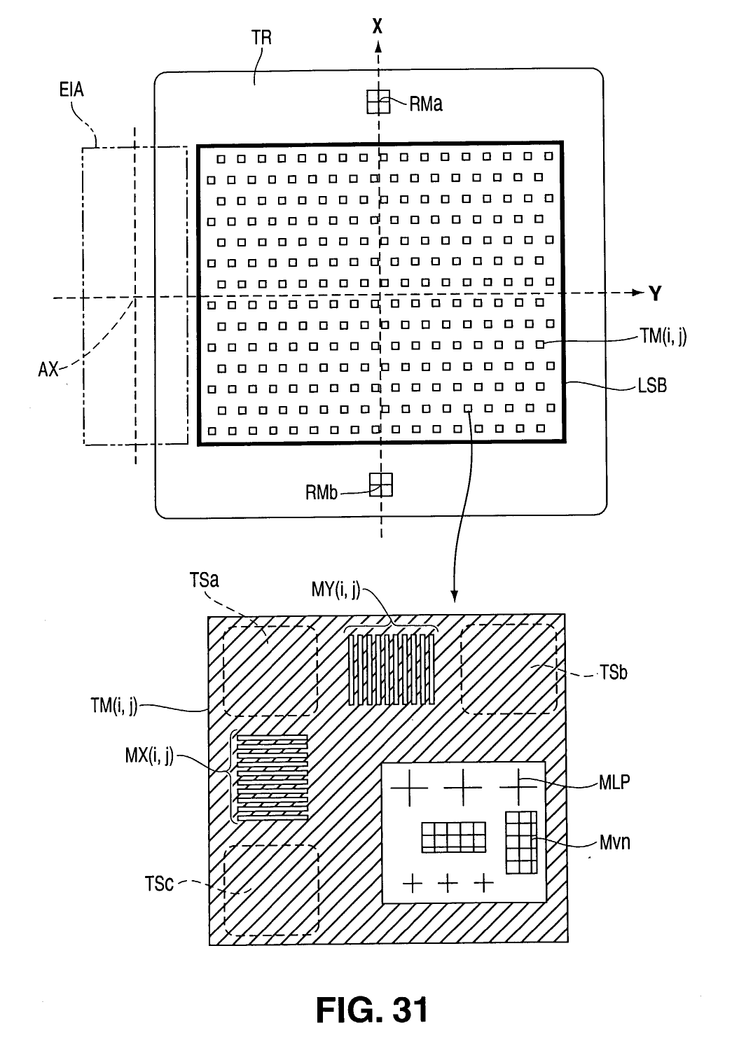

Here, the test reticle TR preferable for this embodiment is briefly explained by referring to FIG. 31. FIG. 31 is a plan view showing the entire pattern layout on the test reticle TR, and assumes that the center of the test reticle TR is the origin of the XY coordinate system. Additionally, the direction of scan-exposure is the Y direction also in FIG. 31. On the left side of the test reticle TR in FIG. 31, also the effective projection area EIA indicated by a broken line is shown. Both ends of the effective projection area EIA in the non-scanning (X) direction are set to agree with the respective two sides, which extend in the Y direction, of the shading band LSB enclosing the pattern area of the test reticle TR as a rectangle.

Outside the shading band LSB of the test reticle TR, cross-shaped reticle alignment marks RMa and RMb are formed. The marks RMa and RMb are detected by a microscope for reticle alignment in the state where the test reticle TR is put on the reticle stage 8 (see FIG. 2) of the exposure apparatus, so that the test reticle TR is aligned with the reference points within the apparatus.

Inside the shading band LSB of the test reticle TR, test pattern areas TM(i, j), S which are arranged in a matrix with a predetermined pitch in the XY direction are formed. Each of the test pattern areas TM(i, j) is formed by a rectangular shading layer (diagonal-line portion) of the entire size of which is approximately 1 to 2 mm, as expanded and shown in the lower portion of FIG. 31. In the shading layer, a Line & Space (L&S) pattern MX(i, j) having an X direction cycle and a L&S pattern MY(i, j) having a Y direction cycle are formed to be detected by the spatial image detector KES. Also a LAMPAS mark MLP or a vernier mark Mvn, which are used to examine the resolution or the alignment precision, are formed in a transparent window MZ.

Additionally, shading parts TSa and TSc of a predetermined size are designed to be secured on both sides of the L&S pattern MX(i, j) in the X direction in the rectangular shading layer of the test pattern area TM(i, j). The squares of the shading parts Tsa and TSc are set to be larger than that of the rectangular aperture 141 of the spatial image detector KES on the projection image plane side. Similarly, shading parts TSa and TSb of the predetermined size are secured also on both side of the L&S pattern MY(i, j) in the Y direction.

It is assumed that the L&S patterns MX(i, j) and MY(i, j) shown in FIG. 31 have 10 transparent lines in the shading layer, and the width of the shading line between transparent lines and that of each transparent line are the same. However, the number of transparent lines, the ratio (duty) of the width of a transparent line to that of a shading line and the like may be arbitrarily set. The width of each transparent line in the cycle direction is set to be sufficiently resolvable by the projection optical system PL, and not to be extremely thick. By way of example, the line width is set in a range from Δr to 4Δr, which can be resolved by the projection optical system PL.

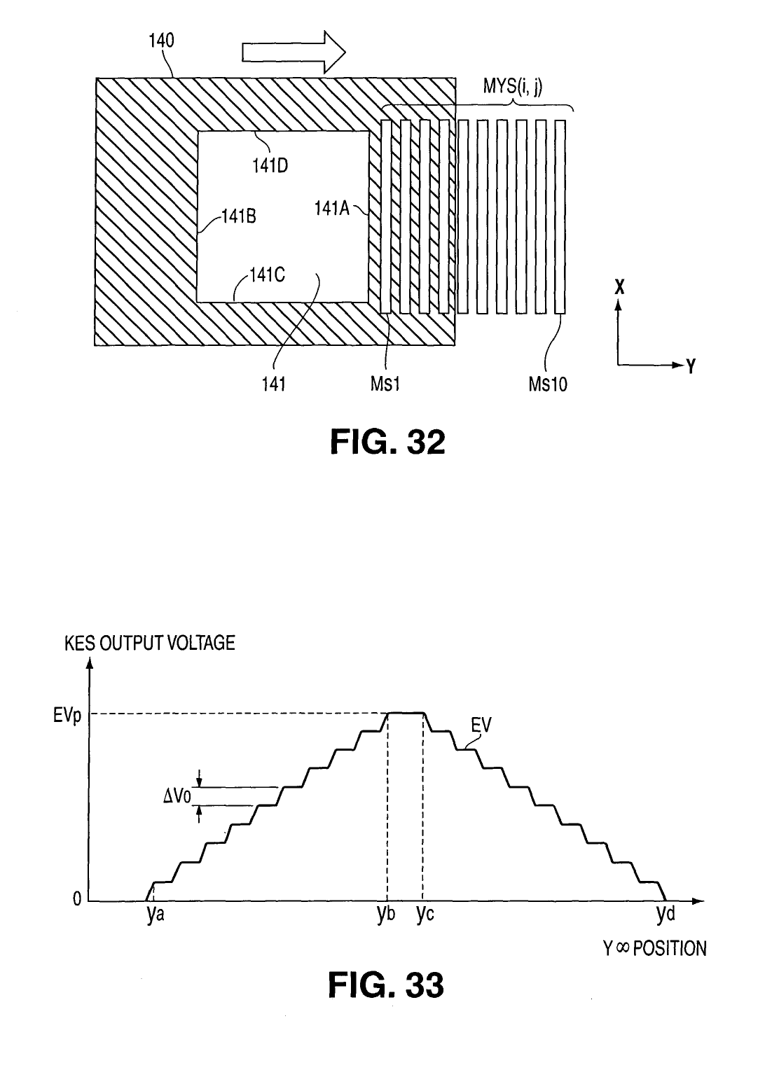

When the test reticle TR shown in FIG. 31 is put on the reticle stage 8 of the exposure apparatus and aligned, the wafer stage 14 is positioned so that the rectangular aperture 141 of the spatial image detector KES can be arranged with respect to one test pattern area TM(i, j) to be measured, as shown in FIG. 32.

FIG. 32 shows the positional relationship immediately before the rectangular aperture 141 scans the projection image MYS(i, j) of the L&S pattern MY(i, j) within one test pattern TM(i, j) in the Y direction. In the state shown in FIG. 32, the rectangular aperture 141 is completely shaded by the shading part TSb (or TSa) shown in FIG. 31. Furthermore, the rectangular aperture 141 moves from this position in FIG. 32 toward a first slit image (transparent line image) Msl in the right direction almost at a constant speed.

At this time, the level of the photoelectric signal from the reception element 143 changes so that it rises the moment that an edge 141A on the right side of the rectangular aperture 141 traverses the first slit image Msl (position “ya”), and falls to “0” the moment or after an edge 141B on the left side of the rectangular aperture 141 traverses a tenth slit image Ms10 (position “yd”), as shown in FIG. 33.

FIG. 33 shows a signal waveform EV represented by taking the coordinate position of the wafer stage 14 (rectangular aperture 141) in the Y (or X) direction as the horizontal axis, and the voltage level of the photoelectric signal of the reception element 143 as the vertical axis. The signal waveform EV increases step-by-step as the first slit image Msl to the tenth slit image Ms10 of the projection image MYS(i, j) sequentially go into the rectangular aperture 141, and reaches a maximum value EVp at a position “yb”. Thereafter, when the wafer stage 14 passes through a position “yc”, the signal waveform EV decreases in a stairs state as the slit images go out of the rectangular aperture 141 sequentially from Msl to Ms10.

A stepwise voltage change amount ΔVe configuring such a step-by-step waveform EV corresponds to the quantity of light of one of the slit images within the projection image MYS(i, j). The important portions in the position measurement using the signal waveform EV are the rising and the falling portions between the respective steps. The signal waveform EV in the stairs state is temporarily stored in the RAM 153A in FIG. 30. Then, the correction (division) of the intensity fluctuation of each illumination pulse light is made by the CPU 154 for each data (voltage value) at each address in the RAM 153A.

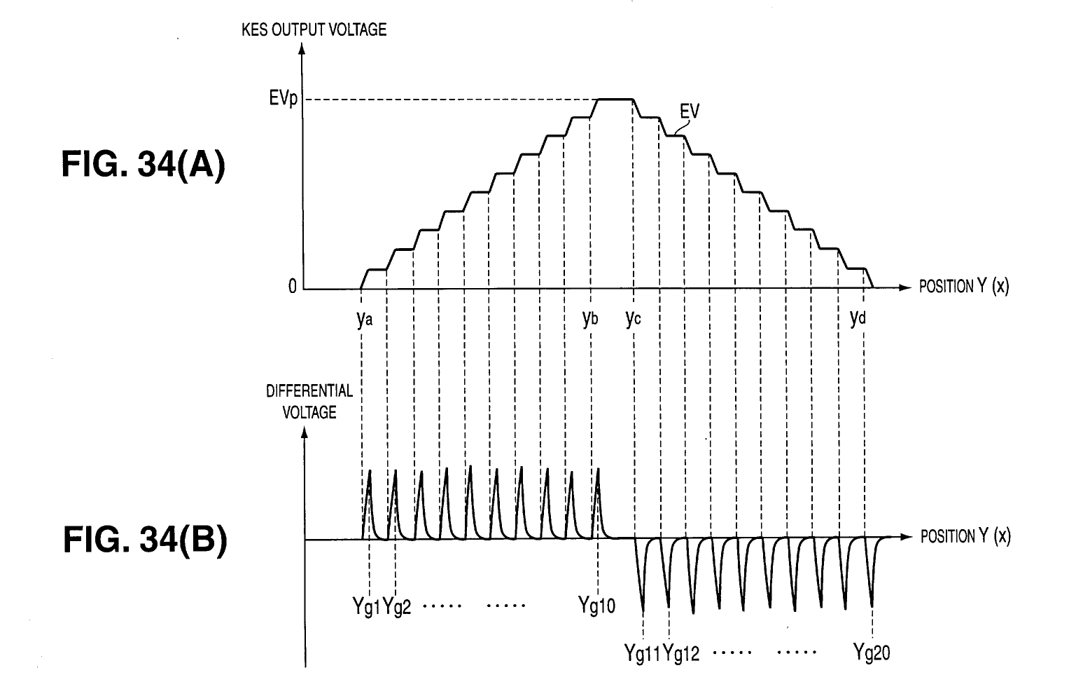

The signal waveform EV which was thus standardized is further smoothed by the CPU 154, if necessary, and the smoothed signal waveform is differentiated so that the rising and the failing positions between the respective steps are emphasized. Since the differentiated waveform is arising waveform between the respective steps of the signal waveform EV again shown in FIG. 34(A) in the interval from the position “ya” to the position “yb” as shown in FIG. 34(B), it becomes a positively differentiated pulse. Additionally, since the waveform is a falling waveform between the respective steps of the signal waveform EV in the interval from the position “yc” to the position “yd”, it becomes a negatively differentiated pulse. FIG. 34(A) again illustrates FIG. 33 for ease of understanding of the corresponding relationship between the positions on the differentiated pulse waveform in FIG. 34(B) and the respective step positions on the original signal waveform EV.

After the CPU 154 shown in FIG. 30 makes a correspondence between the differentiated waveform shown in FIG. 34(B) and the Y (or X) coordinate position and stores the correspondence in its internal memory, it calculates the gravity center positions Yg1, Yg2, . . . , Yg20 for respective 20-pulse waveforms in the differentiated waveform, and determines the position YG(i, j) obtained by adding and averaging the respective positions Yg1 to Yg20. This position YG(i, j) is the Y coordinate value of the wafer stage 14, which is measured by the laser interferometer 62 when the central point of the projection image MYS(i, j) in the Y direction in FIG. 32 perfectly agrees with the median point of the segment linking the two edges 141A and 141B of the rectangular aperture 141.

As described above, the Y coordinate position of the projection image MYS(i, j) of each L&S pattern MY(i, j) within the test pattern areas TM(i, j) formed at the plurality of locations on the test reticle TR is sequentially measured. Also the X coordinate position of the projection image MXS(i, j) of each L&S pattern MX(i, j) within the test pattern areas TM(i, j) is measured with the exactly the same procedures.

In this case, the rectangular aperture 141 of the spatial image detector KES is scanned in the X direction for the projection image MXS(i, j), and a pair of edges 141C and 141D which regulate the width of the rectangular aperture 141 in the X direction in FIG. 32 operate as a knife-edge for the projection image MXS(i, j). Accordingly, the waveform EV of the photoelectric signal from the light reception element 143 and its differentiated waveform are exactly the same as those shown in FIGS. 34(A) and (B). However, since the central position XG(i, j) of the projection image MXS(i, j) in the X direction must be obtained, the pulse signal for counting from the receiver 62D within the laser interferometer 62 shown in FIG. 30 is switched to the pulse signal for counting, which is obtained from the receiver within the laser interferometer (16X in FIG. 1) measuring the moving position of the wafer stage 14 in the X direction.

In this way, the projection coordinate position [XG(i, j), YG(i, j)] at the ideal lattice point regulated by the L&S patterns MX(i, j) and MY(i, j) within each test pattern area TM(i, j) on the test reticle TR can be measured. By obtaining the difference in the XY direction between the measurement result and the coordinate position of each ideal lattice point on the test reticle TR, the static image distortion vector DV(Xi, Yj) at each ideal lattice point, which explained in FIGS. 3 and 4, can be obtained.

With the above-described distortion measurement method, the static image distortion vector DV(Xi, Yj) is obtained after measuring each projection coordinate position [XG(i, j), YG(i, j)] of the L&S patterns MX(i, j) and MY(i, j). However, the image distortion vector DV(Xi, Yj) can be obtained without actually measuring each projection coordinate position [XG(i, j), YG(i, j)].

That is, the coordinate position of the ideal lattice point regulated by the L&S patterns MX(i, j) and MY(i, j) on the test reticle TR is known beforehand in a design, also the projection image position (ideal projection position) when the ideal lattice point is projected through an ideal projection optical system PL is known beforehand in the design. Therefore, at the stage where the differentiated waveform, for example, shown in FIG. 34(B) is generated in a memory, the reference address corresponding to the ideal projection position among the addresses in the memory is set by software, the position obtained by adding and averaging the respective gravity center positions of the 20 pulses of the differentiated waveform shown in FIG. 34(B) is determined as an identified address in the memory, and the difference value between the identified address and the previous reference address is multiplied by the value of the resolution (such as 10 nm) of the measurement pulse signal from the laser interferometer 62 (or 16X), so that the image distortion vector DV(Xi, Yj) can be directly calculated.

For the above-described projection image detection using the space image detector KES, there is a matter to be further considered. The matter is that the intensity distribution of unnecessary interference fringes is superposed on the intensity distribution of the pulse illumination light irradiated on the reticle R with a contrast of several percent or so due to the use of the first and the second fly eye lenses 7C and 7G shown in FIG. 2.

Therefore, when the wafer W is scan-exposed, the vibration mirror 7D arranged between the first and the second fly eye lenses 7C and 7G in FIG. 2 is vibrated, a plurality of pulse illumination lights are irradiated while deflecting the pulse illumination light incident to the second fly eye lens 7G by an infinitesimal amount in the non-scanning direction intersecting the moving (Y) direction of the reticle R at the time of scan-exposure, and the interference fringes are infinitesimally moved in the non-scanning direction on the reticle R (and the wafer W) for each of the plurality of pulse illumination lights, so that the contrast of the interference fringes superposed on the pattern image which is projected and exposed onto the wafer W is sufficiently decreased by the accumulation effect of the resist layer.

However, the accumulation effect by the resist layer cannot be used when a projection image is detected by the spatial image detector KES, unlike the case of the scan-exposure of the wafer W. Therefore, it is desirable to obtain a similar accumulation effect, for example, by a hardware process with the circuit configuration where the signal processing circuit in FIG. 30 is partially changed, or by a software process using the CPU 154.

Specifically, the method for sufficiently reducing the moving speed when the projection image MYS(i, j) or MXS(i, j) of the L&S pattern is scanned with the rectangular aperture 141 as shown in FIG. 32, and for providing a plurality of trigger signals to the control system 2 of the excimer laser light source 1 in response to one pulse of the pulse signal for counting from the laser interferometer 62 (or 16X in FIG. 1) in the state where the vibration mirror 7D is vibrated at high speed, can be adopted.

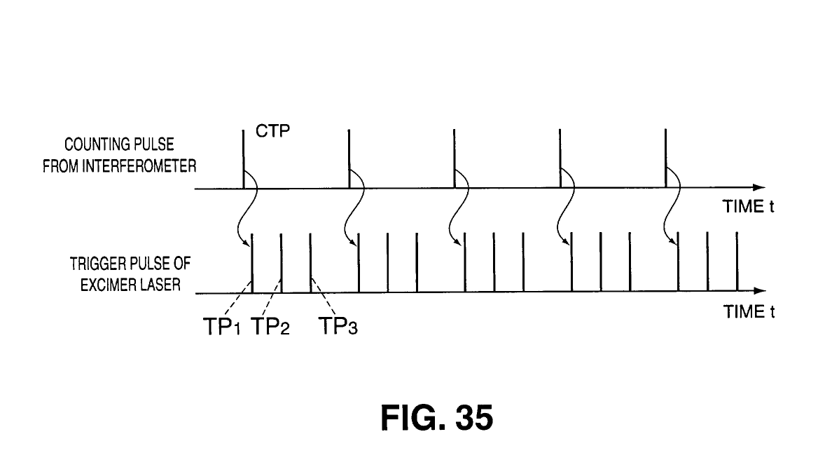

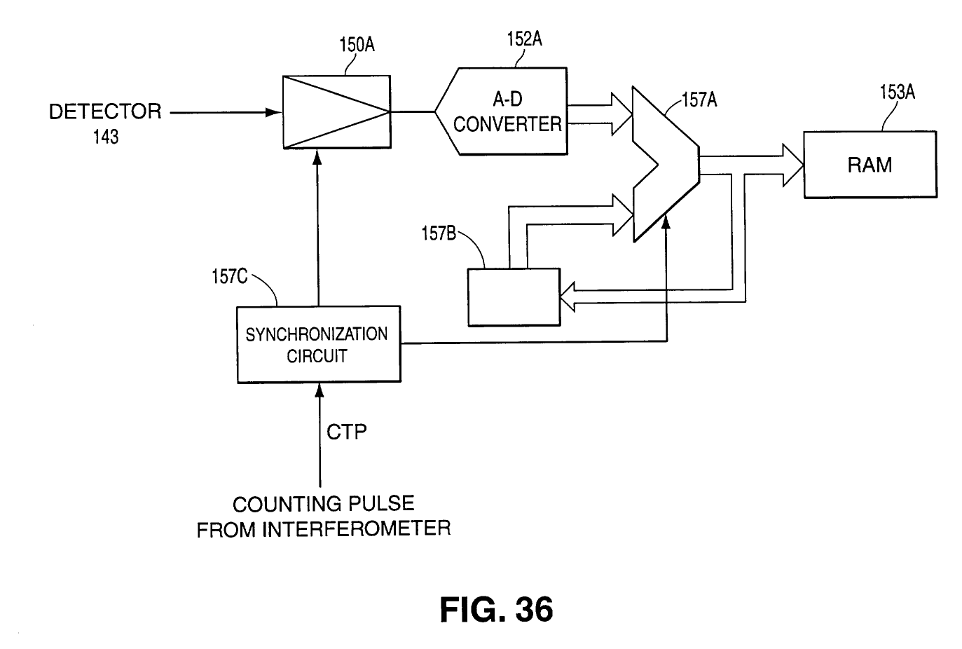

Therefore, the method for obtaining the accumulation effect by the hardware process is briefly explained by referring to FIGS. 35 and 36. First of all, for example, three trigger pulses TP1, TP2, and TP3 are configured to be generated in response to one pulse of the pulse signal CTP for counting from the laser interferometer 62 (or 16X) intended to measure the position of the wafer stage 14 as shown in FIG. 35, and the excimer laser light source 1 is made to oscillate in response to the respective trigger pulses TP1, TP2, and TP3.

Then, part of the signal processing circuit shown in FIG. 30 is changed to that shown in FIG. 36. In FIG. 36, an accumulator 157A which adds the output data of the A-D converter 152A and the data temporarily stored in a register 157B is connected, after the A-D converter 152A which converts the peak value of the photoelectric signal from the reception element 143 of the spatial image detector KES into a digital value, and the result of the addition is stored in a RAM 153A similar to that shown in FIG. 30.

Additionally, a synchronization control circuit 157C which outputs the trigger pulses TP1, TP2, and TP3 in response to the counting pulse signal CTP from the interferometer is arranged to synchronize sequences, and the sample and the hold operations of the S/H circuit 150A are switched according to the respective trigger pulses TP1, TP2, and TP3. These trigger pulses TP1, TP2, and TP3 are transmitted also to the accumulator 157A, which sequentially adds the data output from the A-D converter 152A every three trigger pulses TP1, TP2, and TP3 (every three pulse light emissions).

In such a configuration, the register 157B operates to be reset to “0” at the rising of the counting pulse signal CTP of the interferometer, and the synchronization control circuit 157C outputs the first trigger pulse TP1 after the zero reset. The S/H circuit 150A and the A-D converter 152A begin to operate in response to the output trigger pulse TP1. In response to this, the S/H circuit 150A and the A-D converter 152A are operated, and the peak value EV1 of the signal output from the reception element 143 according to the first pulse light emission is applied to one of input terminals of the accumulator 157.

Since the data of the register 157B is “0” at this time, the peak value EVI emerges in the output of the accumulator 157A. This output is immediately transmitted to the register 157B and stored. After a predetermined amount of time elapses, the synchronization control circuit 157C outputs the second trigger pulse TP1. Then, the peak value EV2 of the signal output from the reception element 143 according to the second pulse light emission is input to one of the input terminals of the accumulator 157A in a similar manner.

By so doing, the addition value of the peak value EV2 from the A-D converter 152A and the peak value EV1 from the register 157B emerges in the output of the accumulator 157A, and this addition value is again transmitted to the register 157B. Similar operations are performed also for the third trigger pulse TP3. Consequently, the addition value of the peak values EV1, EV2, and EV3 which are respectively obtained by the three pulse light emissions emerges in the output of the accumulator 157A, and this addition value is stored at a specified address in the RAM 153A.

In the above-described embodiment, the three trigger pulses TP1, TP2, and TP3 are generated for one pulse of the counting pulse signal of the interferometer. While these trigger pulses are generated, the angle of the vibration mirror 7D is infinitesimally changed. Therefore, the contrast component of the interference fringes superposed for each pulse light emission on the image MXS(i, j) or MYS(i, j) projected onto the shading plate 140 of the spatial image detector KES is averaged, whereby the distortion of the signal waveform EV shown in FIG. 33 due to the interference fringes is reduced.

In addition to the above-described method, there are methods for reducing the precision deterioration due to the interference fringes when an image is measured using the spatial image detector KES. One of them is a method for scanning the rectangular aperture 141 of the spatial image detector KES a plurality of times for one projected L&S pattern image MXS(i, j) or MYS(i, j). In this case, the signal processing circuit is assumed to be the above-described circuit shown in FIG. 30, the waveform process like the one shown in FIGS. 34(A) and (B) is performed in each of the plurality of times of the scanning for the rectangular aperture 141, and after the central position (or the image distortion vector) of the projection image is obtained for each scanning, the central position (or the image distortion vector) is averaged on the software of the CPU 154.

Since the angle of the vibration mirror 7D is infinitesimally changed while the rectangular aperture 141 is thus scanned a plurality of times, the position of the interference fringes is infinitesimally shifted in each scanning for the rectangular aperture 141. As a result, the central position (or the image distortion vector) of the projection image which can possibly scatter and be measured due to the influence of the interference fringes contrast can be averaged and obtained, thereby improving the measurement accuracy that much.

In the above-described configuration, the wafer stage 14 is scanned in the X or the Y direction when a projection image is detected with the spatial image detector KES. However, a similar distortion measurement can be made also by making the spatial image detector KES stationary at a certain measurement position, and by infinitesimally moving the reticle R in the X or Y direction. Additionally, the spatial image detector KES(wafer stage 14) and the reticle R may be synchronously moved at a speed rate different from the initial speed rate, for example, in the Y direction (scan-exposure direction), and the signal waveform which can be obtained from the reception element 143 may be analyzed during that time period.

In this case, for example, both the rectangular aperture 141 and the projection image MYS(i, j) of FIG. 32 move in one direction along the Y direction with a constant speed difference, and the projection image MYS(i, j) is relatively scanned by the rectangular aperture 141 by the speed difference, so also the signal from the reception element 143 becomes the waveform in a stairs state. When both the reticle R and the spatial image detector KES are synchronously moved in this manner, strictly speaking, it is not considered that the static distortion characteristic at an ideal lattice point is measured. However, if the waveform of the photoelectric signal at that time is analyzed, it is possible to find out the averaged image distortion vector in a local range, where the L&S pattern projection image MYS(i, j) is scanned and moved within the projection view field IF, that is, the dynamic distortion characteristic.

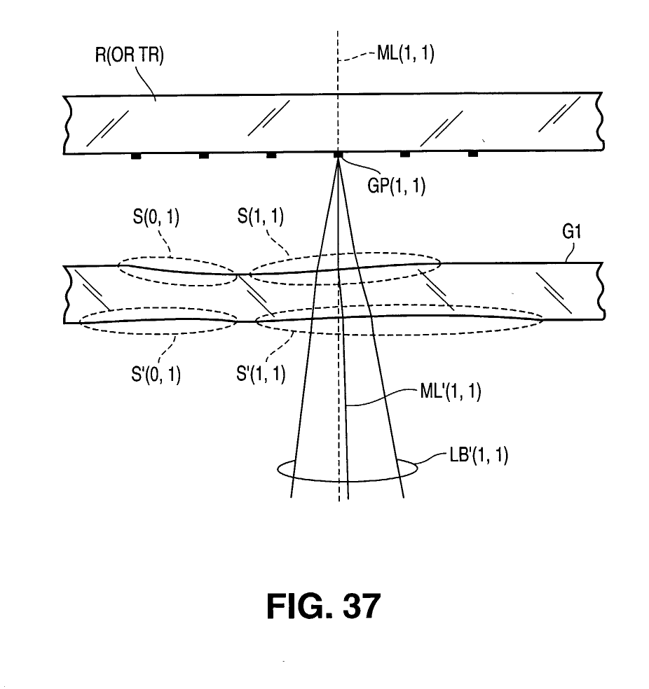

Based on the result of the above-described automatic measurement, when the image distortion correction plate G1 is polished with the polishing processing machine processor shown in FIG. 11, not only one side of the image distortion correction plate G1 as previously shown in FIG. 9 but both sides may be polished as show in FIG. 37. FIG. 37 exaggeratedly shows a partial cross-section of the image distortion correction plate G1 through which the imaging light beam LB′(1, 1) from one lattice point GP(1, 1) on the reticle R or the test reticle TR passes.

In the case of FIG. 37, polishing areas S′(1, 1) and S′(0, 1) are set on the lower surface of the image distortion correction plate G1 (on the projection optical system PL side) in response to the polishing areas S(1, 1) and S(0, 1) on the front surface. Also each of the polishing areas S′(1, 1) and S′(0, 1) on the lower surface is polished to be a slope of a wavelength order in order to give an infinitesimal deflection angle optimum for the imaging light beam (principal ray).

By way of example, the imaging light beam LB′(1, 1) shown in FIG. 37 is deflected by the two infinitesimal slopes of the polishing areas S(1, 1) and S′(1, 1). Accordingly, if the tilt directions and amounts of the polishing areas S(1, 1) and S′(1, 1) are set to be almost the same, only the local areas can be modified on a tilted parallel plate, so that the deflection corrected principal ray MB′(1, 1) can be restored to be almost parallel to the optical axis AX. Therefore, there is an advantage that the principal ray MB′(1, 1) from the object point GP(1, 1) becomes almost vertical to the projection image plane of the projection optical system PL, and the telecentric state is maintained.

Additionally, if both sides of the image distortion correction plate G1 are polished, a plurality of adjacent polishing areas which have to be overlapped among the polishing areas S(i, a) and S(i, b) can be separated on the front and the back surfaces of the image distortion correction plate G1 even if they exist, as explained earlier by referring to FIG. 10. As a result, there is an additional advantage that the joint of the polished planes on the same surface becomes smooth, which leads to the implementation of a more precisely distortion correction.

Explained next is the optical condition of the illumination optical system of the projection exposure system, which must be considered when a distortion characteristic is measured in this embodiment. As explained earlier by referring to FIG. 2, the illumination optical system of the projection exposure apparatus of this type is normally configured as a Koehler illumination system which images a plane light source image (actually a set of 5 to 10 thousand luminance points) formed on the exit side of the second fly eye lens 7G at an entrance pupil or an exit pupil of the projection optical system PL. With this system, an even illuminance distribution of approximately ±1 percent is respectively obtained at the position of the blind 7L as the first irradiated plane, the position of the pattern plane of the reticle R as the second irradiated plane, and the position on the image plane (wafer plane) of the projection optical system PL as the third irradiated plane if no contrast of the interference fringes (or speckle) caused by the coherence of an excimer laser light beam is assumed to exist.

However, with the recent improvement of the density and the minuteness of a semiconductor device, problems have arisen not only in the evenness of the illuminance distribution on an irradiated plane but also in the shift from a telecentric condition of an illumination light irradiated on the irradiated plane (especially on the wafer plane), that is, a telecentric error. However, this telecentric error is construed as including also a telecentric error possessed by the projection optical system PL itself.

In particular, in recent years, the respective types of an illumination CY diaphragm plate (hereinafter referred to as a spatial filter) 7H, such as a ring aperture, a quadro-pole aperture, a small circular aperture, a large circular aperture, or the like, are arranged to be exchangeable on the exit side of the second fly eye lens 7G as shown in FIG. 2, and the shape of the illumination light source plane is changed according to the pattern on the reticle R.

In this case, the telecentric correction plate 7N which is arranged in the neighborhood of the condenser lens system shown in FIG. 2 may be mounted in the optical path so as to correct a telecentric error at each point by being polished with a method similar to the method for manufacturing the image distortion correction plate G1 so that the telecentric error of the illumination light reaching the wafer W side is measured at each point on the irradiated plane in a state where the spatial filter 7H is not mounted in the optical path or in a state where the spatial filter having a large circular aperture is mounted in the optical path. Or, an aspheric process (including the case where a spherical surface is locally polished with the polishing processing machine shown in FIG. 11) such that a measured telecentric error is corrected for a particular lens component included in the condenser lens systems 7K, 7Q, or the like, shown in FIG. 2, may be performed.

Accordingly, it becomes necessary to accurately measure the telecentric error of an illumination light on the image plane side of the projection optical system PL. For that measurement, the above-described space image detector KES and the test reticle TR described above with reference to FIGS. 30 through 34 can be used as they are. However, to obtain the telecentric error, the XY coordinate position of a projection image is repeatedly measured by scanning the projection image of an L&S pattern on the test reticle TR with the rectangular aperture 141 by changing the position of the wafer table TB in the Z direction by a predetermined amount (such as 0.5 μm) based on the detection result of a focus detection system of a diagonally incident light type, so that the change in the XY coordinate position according to the position of one L&S pattern image in the Z direction, that is, the direction and the amount of the tilt of the principal ray of the L&S pattern image to the Z axis are measured.

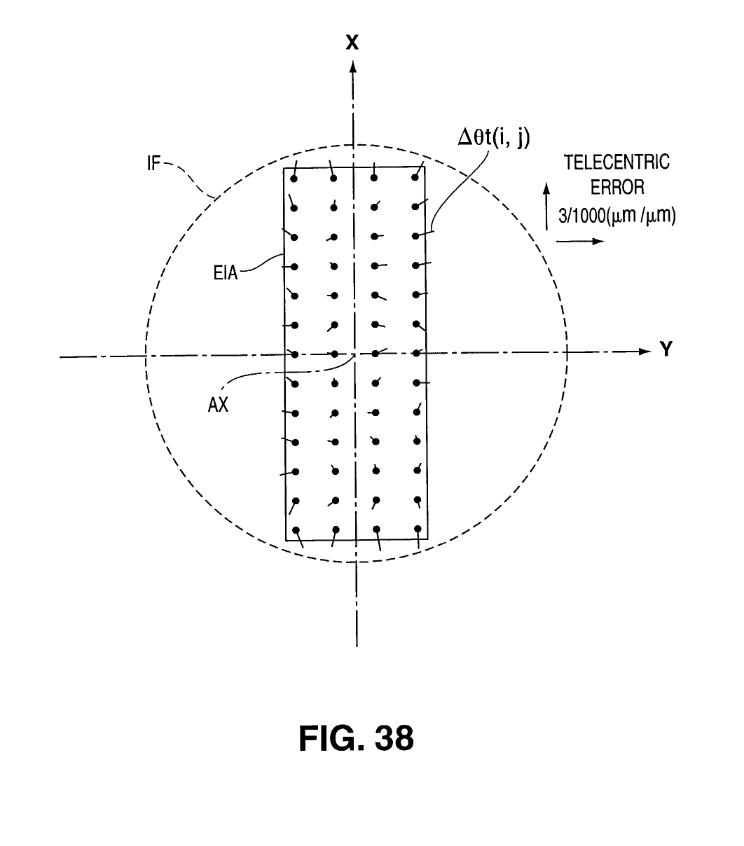

By making such a telecentric error (a tilt error of an imaging light beam) measurement for each projection image of the L&S pattern arranged at each ideal lattice point on the test reticle TR, the telecentric error distribution within the projection image plane or the effective projection area EIA can be known, for example, as FIG. 38. FIG. 38 exemplifies the exaggerated distribution of a local telecentric error occurring within the effective projection area EIA. Black points in this figure represent ideal lattice points or points conforming thereto, and a segment extending from each of the black points represents a telecentric error vector (direction and magnitude) Δθt(i, j).

This telecentric error vector Δθt(i, j) represents how much the principal ray at a projection image point shifts in the X and Y directions per distance of 1000 μm in the Z direction as an example. The overall tendency of the vector map shown in FIG. 38 exhibits the coexistence of a component which can be approximated by function and a random component, which is similar to a distortion characteristic.

Accordingly, by measuring a telecentric error vector map like the one shown in FIG. 38, the coordinate position within the projection view field IF where a telecentric error to be modified (corrected) occurs is determined, and the correction amount of the principal ray at the coordinate position is calculated, and the infinitesimal slope of a wavelength order may be formed by locally polishing the surface of the telecentric correction plate 7N (or lens component) based on the result of the calculation.

Additionally, it is desirable to simulate the polished state of the telecentric correction plate 7N by measuring the telecentric error characteristic of an illumination light with the spatial image detector KES, to perform an actual polishing process based on the result, and to re-perform the polishing process (modification polishing) for the telecentric correction plate 7N in consideration of the result of observing and measuring the state of the resist image by using an optical or an electron microscope when test printing (scan-exposure) is performed with the processed telecentric correction plate 7N mounted.

As described above, the method for performing a polishing process based on both of the result of photoelectric detection of a spatial intensity distribution of a projection image, and a measurement result of the quality of an image which is actually etched on a resist layer by test printing can be applied also to the manufacturing of the image distortion correction plate G1 as well as the telecentric correction plate 7N, thereby maximizing the projection performance when an actual device pattern is scan-exposed onto the wafer W.

Additionally, the telecentric correction plate 7N can collectively correct a telecentric error (offset amount) which equally occurs at each point within the projection view field if this plate is arranged to be tiltable in a direction arbitrary to the plane vertical to the optical axis AX of the illumination system, similar to the image distortion correction plate G1 described earlier.

In the meantime, with the measurement of an L&S pattern projection image, which uses the spatial image detector KES, an image plane astigmatism or coma occurring at each point within the projection view field IF or within the rectangular projection area EIA, an image plane curvature, or the like can be measured. Accordingly, also the astigmatism/coma correction plate G3 at the bottom of the projection optical system PL, which is shown in FIG. 2, is polished so that the aberration amount is reduced to “0” by averaging the aberration amount at the time of scan-exposure, or the aberration amount is reduced to “0” in a static state based on the astigmatism/coma aberration amount measured at each point within the projection field IF or the rectangular projection area EIA in the same manner and is mounted in the bottom of the projection optical system PL after being polished.

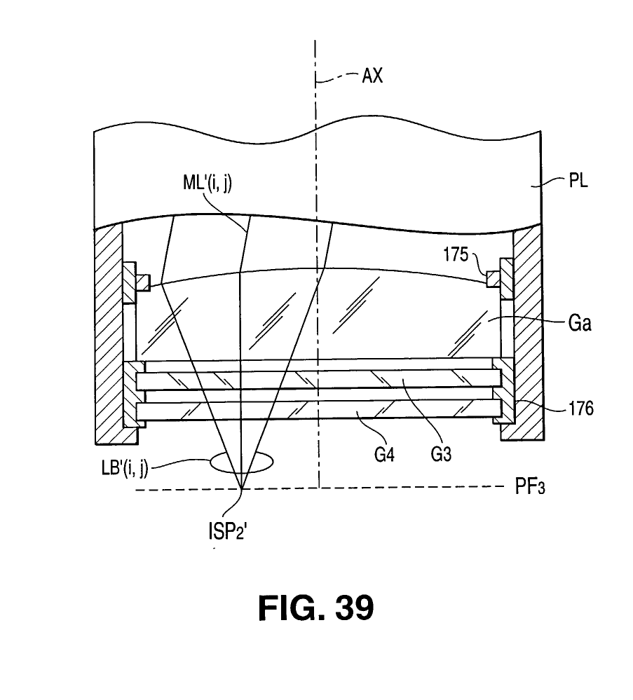

Furthermore, although omitted in FIG. 2, the image plane curvature correction plate (quartz plate) G4 having the plane shape for correcting the curvature of a projection image plane is attached in parallel with the astigmatism/coma correction plate G3 as shown in FIG. 39. FIG. 39 is a partially cross-sectional view showing the bottom of the projection optical system PL, and the state where a lens component Ga closest to the projection image plane PF3 is fixed within the lens barrel of the projection optical system PL through a ring-shaped metal holding 175. The astigmatism/coma correction plate G3 and the image plane curvature correction plate G4 are fixed between the lens component G and the image plane PF3 within the lens barrel through a ring-shaped metal holding 176.

Here, the image plane PF3 is a best focus plane which is optically conjugate to the pattern plane of the reticle R, and the principal ray ML′(i, j) of the imaging light beam LB′(i, j), which converges at an image point ISP2′ on the image plane PF3, is parallel to the optical axis AX between the lens component Ga and the image plane PF3. At this time, the numerical aperture NAw of the imaging light beam LB′(I, j) is larger by an inverse number of the projection magnification (¼, ⅕, or the like) in comparison with the numerical aperture NAr on the reticle side, and is approximately 0.5 to 0.7.

Therefore, the spread area of the imaging light beam LB′(I, j) when going through the astigmatism/coma correction plate G3 and the image plane curvature correction plate G4 becomes much larger than the image distortion correction plate G1 on the reticle side. Accordingly, the overlapping between the imaging light which generates another image point positioned in the neighborhood of the image point ISP2′ and the imaging light beam LB′(I, j) on the astigmatism/coma correction plate G3 of FIG. 39 cannot be avoided.

However, the polishing of the surface of the astigmatism/coma correction plate G3 is not required to be taken into account for the entire surface of the astigmatism/coma correction plate G3, in consideration of the fact that also the aberration characteristic in the width direction (scanning direction) within the rectangular projection area EIA is averaged by scan-exposure, and may be performed for a local area in consideration of the averaging at the time of scan-exposure. Therefore, a polished surface when polishing the astigmatism/coma correction plate G3 can be relatively jointed with ease.

In the meantime, the image plane curvature is determined by measuring the best focus position (Z position) of an L&S pattern image at each point on the test reticle TR, which is projected under a certain illumination condition, with the off-line method by text printing and the spatial image detector KES, and by obtaining an approximate plane (a curved surface) on which the measured best focus position at each point is approximated with a least square method, or the like.

In this case, the detection of a projection image by the space image detector KES is performed by changing the Z position of the table TB while measuring the position of the height position of the surface of the shading plate 140 with a focus detection system such as a diagonally incident light method, or the like, and the Z position of the table TB such that also the contrast (the peak value of a differential waveform, a level of a bottom value) of the L&S pattern projection image becomes the highest is measured as the best focus position.

If the flatness of the approximate plane of the projection image plane thus determined is not within an allowable range at least in the rectangular projection area EIA at the time of scan-exposure, the polishing process such that an image plane curvature is modified by taking out the image plane curvature correction plate G4 from the projection optical system PL is performed. In this case, the image plane curvature correction plate G4 is generally manufactured to correct the tendency of the entire image plane curvature within the projection view field by entirely polishing its one side with a positive curvature, and the other with almost a same negative curvature.

However, if there is a portion where the image plane curvature is locally large within the projection view field (within the rectangular projection area EIA), it is also possible to correct that portion by locally performing additional polishing. Additionally, it is desirable to measure a profile of an actual resist image transferred by test printing and to consider also the result of that measurement not only depending on a photoelectric measurement result of a projection image, which is obtained by the space image detector KES, when the above-described astigmatism/coma correction plate G3 and the image plane curvature correction plate G4 are manufactured.

Next, other illumination condition which must be considered when the above-described distortion characteristic, astigmatism/coma aberration, image plane curvature, and the like are measured will be explained. As described earlier, an even illuminance distribution of approximately ±1 percent can be obtained on an irradiated plane of the position of the blind 7L, the position of the pattern plane on the reticle R (test reticle TR), the position of the image plane (wafer plane) of the projection optical system PL and the like by the operations of the first fly eye lens 7C and the second fly eye lens 7G, which are shown in FIG. 2.

However, it is also proved that the irradiation state of an illumination light has not only a problem in the evenness of an illuminance distribution on an irradiated plane, but also a problem in the local degradation of an overall imaging performance capability including a resolution, a distortion error, various aberration types, or the like due to the phenomenon that the numerical aperture (NA) of the illumination light partially differs according to the position within the irradiated plane, that is, an occurrence of an NA difference (unevenness within an illumination angle) according to a image height which is the distance from the optical axis AX. This phenomenon is caused not only by a σ value change depending on the image height position of the illumination system, but also by the respective aberration types of the illumination optical system from the second fly eye lens 7G to the reticle R shown in FIG. 2, an arrangement error when a plurality of optical members configuring the illumination optical system are assembled and manufactured, or an angle characteristic of a thin film for preventing a reflection, which is coated on the respective optical members, or the like.

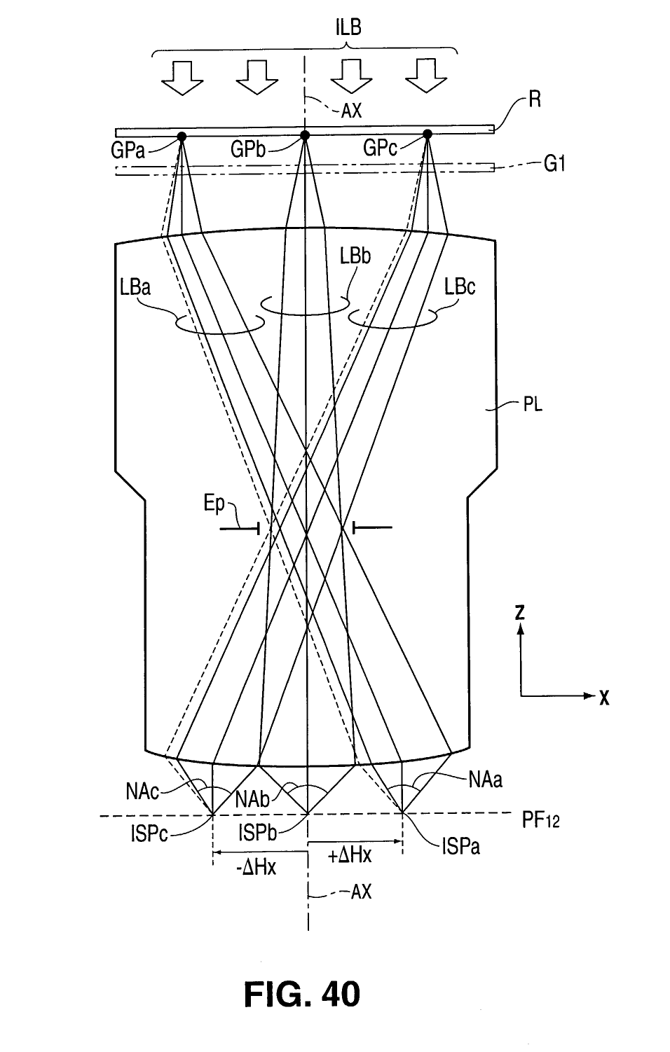

Additionally, such an NA difference of the illumination light according to the image height is a phenomenon which can possibly occur due to an aberration of the projection optical system PL by itself. As a result, as exaggeratedly shown in FIG. 40, for example, numerical apertures NAa, NAb, and NAc of imaging light beams LBa, LBb, and LBc for forming respective three image points ISPa, ISPb, and ISPc on the projection image plane PF3 differ depending on the image height position ±ΔHx.

FIG. 40 shows the state where an object point (ideal lattice point) GPb at a position on the optical axis AX on the reticle R, an object point GPc apart from the object point GPb by a distance M·±ΔHx in a positive direction along the X axis (axis in a non-scanning direction), and an object point Gpa apart from the object point GPb by the distance M·±ΔHx in a negative direction of the X axis are respectively imaged and projected as image points ISPa, ISPb, and ISPc through a bilaterally telecentric projection optical system PL at a reduction magnification 1/M (M is approximately 2 to 10).

At this time, the reticle R is irradiated with an almost even intensity distribution by an illumination light ILB which is adjusted to be a predetermined numerical aperture and a predetermined a value, and the imaging light beams LBa, LBb, and LBc, which proceed to the image plane PF3 side without being shaded by the pupil (diaphragm aperture) EP of the projection optical system PL, among the lights entering from the respective object points to the projection optical system PL via the image distortion correction plate G1, contribute to the imaging formation of the respective image points.

Furthermore, in FIG. 40, partial light beams indicated by broken lines at the left side of the respective image light beams LBa and LBc represent portions which are lost or attenuated as unevenness within an illumination angle from the original aperture state. If an NA difference according to the image height position as described above, a gravity center line, which is determined by the center of gravity of light amount on each of the cross-sectional planes of the respective imaging light beams LBa and LBc, becomes the one tilting from the principal ray on the image plane PF3, although each light beam of the imaging light beam LBa at the image height+ΔHx, and the imaging light beam LBc at the image height−ΔHx go through the central point (optical axis AX) of the pupil Ep.

Considered will be the case where an L&S pattern almost at a resolution limit, which is positioned, for example, in the center of the illumination area on the reticle R, that is, in the neighborhood of the optical axis AX of the projection optical system PL, and an L&S pattern almost at a resolution limit, which is positioned at the periphery of the illumination area apart from the optical axis AX, are projected and exposed in the state where there is such an NA difference according to the image height of the illumination light.

In this case, even if the intensity distributions of the illumination light irradiating the respective L&S patterns at the two positions are identical, an effective NA of the illumination light for the L&S pattern in the neighborhood of the optical axis AX is larger (smaller depending on a case) than the illumination light for the L&S pattern apart from the optical axis AX. Therefore, a difference exists between the resolutions of the L&S patterns in the neighborhood and the periphery of the optical axis AX, which are finally transferred onto the wafer W, which poses a problem such that the contrast or the line width of an image to be transferred may differ depending on the position on the image plane although the L&S patterns have the same line width and pitch.

Additionally, the NA difference of the illumination light causes a problem such that the line widths or duties of the projection images of two L&S patterns may be infinitesimally changed according to a pitch direction, when the two L&S patterns of a same design with different pitch directions are closely arranged on the reticle.

Although there is no effective NA difference between the center of an illumination area and its periphery, there may arise a problem such that the whole of the illumination light beam irradiated on the reticle R (or the wafer W) slightly tilts not at an angle symmetrical with respect to the optical axis AX, but in a certain direction. However, its adjustment can be made by infinitesimally moving the positions of the second fly eye lens 7G and the other optical elements within the illumination optical system in the X, Y, Z, or θ direction in that case.

The above-described NA difference according to the image height of an illumination light naturally becomes a problem also when the above-described distortion characteristic is measured, when the telecentric error map shown in FIG. 38 is measured, or when the astigmatism/coma aberration and the image plane curvature are measured, and an error is included in static image distortion, telecentric error vector to be measured, as shown in FIGS. 30-33.

Therefore, it is desirable that the NA difference according to the image height of an illumination light irradiated on the reticle R is adjusted when a distortion is measured at the time of manufacturing the image distortion correction plate G1, when a telecentric error is measured, when an astigmatism/coma aberration is measured, or when image plane curvature is measured in addition to when a wafer is exposed on a device manufacturing line. Arranged for such an adjustment is the plate for correcting an illumination NA difference (hereinafter referred to as an illumination NA correction plate) 7F which is positioned on the incidence plane side of the second fly eye lens 7G shown in FIG. 2.

In the meantime, the spatial image detector KES previously explained in FIG. 30 is intended to detect light amount within a rectangular aperture 141 on a projection image plane, and cannot detect the amount by making a distinction between the illuminance of an illumination light on a projection image plane and the NA difference according to the image height of the illumination light. Meanwhile, since the resist layer on the wafer W is sensitive to the NA difference according to the image height of an illumination light and to an illuminance change, a definite distinction emerges in the imaging characteristic (resist profile) of the pattern image projected onto the resist layer.

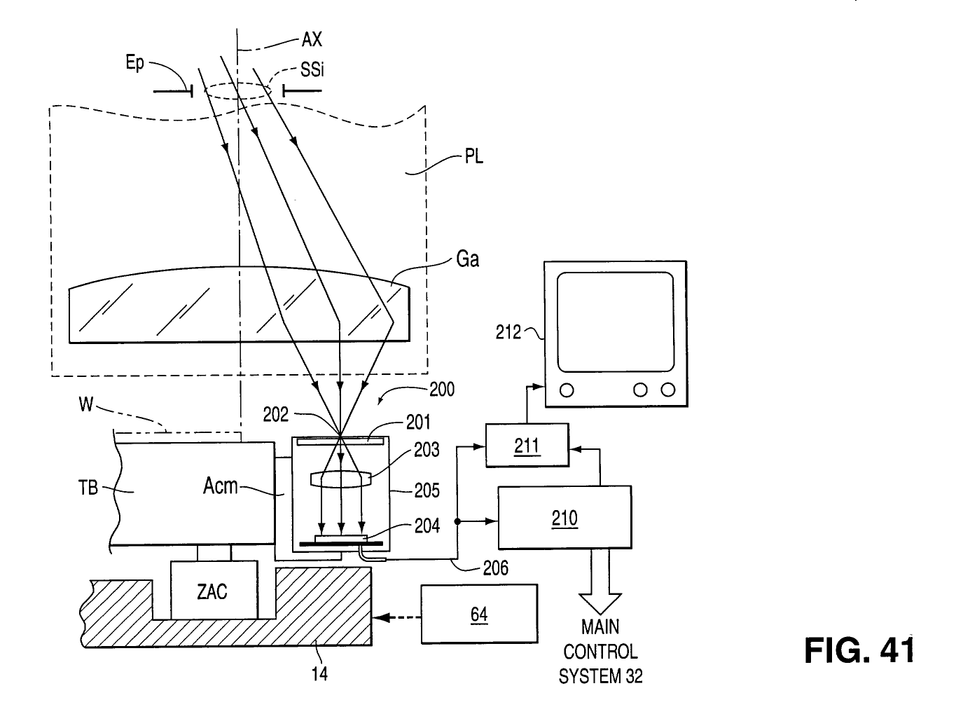

Accordingly, in this embodiment, an illumination NA measurement sensor 200 which can automatically measure the NA difference according to the image height of an illumination light at arbitrary timing while the apparatus is running is arranged, for example, to be detachable to the wafer table TB in FIG. 2 via a metal fixture A cm as shown in FIG. 41. FIG. 41 is an enlarged view showing the partial structure of the table TB to which the illumination NA measurement sensor 200 is attached, and the bottom of the projection optical system PL. On the sensor 200, a shading plate 201 on which a shading layer of chrome or the like is formed on the entire surface of a quartz plate is formed is arranged, and a pin hole 202 having a diameter which is determined based on a wavelength λ of an illumination light, the numerical aperture NAw on the image side of the projection optical system PL, or the like is arranged in a portion of the shading layer.

Under the pin hole 202 of the shading plate 201, a lens component 203 for converting an illumination light which went through the pin hole 202 into a parallel light beam, that is, a Fourier transform lens is arranged. On the Fourier transform plane implemented by the lens component 203, a CCD 204 as a two-dimensional imaging element is arranged. The shading plate 201, the lens component 203, and the CCD 204 are collectively included in a case 205 of the sensor 200. The image signal from the CCD 204 is transmitted to an image processing circuit 210, and a video signal mixer circuit 211 arranged outside of the apparatus via a signal cable 206.

The video signal mixer circuit 211 composes a scale signal and a cursor signal from the image processing circuit 210 and an image signal from the signal cable 206 and controls the image so that a light source image SSi which is formed in the pupil Ep is displayed on the display 212. The image processing circuit 210 comprises software for detecting the optical intensity distribution of the light source image SSi in correspondence with the arrangement of the lens components of the second fly eye lens 7G, and for analyzing a portion which is especially uneven in the intensity distribution, and has a capability for transmitting the result of the analysis to the main control system 32 of FIG. 2.

In the above-described configuration of the sensor 200, the surface of the shading plate 201 of the sensor 200 is located at the Z position matching the projection image plane PF3 of the projection optical system PL, or the Z position accompanying a predetermined offset from the projection image plane PF3 by the focus detection system and the actuator ZAC in a predetermined leveling state, when the NA difference of an illumination light is measured. Additionally, the XY stage 14 is driven by the driving system 64 so that the pin hole 202 is located at arbitrary X, Y position within the projection view field IF or the rectangular projection area EIA of the projection optical system PL.

When measurement is made, an original reticle on which no patter is drawn is mounted on the reticle stage 8, the original reticle is evenly illuminated by an illumination light ILB, and the pin hole 202 is located at the image height position to be measured within the projection view field IF or the rectangular projection area EIA. Because the illumination light ILB is a pulse light at that time, the illumination light which went through the pin hole 202 is accumulated and photoelectrically detected by the CCD 204 while the illumination light ILB is irradiated with a predetermined number of pulses if the CCD 204 is arranged as a charge storage type.

Since the image plane of the CCD 204 is the Fourier transform plane, the CCD 204 shoots and images the intensity distribution of the light source image SSi imaged in the pupil Ep of the projection optical system PL. However, the light source image SSi formed in the pupil EP is similar to the shape of the portion which went through the aperture of the spatial filter 7H among innumerable luminance point group planes formed on the exit plane side of the second fly eye lens 7G in FIG. 2.

Since this embodiment assumes the apparatus for performing scan-exposure in a width direction (Y direction) of the rectangular projection area EIA, also effects by the illumination NA difference of the quality of a pattern image to be transferred onto the wafer W is an average of the illumination NA difference in the size of the width direction of the projection area EIA. Accordingly, it is desirable to obtain a dynamic illumination NA difference by partitioning the projection area EIA into a plurality of areas at predetermined intervals in the non-scanning direction (X direction), and by averaging the static illumination NA difference in the scanning direction for each of the partitioned areas, in a similar manner as in the case of the distortion measurement.

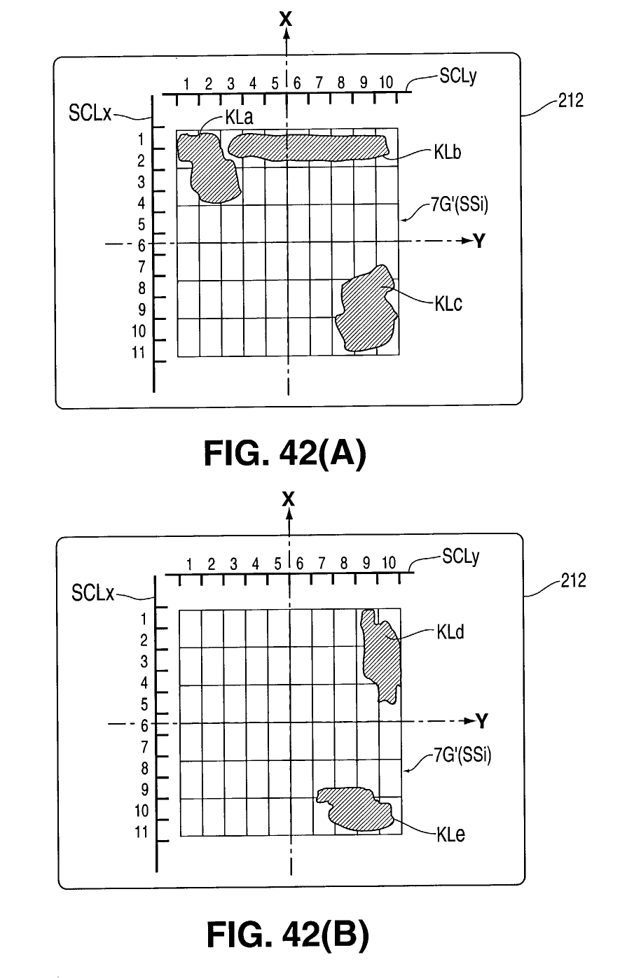

Therefore, the measurement of the static illumination NA difference will be explained by referring to FIGS. 42(A) and 42(B). FIGS. 42(A) and 42(B) illustratively show the examples of the light source image SSi, which are respectively displayed on the display 212 when the pin hole 202 is located at different positions within the projection area EIA. On the screen of the display 212, a cursor line representing an array 7G′ (light source image SSi) of the lens component on the exit side of the second fly eye lens 7G, and scale lines SCLx and SCLy which represent the positions in the X and Y directions are displayed at the same time.

In FIGS. 42(A) and 42(B), the array 7G′ on the exit plane side of the second fly eye lens 7G is adjusted to be almost a square as a whole, and the cross-sectional shape of each lens component is a rectangle which is almost similar to the projection area EIA. That is, since the incident plane side of each lens component is conjugate to the irradiated plane (a blind plane, a reticle plane, or a projection image plane), the size in the scanning direction (Y direction) is smaller than that in the non-scanning direction (X direction) in order to efficiently irradiate the projection area EIA on the irradiated plane.

In case of FIG. 42(A), each of the intensities of an area KLa at the upper left corner, an area KLb in the top row, and an area KLc at the lower right corner within the array 7G′ is lower than a tolerable value compared to its peripheral intensity. Meanwhile, FIG. 42(B) shows an example where each of the intensities of an area KLd at the upper right corner and an area KLe at the lower right corner within the array 7G′ is lower than a tolerable value compared to its peripheral intensity.

As described above, since the intensity distribution of the light source image SSi formed in the pupil Ep of the projection optical system PL varies according to the position within the projection field of the pin hole 202, that is, the image height, the quality of a pattern image to be projected on the reticle R (or TR) may be deteriorated. For example, if the center of gravity of the entire distribution of the light source image SSi (array 7G′) is decentered from the coordinate origin (optical axis AX) in a lower left direction as shown in FIG. 42(A), the imaging light beam of the pattern to be projected at the image height position becomes the one deteriorated from the telecentric state. If a comparison is made between FIGS. 42(A) and 42(B), an NA of illumination light beam on the projection image plane PF3 is smaller as a whole in FIG. 42(A).

The shape of the light source image SSi when the wafer W is actually scan-exposed is set by the aperture shape of the spatial filter 7H which is arranged on the exit side of the second fly eye lens 7G. Therefore, the shape of the light source image SSi becomes the aperture shape (a circular shape, a ring shape, a quadro-pole aperture, or the like) in the square array 7G′ shown in FIG. 42(A) and 42(B), which is restricted by the spatial filter 7H.

To average such an illumination NA difference according to the image height within the projection view field, a plurality of measurement points in a matrix state are set within the rectangular projection area EIA, the image signal from the CCD 204 is observed on the display 212 each time the pin hole 202 is located at each of the measurement points, and an uneven area within the intensity distribution of the light source image SSi (array 7G′) is analyzed by the image processing circuit 210, and the static illumination NA characteristic (the vector representing the directionality of an NA and its degree) at each of the measurement points is sequentially stored based on the result of the analysis.

Thereafter, a dynamic illumination NA characteristic is calculated by averaging the illumination NA characteristic at several measurement points arranged in the scanning direction among the static illumination NA characteristic at the respective measurement points. This dynamic illumination NA characteristic is obtained at predetermined intervals in the non-scanning direction of the rectangular projection area EIA, and the illumination NA difference according to the image height is obtained particularly in the non-scanning direction by making a comparison between the dynamic illumination NA characteristics.

Then, the illumination NA correction plate 7F which is arranged on the incident plane side of the second fly eye lens 7G in FIG. 2 is processed based on the dynamic illumination NA characteristic thus obtained, and a correction is made to reduce the difference between the dynamic illumination NA in the non-scanning direction almost to “0”. In this embodiment, since the rectangular projection area EIA is set along the diameter extending in the non-scanning direction within the circular projection field IF of the projection optical system PL, the dynamic illumination NA corresponds to the image height from the optical axis AX.

Accordingly, to correct the dynamic illumination NA difference in the non-scanning direction, the illumination NA correction plate 7F may be manufactured to have the illumination a value at each image height in the non-scanning direction with an offset. As a method for changing the illumination a value depending on the image height, for example, a beam attenuating part for changing the size or the intensity of the illumination light beam entering each lens component or for decentering the intensity distribution for each lens component (rod lens) in the periphery on the incident plane side of the second fly eye lens 7G may be locally formed on a transparent (quartz) plate.

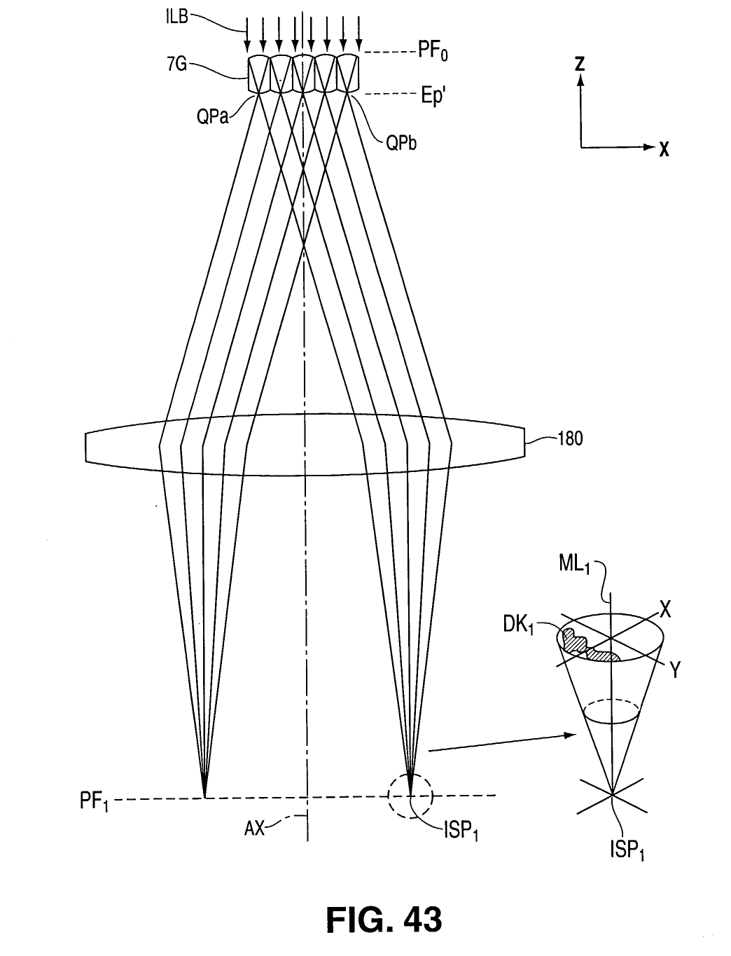

Therefore, the state of the illumination light on the irradiated plan will be briefly explained by referring to FIG. 43. FIG. 43 illustratively shows the system from the second fly eye lens 7G to the irradiated plane PF1, which is shown in FIG. 2. A collective lens system 180 represents a composition system of the mirror 7J, the collective lenses 7K and 7M, the mirror 7P, and the condenser lens system 7Q, which are shown in FIG. 2. Accordingly, the irradiated plane PF1 is the pattern plane of the reticle R, which is the second irradiated plane, for ease of explanation. However, the illumination NA difference to be actually evaluated is obtained by the projection image plane PF3 on the wafer W (or the shading plate 201 of the measurement sensor 200) side, which is the third irradiated plane including the projection optical system PL.

In FIG. 43, the second fly eye lens 7G is a bundle of a plurality of square-pillar-shaped rod lenses, and the illumination light beam ILB incident to the incident plane PF0 which is conjugate to the irradiated plane PF1 is split by each rod lenses and collected as a plurality of point light source images (collective points) on the exit plane Ep′ side. Here, the light source images formed on the exit plane Ep′ side of the rod lenses apart from the optical axis AX within the second fly eye lens 7G are respectively QPa and QPb.

However, since the first fly eye lens 7C is arranged in this embodiment as explained earlier by referring to FIG. 2, the light source image formed on the exit plane Ep′ side of one rod lens of the second fly eye lens is a relay of an aggregate of the plurality of point light source images formed on the exit side of the first fly eye lens 7C.

Viewing from the irradiated plane PF1, the exit plane Ep′ of the second fly eye lens 7G is a Fourier transform plane (pupil plane), and the split light which diverges and proceeds from each of the rod lenses of the second fly eye lens 7G is transformed into almost parallel light beam, and integrated on the irradiated plane PF1. In this way, the intensity distribution of the illumination light on the irradiated plane PF1 is made even.

However, observing the state of the illumination light beam irradiated at a peripheral irradiated point ISP1 apart from the optical axis AX on the irradiated plane PF1 in the non-scanning direction (X direction), the numerical aperture of the illumination light beam converged at the point ISP1 becomes smaller relatively in the X direction due to an intensity attenuated portion DK1 within the light beam, as shown in the perspective view in the lower right of FIG. 43. ML1 represents a principal ray which goes through the central point of the pupil of the projection optical system PL and reaches the irradiated point ISP1 in this figure.

As described above, the illumination light beam including the attenuated (or increased) portion like the portion DK1 in FIG. 43 can possibly occur if the intensity of the light source image QPa formed by the rod lens positioned at the left end of the second fly eye lens 7G is extremely low (or extremely high), or if the intensity of the light source image QPb formed by the rod lens positioned at the right end of the second fly eye lens 7G is extremely high (or extremely low).

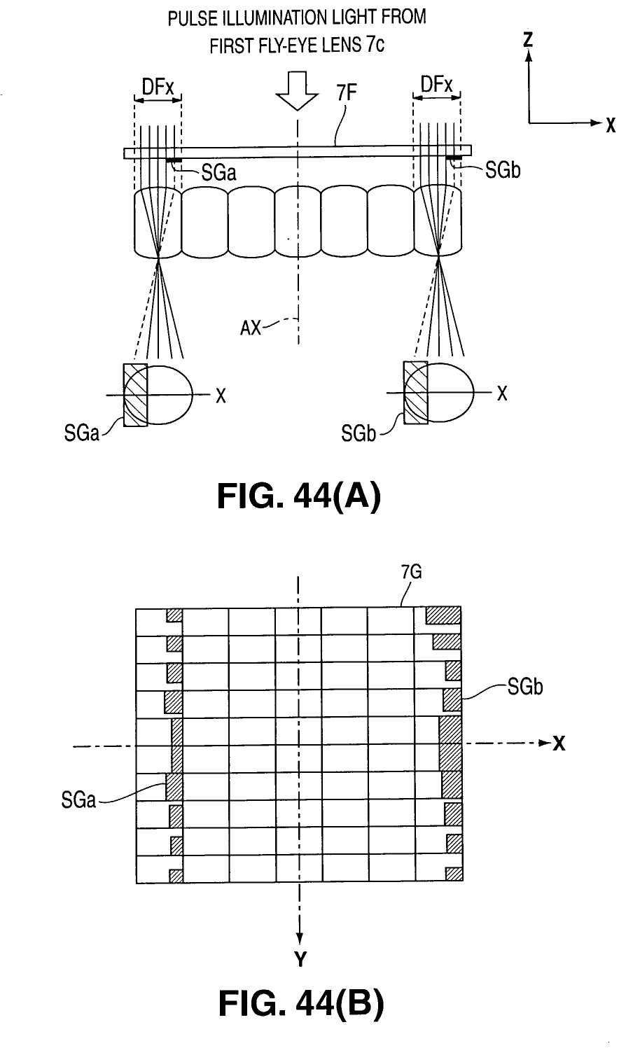

Accordingly, for example, as shown in FIG. 44(A), a thin film filter part SGa or SGb through which the illumination light beam having a width DFx, which enters the rod lens at the left or right end of the second fly eye lens 7G, is entirely or partially beam-attenuated is formed on the illumination NA correction plate 7F as a shading unit. FIG. 44(A) is a diagram showing the positional relationship between the second fly eye lens 7G and the illumination NA correction plate 7F, which is enlarged on the X-Z plane. FIG. 44(B) is a diagram showing the positional relationship in terms of a plane between filter units SGa and SGb formed on the illumination NA correction plate 7F, and a rod lens (a rectangular cross-section) array of the second fly eye lens 7G.

As shown in FIG. 44(B), the section of each of the rod lenses of the second fly eye lens 7G is a rectangle extending in the non-scanning direction (X direction), and the filter units SGa and SGb are individually arranged for each of the rod lenses existing in sequence in the Y direction at both ends of each rod lens array in the X direction. Since the dynamic illumination NA difference, especially, in the non-scanning direction is corrected in this embodiment, the filter units SGa and SGb are set by paying close attention to both ends of the sequence of rod lenses arranged mainly in the X direction also for the rod lens arrays of the second fly eye lens 7G.

Accordingly, only either of the filter units SGa and SGb can be used, and the shape of the filter unit SGa or SGb can be made identical for the rod lenses arrayed in the Y direction. Here, however, the shapes and the locations of the filter units SGa and SGb are set to be different little by little according to the positions of the rod lenses arranged in the Y direction, and the dynamic illumination NA difference becomes small not only in the non-scanning direction but also in the scanning direction (Y direction).

Also when the illumination NA correction plate 7F is made as described above, the dynamic illumination NA characteristic is measured with the measurement sensor 200 of FIG. 41 in a state where a completely transparent plate (quartz) which becomes a base material of the illumination NA correction plate 7F is arranged on the incident plane side of the second fly eye lens 7G as shown in FIG. 2, and the reticle R is exchanged with the original reticle, in a similar manner as in the above described manufacturing of the image distortion correction plate G1. Then, the filter units SGa and SGb (for example, minute dot-shaped chromium is evaporated or deposited by varying the density with random distribution) which become beam-attenuating parts and the like may be formed on the transparent plate (or its equivalence) which is removed from an exposure apparatus and becomes a base material based on the result of the measurement.

As a matter of course, it is desirable to examine whether or not a correction of a dynamic illumination NA difference according to an image height is preferably made by re-measuring the dynamic illumination NA characteristic with the measurement sensor 200 of FIG. 41 after a manufactured illumination NA correction plate 7F is installed in a predetermined position within the illumination optical path.

Additionally, it goes without saying that the above described manufacturing of the illumination NA correction plate 7F and illumination NA correction using this plate must be performed prior to the various measurement operations using the test reticle TR when the image distortion correction plate G1, the astigmatism/coma aberration correction plate G3, and the image plane curvature correction plate G4 are manufactured.

Meanwhile, as shown in FIG. 2, the spatial filter 7H is arranged to be switchable on the exit side of the second fly eye lens 7G in order to change the shape or the size of the light source image SSi formed in the pupil Ep of the projection optical system PL. Therefore, if the aperture of the spatial filter 7H is switched from a normal circular aperture to a ring aperture, or from the ring aperture to a quadro-pole aperture, the optical characteristic of illumination light beam which irradiates the reticle R or the test reticle TR may differ, so effects on the projection optical system PL may also differ.

Accordingly, it is desirable that each of the above-described image distortion correction plate G1, astigmatism/coma aberration correction plate G3, image plane curvature correction plate G4, illumination NA correction plate 7F is configured to be exchangeable for an optimum plate according to the shape of the aperture of the spatial filter 7H in synchronization with the switching of the spatial filter 7H.

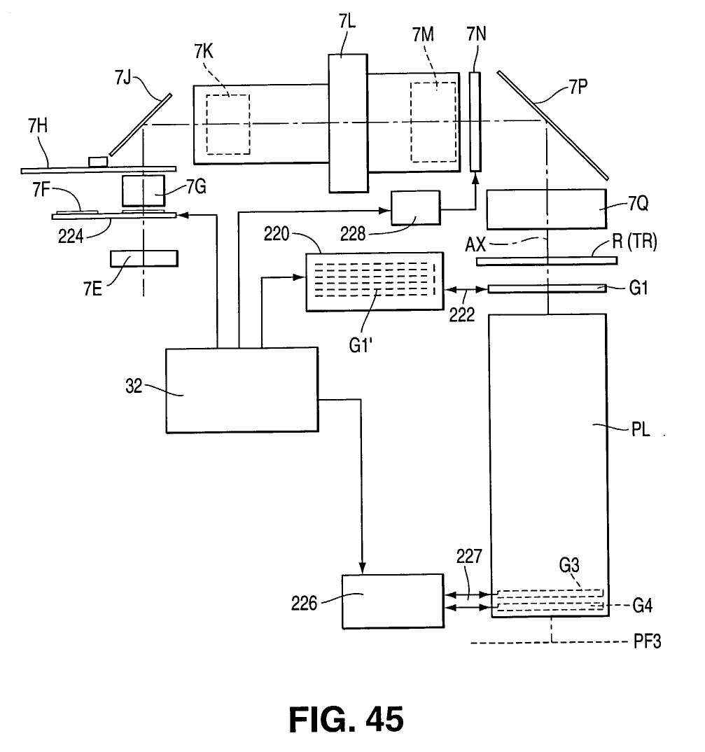

FIG. 45 shows the outline of the configuration of a projection exposure apparatus where the image distortion correction plate G1, the astigmatism/coma aberration correction plate G3, the image plane curvature correction plate G4, and the illumination NA correction plate 7F are respectively made exchangeable, and the fundamental arrangement of the respective optical members from the collective lens 7E within the illumination optical system to the projection image plane PF3 of the projection optical system PL is the same as that in the configuration of FIG. 2. In FIG. 45, the image distortion correction plate G1 is arranged to be exchangeable for a plurality of image distortion correction plates G1′ which are polished beforehand according to the shape or the size of the aperture of the spatial filter 7H and are in stock in a library 220, and its exchange operations are performed by an automatic exchange mechanism 222 which operates in response to the command from the main control system 32.

Additionally, on a switching mechanism 224, such as a turret, a linear slider, or the like, a plurality of illumination NA correction plates 7F can be mounted, and each of the plurality of correction plates 7F is manufactured in advance so that a dynamic illumination NA difference becomes a minimum according to the shape or the size of the aperture of the spatial filter 7H. Which illumination NA correction plate to be selected is determined in correspondence with the spatial filter 7H selected in response to the command from the main control system 32.

Also for the astigmatism/coma correction plate G3 and the image plane curvature correction plate G4, a plurality of plates manufactured in advance in correspondence with the switching of the spatial filter 7H are in stock in a library 226, and suitable correction plates G3 and G4 among them are selected by an automatic exchange mechanism 227 in response to the command from the main control system 32, and mounted in the bottom of the projection optical system PL.

Also for the telecentric correction plate 7N, an automatic exchange mechanism 228 for exchanging for a telecentric correction plate which is polished beforehand according to an illumination condition (spatial filter 7H) in response to the command from the main control system 32 is arranged. However, only if average telecentric error in the whole of illumination light beam is equally corrected, the automatic exchange mechanism 228 may be configured merely by an actuator which adjusts a tilt of the telecentric correction plate 7N to be two-dimensional.

With the above described configuration, the respective fluctuations of the optical characteristic of illumination light beam and the imaging characteristic of the projection optical system PL, which occur with an illumination condition change, can be optimally corrected in response to the command from the main control system 32, and a pattern image on the reticle R can be projected and transferred onto the wafer W in a state where few aberrations (such as a distortion error including an isotropic magnification error, an image plane curvature error, an astigmatism/coma error, a telecentric error, or the like) exist.

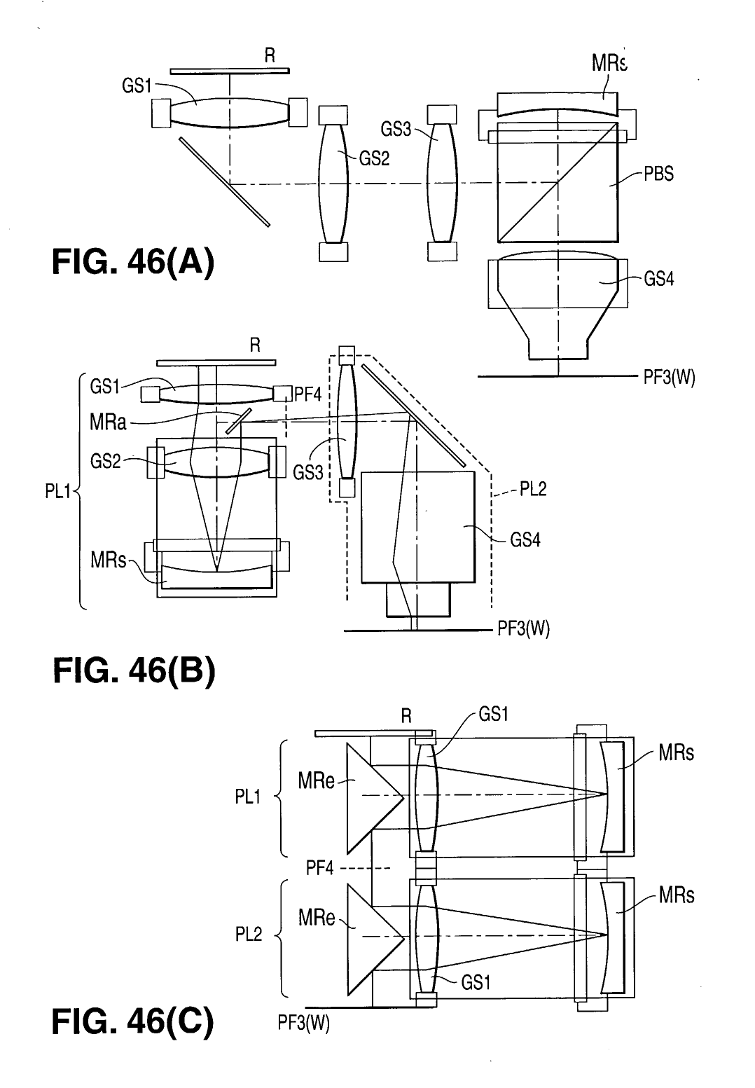

The projection optical system PL exemplified in the above described embodiments is a reduction projection lens configured only by a dioptric element (lens) which uses quartz or fluorite as an optical glass material. However, the invention can also be applied to other types of a projection optical system in exactly the same manner. Accordingly the other types of a projection optical system will be briefly explained by referring to FIG. 46.

FIG. 46(A) is a reduction projection optical system where dioptric elements (lens systems) GS1 through GS4, a concave mirror MRs, and a beam splitter PBS are combined. The characteristic of this system is a point that the image light beam from the reticle R is reflected by the concave mirror MRs via the large beam splitter PBS, and again returned to the beam splitter PBS, and imaged on the projection image plane PF3 (wafer W) with a reduction ratio earned at the dioptric lens system GS4. Its details are disclosed by Japanese Laid-Open Patent Application 3-282527 (U.S. Pat. No. 5,220,454).

FIG. 46(B) is a reduction projection optical system where dioptric elements (lens systems) GS1 through GS4, a small mirror MRa, and a concave mirror MRs are combined. The characteristic of this system is a point that the image light beam from the reticle R is imaged on the projection image plane PF3 (wafer W) through a first imaging formation system PL1 which is almost an equal magnification and composed of lens systems GS1 and GS2 and a concave mirror MRs, and a second imaging formation system PL2 which is composed of lens systems GS3 and GS4 and has almost a desired reduction ratio. Its details are disclosed by Japanese Laid-Open Patent Application 8-304705 (U.S. Pat. No. 5,691,802).

FIG. 46(C) is an equal magnification projection optical system where a dioptric element (lens system) GS1 and a concave mirror MRs are combined. The characteristic of this system is a point that the image light beam from the reticle R is imaged on the projection image plane PF3 (and wafer W) as an equal magnification erecting image through first second Dyson imaging systems PL1 and PL2, which are respectively configured by a prism reflection mirror MRe, the lens system GS1, and the concave mirror MRs, Its details are disclosed by Japanese Laid-Open Patent Application 7-57986 (U.S. Pat. No. 5,729,331).

Also to the exposure apparatus comprising each of the projection optical systems shown in FIGS. 46(A), (B) and (C), the above-described image distortion correction plate G1, astigmatism/coma correction plate G3, and image plane curvature correction plate G4 can be attached in a similar manner. Since an intermediate image forming plane PF4 which is almost an equal magnification of a pattern within an illumination area on the reticle R is formed especially in the projection optical system of FIGS. 46(B) and (C), at least one of the image distortion correction plate G1, the astigmatism/coma correction plate G3, and the image plane curvature correction plate G4 can be arranged in the neighborhood of the intermediate image plane PF4.

Additionally, the projection optical systems shown in FIGS. 46(A), (B) and (C) are systems which can be sufficiently applied to an ultraviolet light having a central wavelength of 200 nm or less such as an ArF excimer laser beam, or the like by selecting an optical glass material, a surface-coated material, or the like to be used. Even when such a projection optical system is used, a significant effect such that a distortion of a pattern image which is eventually transferred onto a photosensitive substrate, an absolute projection position error, or a local overlapping error can be suppressed to approximately one-tenth (approximately several tens of nm) or less of the minimum line width of the pattern image to be transferred by carrying out the sequence of: (1) the measurement of dynamic optical characteristics (a distortion, an astigmatism/coma aberration, an illumination NA difference, or the like) under a set illumination condition; (2) the process of each correction plate based on the result of the above described measurement; and (3) the mounting and the adjustment (including re-measurement) of each manufactured correction plate, can be obtained.

In the meantime, the projection optical systems shown in FIGS. 2 and 46(A) among the projection optical systems shown in FIGS. 2 and 46 possess a circular projection view field, while the projection optical systems shown in FIGS. 46(B) and (C) possess almost a semicircle projection view field. An effective projection area EIA which is restricted to a rectangular slit shape within a projection view field is to be used for scan-exposure whichever projection optical system is used. However, a slit projection area in an arc may be set depending on a case.

In such a case, the shape of the intensity distribution of the illumination light which illuminates the reticle R (TR) may be merely modified to be an arc-shaped slit. However, considering that the illumination light is a pulse light, it is not advantageous to make the width of the scanning direction of the arc-shaped slit as thin as disclosed by pp. 424-433 in Vol. 1088 of the above described SPIE published in 1989, which is cited earlier in the explanation of the conventional technique, and some width is required.

Assume that a width Dap of an arc-shaped slit in the scanning direction on a wafer is 1 mm, the number Nm (integer) of pulse lights to be oscillated while the wafer is moving by that width during the scanning is 20 pulses, and the maximum frequency fp of the pulse oscillation of an illumination light is 2000 Hz (conforming to the standard of a laser light source). The moving speed Vws of the wafer while one shot area on the wafer is being scanned and exposed becomes 100 mm/sec based on the relationship Vws=Dap/(Nm/fp), which proves that a throughput is improved with the widening of the slit width Dap.

Accordingly, even if an illumination light is set to have an arc-shaped slit, a width, for example, of approximately 3 to 8 millimeters, which is wider than a conventional method, must be adopted on a wafer. However, it is desirable not to make the inside are of the illumination light having the arc-shaped slit and its outside arc concentric, but to form the slit into a crescent shape such that the width of scan-exposure of the arc-shaped slit is the same at any position in the non-scanning direction of the arc-shaped slit.

The way of thinking of the respective optical aberration corrections by the image distortion correction plate G1, the astigmatism/coma correction plate G3, the image plane curvature correction plate G4, the telecentric correction plate 7N, and the illumination NA correction plate 7F, which is explained in the embodiments of the invention, is applicable also to an X-ray exposure apparatus, having a wavelength of 50 nm or less, which comprises a reduction projection system configured only by catoptric elements (a concave mirror, a convex mirror, a toroidal reflection mirror, a plane mirror, or the like) in addition to the projection optical system configured by a catadrioptric system (a system where a dioptric element and a catoptric element are combined) shown in FIG. 46.

Because there is no optical material having a satisfactory dioptric operation for an ultra-high-frequency illumination light (so-called vacuum ultraviolet light), corrections of the distortion characteristic, the astigmatism/coma aberration characteristic, the telecentric characteristic, and the like can be implemented by locally and infinitesimally transforming the plane shape of the reflection surface of a catoptric element. As the method for performing an infinitesimal transformation, for example, the method for polishing a reflection layer, which is piled up relatively thick, on the surface of the material (low-expansion glass, quartz, fine ceramics, or the like), which becomes a base material of a reflection mirror arranged at a position close to the object surface or the image plane within a projection optical path, the method for intentionally performing an infinitesimal transformation for the shape of a reflection plane in a controllable range by applying a local stress to a base material from the rear or the side of the reflection plane of a reflection mirror, the method for infinitesimally transforming the shape of a reflection plane with thermal expansion by installing a temperature adjuster (a Peltier element, a heat pipe, or the like) on the rear of a reflection mirror, or the like, are considered.

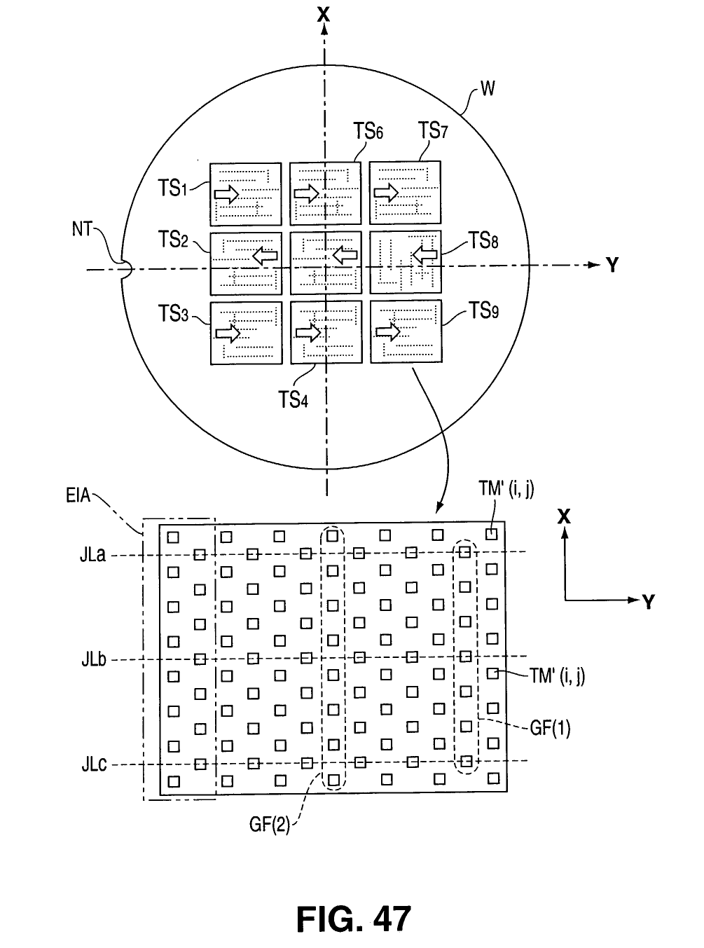

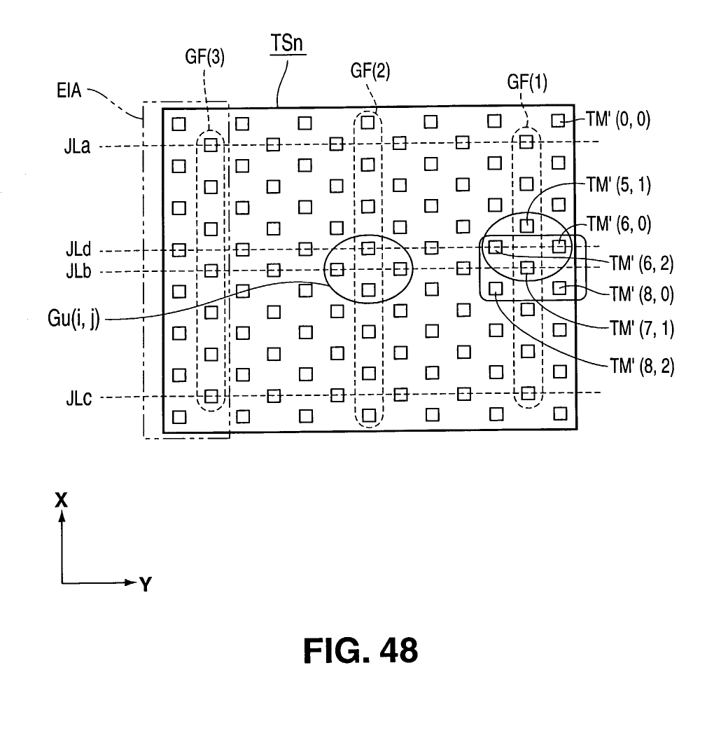

Meanwhile, when the image distortion correction plate G1 is manufactured, when the telecentric correction plate 7N is manufactured, or when the astigmatism/coma aberration correction plate G3 is manufactured, the dynamic distortion characteristic, the dynamic telecentric error characteristic, the dynamic astigmatism characteristic, or the like in consideration of the averaging at the time of scan-exposure must be obtained by measurements. However, such types of dynamic aberration characteristics can be obtained also from the result of the test printing of a measurement mark pattern on the test reticle TR with a scan-exposure method. Therefore, the measurement method and sequence in that case will be explained below by referring to FIGS. 47 and 48.

As explained earlier, if a particular object point positioned on the object plane of the projection optical system PL is scanned and exposed and transferred on the wafer W by using the exposure apparatus shown in FIGS. 1 and 2, the image of the object point projected onto the wafer W is modulated by the static distortion characteristic at each position in the scanning direction within the effective projection area EIA of the projection optical system PLM, and is averaged, so that a dynamic distortion characteristic (dynamic image distortion error) is included at a stage of exposing on the wafer W.

Accordingly, if a measurement mark TM(I, j) on the test reticle TR shown in FIG. 31 is scan-exposed onto a test wafer, the respective projection images of each L&S pattern MX(i, j), MY(I, j) formed at the position of an ideal lattice point or its equivalent position on the test reticle TR becomes an image accompanying a dynamic image distortion vector (distortion error).

Therefore, as shown in FIG. 47, a resist layer is coated on a super flat wafer W having a notch NT, which is suitable for test printing is mounted on the table TP of the exposure apparatus shown in FIG. 2. Then, pattern areas on the test reticle TR (inside of the shading band LSB of FIG. 31) are sequentially transferred on the wafer W, for example, in 3×3 shot areas TS1 through TS9 with a step-and-scan method. At this time, the respective shot areas TS1 through TS9 shown in FIG. 47 are scanned in an order of TS1, TS2, . . . , TS9 alternately in the Y direction as indicated by the arrows in this figure.

As a result, each projection image TM′(i, j) of the test mark TM(i, j) arranged in a matrix state within the test reticle R is transferred in the respective shot areas TS1 to TS9 of the resist layer on the wafer W as a latent image, as expanded and shown in the lower portion of FIG. 47. Then, the wafer W is transmitted to a coater developer, and the resist layer is developed under the condition equal to that at the time of the manufacturing of an actual device.

The developed wafer W is set up within a dedicated examination measurement device, by which a position shift amount of each projection image TM′(i, j) formed by the concave/convex of the resist layer within the respective shot areas TS1 through TS9 from an ideal lattice point is measured. The projection image TM′(i, j) measured at that time may be any image of an L&S pattern MX(i, j), MY(i, j), a cross-shaped LAMPAS mark MLP, a vernier mark Mvn, or the like, as shown in the lower portion of FIG. 31, and an image suitable for the examination measurement device is used.

For the position shift measurement of each projection image TM′(i, j) from an ideal lattice point, an alignment detection system mounted in a projection exposure apparatus may be used. The wafer W after being developed is mounted, for example, within the projection exposure apparatus equipped with an LSA system, an FIA system, or an LIA system, which is disclosed by Japanese Laid-Open Patent Application 2-54103 (U.S. Pat. No. 4,962,318), and a pattern and a mark formed on the resist layer can be measured in a similar manner.

The position shift amount of each projection image TM′(i, j) from an ideal lattice point, which is obtained by the above-described measurement operation, becomes an amount that directly represents the dynamic image distortion vector VP(Xi) at each ideal lattice point. Then, if the image distortion vector VP(Xi) is measured, for example, for each of a pair GF(1) and GF(2) of projected images TM′(i, j) aligned in the non-scanning direction (X direction) in one shot area, the image distortion vectors in each pair GF(1) and GF(2) directly show the distortion characteristic, for example, as previously shown in FIG. 5(D).

However, for example, the respective image distortion vector VP(Xi) of a plurality of projection images TM(i, j), which exist, for example, respectively along lines JLa, JLb, and JLc extending in the scanning direction (Y direction), among projection images TM′(i, j) are calculatedly averaged for the respective lines JLa, Jlb, and JLc. This is because unevenness occurs due to the moving control precision of a reticle stage or a wafer stage at the time of scan-exposure, or a measurement error of a projection image TM′(i, j) even if the dynamic image distortion characteristic is determined with only one particular combination.

In this way, for example, the dynamic distortion characteristic at the position on the line JLb within the effective projection area EIA or in its neighborhood can be accurately obtained from the average value of the respective image distortion vector VP(xi) of the plurality of projection images TM′(i, j) on the line JLB. However, if the respective image distortion vector VP(Xi) of all the projection images TM′(i, j) which exist along the respective lines JLa, JLb, and JLc are averaged within a shot area TSn, the running errors (a relative rotation error of a scanning axis, a yawing error, or the like) of the reticle stage 8 and the wafer stage 14 at the time of scan-exposure are also averaged in the size of the scanning direction within the shot area TSn.

Therefore, as shown in FIG. 48, the dynamic image distortion vector VP(xi) is obtained for each of the upper-right combination GF(1), the middle combination GF(2), and the upper-left combination GF(3) in the scanning direction (Y direction) within the shot area TSn by an actual measurement, and the actually measured image distortion vector VP(Xi) from which the running errors of the stages 8 and 14 at each scanning position (position in the Y direction within the shot area) are subtracted is defined to be a dynamic distortion characteristic.

Then, the distortion characteristics of the respective combinations GF(1), GF(2), and GF(3) from which the running errors are subtracted are averaged. It is easy to calculatedly obtain the running errors of the stages 8 and 14 afterwards, if the measurement value (X, Y, θ) by the interferometers 46, 62 and the like at the time of scan-exposure is stored in real time in a neighborhood range of the scanning position of each of the combinations GF(1), GF(2), and GF(3).

Additionally, if the dynamic image distortion vector VP(Xi) at an arbitrary position in the X direction is determined in each of the combinations GF(1), GF(2), and GF(3), averaging may be made by using the result of an actual measurement of the image distortion vector VP(Xi) of a projection image TM′(i, j) positioned in the periphery of that position. For example, as shown in FIG. 48, if the image distortion vector on the line JLb in the combination GF(1) is determined based on the assumption that the upper right corner of the projection image TM′(i, j) is TM′(0, 0), the actual values of the image distortion vector VP(Xi) of the projection image TM′(7, 1) which exists in that position and the projection image TM′(6, 0), TM′(6, 2), TM′(8, 0), and TM′(8, 2) which are positioned in the periphery of that position, are averaged.

In the same manner, when the image distortion vector on the line JLd (position adjacent to the line JLb) within combination GF(1) is determined, the measurement value of the image distortion vector VP(Xi) in the respective projection images TM′(5, 1), TM′(6, 0), TM′(6, 2), and TM′(7, 1) positioned in the vicinity of the position can be averaged.

If the image distortion vector on the line JLb in the combination GF(2) is determined, the actual measurement values of the image distortion vector VP(Xi) of four projection images TM′(i, j) existing in an ellipse GU(i, j) with that position as a center are averaged.

Furthermore, in the above-mentioned case, a plurality of shot areas TSn are formed on the wafer W. Therefore, there is an advantage that a random measurement error can be reduced by adding and averaging the dynamic image distortion (after a running error is corrected) at the same position in the other shot areas.

As described above, in the above-mentioned case, a dynamic distortion characteristic is determined based on the result of actual test printing with a scan-exposure method. This method is also applicable to the case where various imaging formations, such as a dynamic telecentric error characteristic, a dynamic astigmatism/coma characteristic, or the like, are measured in exactly the same manner. Additionally, in the above-described case, a device for examining and measuring mark projection images TM′(i, j) at a plurality of positions on a test-printed wafer, or an alignment system of a projection exposure apparatus is required. However, since the position of a mark projection image is actually formed on a resist layer, the resolution state of a projection image, the difference due to the directionality of an L&S pattern image, and the like are actually measured, measurements based on the actual optical characteristics of the illumination optical system and the projection optical system PL of the projection exposure apparatus can be made.

Thus, optical correction members (G1, G3, G4, or the like) to be inserted in the projection optical path between the mask (reticle R) and the substrate to be exposed (wafer W) are locally polished by using the dynamic aberration information which is added and averaged in a unique direction with respect to the scanning exposure method, thereby obtaining an effect of allowing the surface shapes and the areas of the optical correction members to be polished with high precision. Furthermore, since the surface shape to be polished can also be extremely moderately set, a significant effect of improving the polishing processing accuracy can be obtained. As a result, it is possible to obtain the extremely high aberration correction accuracy during exposure.

Additionally, this can also be applied to the aberrations other than the distortion characteristic among the various aberration characteristics which become problems in the case of the projection exposure method, for example, an astigmatism/coma characteristic, image plane curvature, or a telecentric error. In general, the astigmatism aberration occurring in the case of the static exposure method can be corrected by infinitesimally tilting the parallel flat plate (quartz or the like) inserted between the lens component which is closest to the image side in the projection optical system and the substrate to be exposed with respect to the plane vertical to the projection optical axis.

However, in the case of the scan-exposure method, the area contributing to the exposure within the projection view field is a rectangular slit shape or an arc-slit shape. Furthermore, considering that this becomes a dynamic astigmatism characteristic which is added and averaged in the scanning direction, the dynamic astigmatism aberration may increase in the center portion of the slit-shaped projection area, or non-linear (or random) astigmatism may occur in some cases. Accordingly, it is possible to make an astigmatism correction with high precision by locally adjusting the surface of the astigmatism/coma correction plate arranged in the neighborhood of the image plane in the projection optical path by using the method of this invention, whereby a significant effect of removing these aberrations can be obtained.

Furthermore, the image plane curvature among the respective optical aberrations can be corrected by replacing the lens component having a long radius of curvature, which is arranged between the projection optical system and the substrate to be exposed, with a lens component of the same diameter having a slightly different radius of curvature, in the case of the static exposure method. However, in the case of the scan-exposure method, since the static image plane curvature characteristic is added and averaged in the scanning direction, a non-linear (random) image plane curvature error, which cannot be modified only by correcting the image plane tilt and the image plane curvature with replacement of lens components in the static exposure method, can possibly remain.

According to the above-described embodiment as well, if the above-mentioned method is used, an image plane curvature correction plate which can correct a non-linear (random) image plane curvature error with high accuracy, can be created. Therefore, a significant effect can be expected in which the projection image plane by the projection optical system can be made into a flat plane which is entirely or locally even, and a DOF (Depth of Focus) can be significantly improved.

The technology for correcting various aberration characteristics and technology for manufacturing correction plates in the above-described embodiment is essential especially when a circuit pattern image having a minimum line width of 0.08 to 0.2 μm or so is projected and exposed onto the substrate to be exposed to which a flattening technology is applied through a high-NA projection optical system with the image side numerical aperture of 0.65 or more. However, since the various static aberrations within the projection area are averaged in the scanning direction in the scan exposure method explained in this embodiment, the aberration (image quality) occurring in the image transferred onto the exposed substrate can possibly deteriorate in comparison with the portions within the projection area, where various static aberrations are minimized.

Accordingly, the averaging in the state where image deterioration occurs must not be performed. Therefore, the correction using a reduction is made by infinitesimally moving the lens components and optical members so as to minimize the respective aberrations as little as possible when the projection optical system itself is assembled or adjusted. Furthermore, the positions of the lens components or the optical members within the lens barrel are infinitesimally adjusted or the like in the state where the lens barrel of the projection optical system is installed in the body of the apparatus, and all possible efforts must be made to remove a liner aberration (an aberration characteristic which is able to be approximated by function) from a calculation value.

Then, if various optical correction members are processed to correct an aberration for the non-linear error (random component) which remains after the linear aberration is removed, the linear and the random aberration components can be suppressed almost to “0”. As a result, when a plurality of projection exposure apparatuses are used together for overlay exposure in semiconductor device production line, the accuracy of distortion-match and mix-and-match can be maintained within the rage of several to ten-several nm, and, therefore, remarkable effects can be obtained that the yield ratio for semiconductor-device manufacturing can be improved.

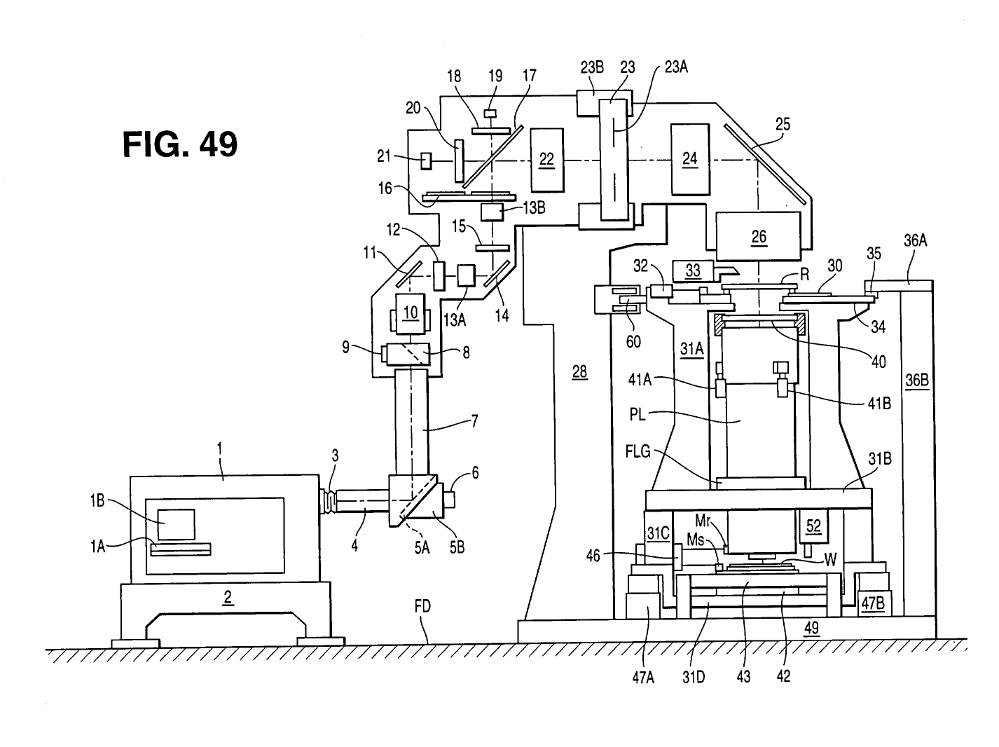

Then, a specific construction of an exposure apparatus using an ArF excimer laser light source, having a projection optical path filled with inert gas and suitable for the manufacturing method of the exposure apparatus according to the invention is described with reference to FIG. 49.

Although reference symbols attached to each structural element in FIG. 49 are overlapped with those in FIGS. 1 and 2, each structural element in FIG. 49 is different from each structural element in FIGS. 1 and 2 even if the same symbols are attached. In the following description, symbols used in FIG. 49 are to be valid only for each structural element regarding FIG. 49.

FIG. 49 is a diagram showing the configuration of a step-and-scan type projection exposure apparatus, having an ArF excimer laser light source 1 narrowed within the range of wavelength from 192 to 194 nm avoiding oxygen absorption band, projecting a circuit pattern on a reticle R onto a semiconductor wafer W through a projection optical system PL, and, at a time, scanning the reticle R and the wafer W relatively. In FIG. 49, a main body of the ArF excimer laser light source 1 is arranged on a floor FD in a clean room (or outside a clean room according to circumstances of a semiconductor manufacturing factory) through a vibration control table 2. A light source control system 1A including an input unit such as a keyboard and a touch panel, or the like and a display 1B are attached to the main body of the laser light source 1, which automatically performs oscillation central wavelength control of the pulse light emitted from the laser light source 1, a trigger control of pulse oscillation, and gas control in the laser chamber.

Narrow-banded ultraviolet pulse light emitted from the ArF excimer laser light source 1 is passed through a shading bellows 3 and a tube 4, reflected on a movable mirror 5A in beam matching unit (BMU) positionally matching light paths into the exposure apparatus, passed through a shading tube 7, and reached to a beam splitter 8 for detecting light amount, at this point, most of the light amount is passed through and only a small portion (for example, approximately 1%) of light is reflected to a light amount detector 9.

The ultraviolet pulse light passed through the beam splitter 8 is adjusted its beam cross-sectional shape and incident to a variable beam attenuating system 10 which adjusts the light intensity of the ultraviolet pulse light. The variable beam attenuating system 10 including a driving motor adjusts, stepwise or continuously, an attenuation ratio of the ultraviolet pulse light in accordance with an instruction from a main control system, which is not shown in FIG. 49.

Furthermore, the movable mirror 5A is two-dimensionally adjusted its reflection direction by an actuator 5B. The actuator 5B is controlled in feed back or feed forward manner based on a signal from a detector 6 for light-receiving a position monitoring beam emitted coaxially with the ultraviolet pulse light from a visible laser light source (semiconductor laser, He-Ne laser, or the like) contained in the laser light source 1.

Therefore, the movable mirror 5A is made to have high transmittance for the wavelength of the position-monitoring beam and high reflectance for the wavelength of the ultraviolet pulse light. The detector 6 is constructed with a quadrant sensor, a CCD imaging device, or the like, which photoelectrically detects changes of the light-receiving position of the position-monitoring beam passed through the movable mirror 5A. Furthermore, driving the actuator 5b for tilting the movable mirror 5A can be performed in response to a signal from a position sensor or an acceleration sensor independently detecting vibration of the floor FD on which the exposure apparatus is placed, instead of a signal from the detector 6.

Meanwhile, the ultraviolet pulse light passed through the variable beam attenuating system 10 irradiates the reticle R via a fixed mirror 11 arranged a predetermined optical axis AX, a collective lens 12, a first fly eye lens 13A as an optical integrator, a vibration mirror 14 for reducing coherence, a collective lens 15, a second fly eye lens 13B, an interchangeable spatial filter 16 for changing distribution of the light source image, a beam splitter 17, a first imaging lens system 22, a reticle blind mechanism 23 including an illumination view field aperture 23A for shaping illumination area on the reticle R into a rectangular slit shape, a second imaging lens system 24, a reflection mirror 25 and a main condenser system 26.

Furthermore, the approximately several percent of ultraviolet pulse light or less which was emitted from the spatial filter 16 and went through the beam splitter 17 is received by a photo-electric detector 19 via an optical system 18 including a collective lens and a diffusing plate. In this case, an exposing condition for scan-exposure is basically determined by calculating a photoelectric detecting signal from the photoelectric detector 19 by a processing circuit for controlling an exposure amount.

Further, a collective lens system 20 and a photo-electric detector 21 arranged to the left side of the beam splitter 17 in FIG. 49 are for photo-electrically detecting the reflection light from the exposure illumination light irradiated on the wafer W through the projection optical system PL and the main condenser lens 26 as a light amount, and a reflectance of the wafer W is detected based on the photo-electric signal.

In the configuration described above, an incident surface of the first fly eye lens 13A, an incident surface of the second fly eye lens 13B, a surface of an aperture 23A of the reticle blind mechanism 23, and a pattern surface of the reticle R are made to be optically conjugated with each other. A light source plane formed to the exit side of the first fly eye lens 13A, a light source plane formed to the exit surface side of the second fly eye lens 13B, a Fourier transform plane (exit pupil plane) of the projection optical system PL are made to be optically conjugated with each other, and are forming a Koehler illumination system. Accordingly, the ultraviolet pulse light is transformed into uniform-intensity-distribution illumination light on the surface of the view field diaphragm aperture 23A within the reticle blind mechanism 23 and on the pattern surface of the reticle R.

The view field diaphragm aperture 23A of the reticle blind mechanism 23 is arranged in a linear slit shape or rectangular shape extended to the direction perpendicular to a scanning exposure direction in the center of the circular view field of the projection optical system PL as disclosed, in the present case for example, in Japanese Laid-Open Patent Application 4-196513 (U.S. Pat. No. 5,473,410). Furthermore, a movable blind for adjusting the scanning exposure direction width of illumination view field area on the reticle R by the view field diaphragm aperture 23A is arranged in the reticle blind mechanism 23. The movable blind reduces a stroke of the reticle R for scanning, and reduces the width of the shading band on the reticle R as disclosed in Japanese Laid-Open Patent Application 4-196513 (U.S. Pat. No. 5,473,410).

As described above, the ultraviolet pulse illumination light uniformly distributed on the illumination field diaphragm aperture 23A of the reticle blind mechanism 23 is incident in the main condenser lens system 26 via the imaging lens system 24 and the reflection mirror 25, and uniformly irradiates a portion of the circuit pattern area on the reticle R becoming a similar shape to the slit or rectangular shape of the aperture 23A.

Meanwhile, the illumination optical system from the beam splitter 8 to the main condenser lens system 26 shown in FIG. 49 is stored in an illumination system housing (not shown) keeping airtight relative to outside air. The illumination housing is fixed on a support column 28 stood on a portion of a surface plate 49 for placing the main body of the exposure apparatus on the floor FD. Further, clean dry nitrogen gas or helium gas containing several percent of air (oxygen) density or less, preferably less than one percent, is filled in the illumination system housing.

In the meantime, the reticle R is absorbed and fixed on a reticle stage 30, at the time of scan-exposure, the position of the stage 30 is moved linearly with a predetermined speed Vr to the left and right direction (Y direction) of FIG. 49 by a driving unit 34 including a linear motor or the like, being measured by a laser interferometer 32 in real time. Further, the laser interferometer 32 measures positional variation in the reticle stage 30 in scan direction (Y direction) as well as positional variation and rotational variation in non-scan direction (X direction) in real time. A driving motor (linear motor, voice coil motor, or the like) in the driving unit 34 drives the stage 30 in order to maintain those positional variation and rotational variation measured at the time of scan-exposure in a predetermined state.

The reticle stage 30, the laser interferometer 32 and the driving unit 34 are fixed on the upper portion of a support column 31A of the main body of the exposure apparatus. An actuator 35 is arranged on the upper-most portion of the support column 31A, where the driving unit 34 (stationary part of the linear motor) is fixed, in order to absorb reaction force produced in the scan direction while accelerating or decelerating the reticle stage 30 at a time of scan movement. The stationary part of the actuator 35 is fixed on a support column 36B stood on a portion of the surface plate 49 via a fixing member 36A.

When the reticle R is illuminated by the ultraviolet pulse illumination light, the transmitted light through the illuminated portion of the circuit pattern on the reticle R is incident to the projection optical system PL, and the partial image of the circuit pattern is imaged limited to the slit or rectangular shape (polygonal shape) in the center of the circular view field of the image surface side of the projection optical system PL whenever each pulse of the ultraviolet pulse illumination light irradiates. Then, the partial image of the projected circuit pattern which was projected is transferred to a resist layer of the surface of one shot area among a plurality of the shot areas on the wafer W arranged on the image plane of the projection optical system PL.

On the reticle R side of the projection optical system PL, an image distortion correction plate (a quartz plate) 40 is mounted to reduce dynamic aberration distortion, especially random distortion characteristic, produced at the time of scan exposure. With respect to the correction plate 40, its surface is locally polished by a wavelength order, and the principal ray of partial imaging light beams in the projection image field is infinitesimally deflected.

Further, in the projection optical system PL, actuators 41A and 41B are arranged for automatically adjusting the imaging characteristic (projection magnification or a kind of distortion) by parallel-moving an internal particular lens component along the optical axis or tilting by small amount based on the detection result of a distortion state of the shot area on the wafer W to be exposed, the detection result of temperature variation in the medium (optical elements and gas to be filled) in the projection optical path, and the detection result of inner pressure variation in the projection optical system PL in accordance with the change in atmospheric pressure.

Meanwhile, the projection optical system PL, in this case, consists of only refractive optical elements (quartz lens and fluorite lens), and is made to be a telecentric system both object side (reticle R) and image side (wafer W).

In the meantime, the wafer W is absorbed and fixed on a wafer stage 42 two-dimensionally moving along an X-Y plane parallel to the image plane of the projection optical system PL. The position of the stage 42 relative to a reference mirror Mr, as a standard, fixed to lower end of the lens barrel of the projection optical system PL is measured in real time by a laser interferometer 46 measuring positional variation in a moving mirror Ms fixed on a potion of the wafer stage 42. Based on the measured result, the wafer stage 42 is two-dimensionally moved on a stage base plate 31D by a driving unit 43 including a plurality of linear motors.

A stationary part of a linear motor composing the driving unit 43 is fixed on the surface plate 49 via a support frame independent from the base plate 31D, and directly transmits reaction force produced while accelerating or decelerating the wafer stage 42 at a time of scan movement to the floor FD, not to the base plate 31D. As a result, the reaction force produced by movement of the wafer stage 42 at a time of scanning exposure is not applied to the main body of the exposure apparatus at all, and the vibration and stress produced in the main body of the exposure apparatus are greatly suppressed.

Further, the wafer stage 42 is moved with constant velocity Vw in the left and right direction (Y direction) in FIG. 49 at a time of scan exposure, and is step-moved in X and Y directions. The laser interferometer 46 measures positional variation in the wafer stage 42 in Y direction as well as positional variation and rotational variation in X direction in real time. A driving motor (linear motor or the like) in the driving unit 34 servo-controls the stage 42 in order for those positional variations to be measured at a time of scan exposure to become a predetermined state.

Additionally, the information of the rotational variation of the wafer stage 42 measured by the laser interferometer 46 is transmitted to the driving unit 34 of the reticle stage 30 via the main control system in real time, and the error of the rotational variation on the wafer side is controlled so as to be compensated by rotational control on the reticle side.

Meanwhile, four corners of the stage base plate 31D are supported on the surface plate 49 via vibration control tables 47A, 47B (47C and 47D are not shown in FIG. 49) including active actuators. A support column 31C is stood on each vibration control table 47A, 47B (47C, 47D), and a column 31B fixing a flange FLG fixed on the outer surface of the lens barrel of the projection optical system PL is arranged on those columns. Further, the support column 31A is fixed on the column 31B.

In the configuration described above, the vibration control tables 47A, 47B, (47C and 47D) move the Z direction position of the stage base plate 31D and the support column 31C independently by feedback and feed-forward control in order to constantly stabilize a position of the main body even if the position of the main body changes in the center of gravity accompanied with the movement of the reticle stage 30 and the wafer stage 42 in response to a signal from a position detecting sensor which monitors positional variation in the main body of the exposure apparatus relative to the floor FD.

In the meantime, each driving unit, actuator, or the like, which is not shown in FIG. 49, is controlled collectively by the main control system. Under the main control system, there are intermediary unit controllers specifically controlling each driving unit or actuator. Regarding such typical unit controller, there is a reticle side control device which manages various information of the reticle stage 30 such as moving position, moving velocity, moving acceleration, positional offset, and the like, and a wafer side control device which manages various information of the wafer stage 42 such as moving position, moving velocity, moving acceleration, positional offset, and the like.

Additionally, the main control system synchronizes and controls specially at a time of scan exposure, the reticle control device and the wafer side control device in order to maintain the speed ratio of moving speed Vr of reticle stage 30 in a Y direction to the moving speed Vw of the wafer stage 42 in X direction in accordance with the projection magnification (⅕ times or ¼ times) of the projection optical system PL.

Furthermore, the main control system gives instructions to control movement of each blade of movable blind arranged in the reticle blind mechanism 23 described above in synchronization with the movement of the reticle stage 30 at a time of scan-exposure. Further, the main control system sets various exposure conditions for scan-exposing the shot area on the wafer W with proper exposure amount (target exposure amount), and, at the same time, performs optimum exposure sequence in cooperation with an exposure control device controlling the light source control system 1A of the excimer laser light source 1 and the variable beam attenuating system 10.

In the configuration other than described above, a reticle alignment system 33 performing alignment of an initial position of the reticle R is arranged outside of the illumination light path between the reticle R and the main condenser lens system 26, photoelectrically detecting a mark formed outside a circuit pattern area surrounded by shading bands on the reticle R. Furthermore, an off axis type wafer alignment system 52 photoelectrically electronically detecting an alignment mark formed for each shot area on the wafer W is arranged under the column 31B.

Further, a non-contact actuator 60 for maintaining positional stability of an optical axis of the illumination optical system (an optical axis of the main condenser lens system 26) relative to an optical axis of the projection optical system PL is arranged between the support column 28 supporting the illumination system and housing the column 31A being a portion of the main body of the exposure apparatus. The actuator 60 is composed of such as, for example, a voice coil producing Lorentz force, an E core type electromagnet producing thrust by magnetic repulsion and attraction force, and the like, and is driven such that a signal from a sensor detecting variation in the distance between the support column 28 and the column 31A becomes constant value.

The entire spaces (a plurality of space between lens components) inside of the lens barrel of the projection optical system PL shown in FIG. 49 is filled with inert gas (dry nitrogen gas, helium gas, or the like) whose oxygen content is made as small as possible in the same manner as the illumination system housing, and the inert gas is supplied to the lens barrel with an amount of flowing filling up a small amount of leakage. Meantime, when air tightness of the lens barrel or the illumination system housing is high, it is not necessary to supply inert gas frequently after completely changing atmospheric air with inert gas.

However, in consideration with variation in transmittance caused by adsorbing water molecule or hydrocarbon molecule produced from various kind of materials (glass, coating materials, adhesive agent, paint, metal, ceramics, or the like) within the optical path, it is necessary to remove impure molecules by arranging chemical filter or static filter on inner surface of the lens barrel surrounding the optical path with forcibly flowing temperature controlled inert gas in the optical path.

Although the projection optical system PL is a dioptric system composed of refractive optical elements in the whole configuration in FIG. 49, it is possible to be catadioptric system combined refractive optical element and concave mirror (or convex mirror). It is desirable in either system to be a telecentric system to both object side and image side of the projection optical system PL.

Further, the pulse light emission control method using an excimer laser light source for scan type projection exposure is disclosed, for example, in Japanese Laid-Open Patent Application 6-132195 (U.S. Pat. No. 5,477,304), Japanese Laid-Open Patent Application 7-142354 (U.S. Pat. No. 5,534,970), or Japanese Laid-Open Patent Application 2-229423 (U.S. Pat. No. 4,924,257). It is possible to use the technology disclosed in those applications as-is, or with some modifications, if necessary. Furthermore, the method for controlling an exposure amount adjusting pulse illumination light energy from the excimer laser light source 1 by the variable beam attenuating system 10 or infinitesimally adjusting oscillation intensity itself (peak value) of the excimer laser light source 1 is disclosed, for example, in Japanese Laid-Open Patent Application 2-135723 (U.S. Pat. No. 5,191,374). For this case as well, it is possible to use the technology disclosed in the application just as it is, or with some modifications, if necessary.

Further, as shown in FIG. 49 where the first fly eye lens 13A and the second fly eye lens 13B are arranged in the illumination optical system, an illumination system that two fly eye lenses (optical integrators) are arranged tandem is disclosed, for example, in Japanese Laid-Open Patent Application 1-235289 (U.S. Pat. No. 5,307,207), and is applied to this embodiment in the same manner.

Regarding the reticle stage 30 shown in FIG. 49, a method can be applied, which is disclosed in Japanese Laid-Open Patent Application 8-63231 using a configuration for canceling the reaction force produced by acceleration or deceleration at a time of scan exposure based on momentum conservation. Regarding the wafer stage 42, a method can be applied, which is disclosed in Japanese Laid-Open Patent Application 8-233964 (U.S. Pat. No. 5,623,853) using a configuration that a stationary part of a linear motor is arranged in a following movable stage in order to reduce the weight of the movable stage moving two-dimensionally.

Meanwhile, in the explanation of the embodiment described above, since the projection exposure apparatus shown in FIG. 1 is a scan exposure type, a method disclosed in Japanese Laid-Open Patent Application 11-45842 (PCT Publication No. WO 99/05709) is applied when a correction surface shape of the correction plate G1 is determined. However, it is possible to apply a method (hereinafter called “the second method”) disclosed in Japanese Laid-Open Patent Application 8-203805 (U.S. patent application Ser. No. 08/581016, filed on Jan. 3, 1996: European Laid-Open Patent Application EP 0724 199A1) applicable to both a projection optical system of collective exposure type and that of scan exposure type. The second method applicable to the present embodiment is described below.

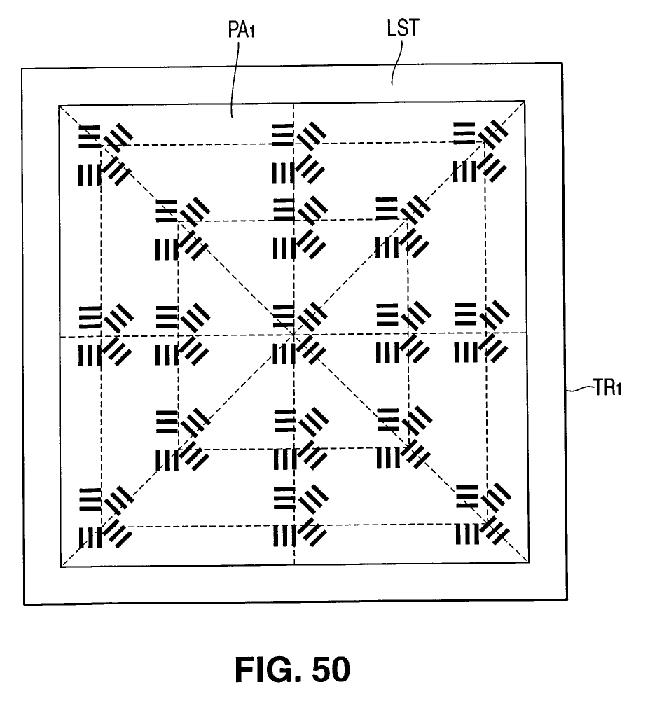

In this second method as well, of the various aberrations of the projection optical system PL, symmetrical components are corrected prior to correction of the random component of the distortion. First, a test reticle TR1 formed with a predetermined pattern is placed on the reticle stage. As shown in, for example, FIG. 50, the test reticle TR1 has a pattern area PA1 provided with a plurality of marks and a light-shielding band LST surrounding the pattern area PA1. The test reticle TR1 is subjected to Koehler illumination with the exposure light emerging from the illumination optical unit. Light emerging from the illuminated test reticle TR1 reaches the wafer W coated with a photosensitive material, for example, a resist, through the distortion correction plate (correspond to image distortion correction plate) 10 and the projection optical system PL, and forms a pattern image of the test reticle TR1 on the wafer W.

After that, the developing process of the wafer W is performed, and the resist pattern image obtained by this development is measured by a coordinate measuring machine. After this, the interval between the optical members which structure the projection optical interval system PL and the tilt shift of the optical members are adjusted based on the information on the measured resist pattern image, and the various aberrations other than the random component of the distortion are corrected.

Additionally, although reference symbol 10 attached to the distortion correction plate is overlapped with the reticle base surface plate in FIG. 1 and the variable beam attenuating system in FIG. 49, the distortion correction plate 10 in FIG. 50, the reticle base surface plate 10 in FIG. 1, and the variable beam attenuating system 10 in FIG. 49 are different elements with each other. Reference symbols used in following FIGS. 50 to 59 are valid only for each element regarding FIGS. 50 to 59.

After the correcting operation of the various aberrations other than the random component of the distortion, the random component of the distortion is corrected.

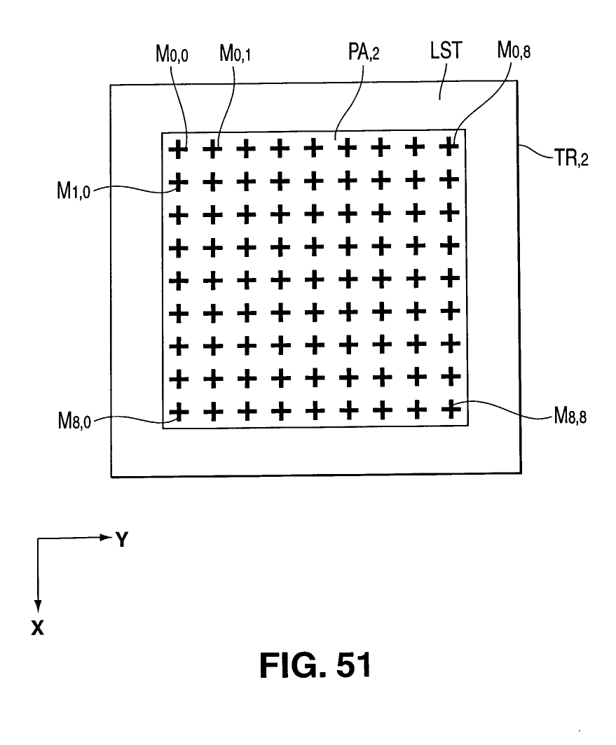

First, a test reticle TR2 as shown in FIG. 51 is placed on the reticle stage instead of the test reticle TR1 used for above correction. The test reticle TR2 has a plurality of cross marks M0,0 to M8,8 arranged in a matrix form, i.e., arranged on the lattice points of square lattices, within a pattern area PA2 surrounded by a light-shielding band LST that shields exposure light. The cross marks M0,0 to M8,8 of the test reticle TR2 may be formed on the pattern area PA1 of the test reticle TR1. In other words, both the test reticles TR1 and TR2 may be employed simultaneously.

Next, the test reticle TR2 on the reticle stage is illuminated with the exposure light of the illumination optical unit. Light from the test reticle TR2 reaches the exposure area on the wafer W whose surface is coated with the photosensitive material, for example, the resist, through the distortion correction plate 10 and the projection optical system PL, and forms the images (latent images) of the plurality of cross marks M0,0 to M8,8 of the test reticle TR2 on the wafer W. After that, developing process of the exposed wafer W is performed, and the plurality of exposed cross marks M0,0 to M8,8 are patterned.

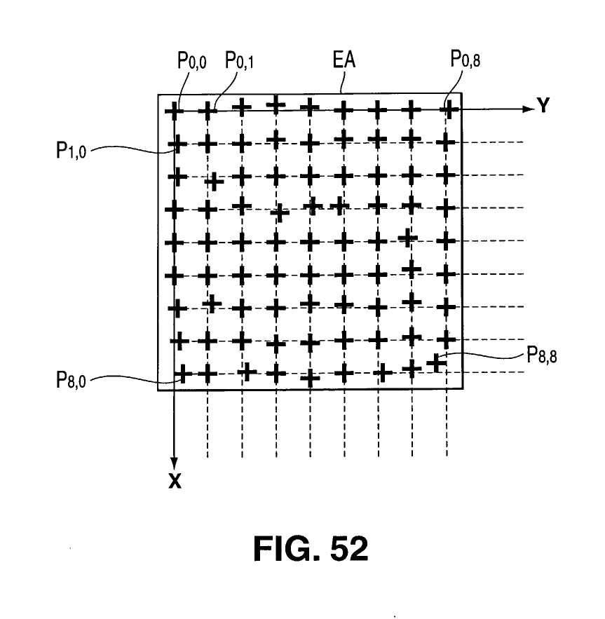

FIG. 52 shows the plurality of patterned cross marks in an exposure area EA on the wafer W. In FIG. 52, ideal imaging positions where images are formed when the projection optical system is an ideal optical system (an optical system having no aberrations) are expressed by intersection positions of broken lines. In FIG. 52, a cross mark pattern P0,0 corresponds to the image of the cross mark M0,0 on the reticle R, a cross mark pattern P1,0 corresponds to the image of the cross mark M1,0 on the reticle R, and a cross mark P0,1 corresponds to the image of the cross mark M0,1 on the reticle R. The following cross mark and cross mark pattern correspond to each other in the same manner.

After that, the X and Y coordinates of each of the plurality of cross patterns P0,0 to P8,8 formed on the wafer W are measured by the coordinate measuring machine.

In the second method, light beams emerging from the plurality of cross patterns M0,0 to M8,8 and focused on the plurality of cross patterns P0,0 to P8,8 are deflected by processing the surface shape of the distortion correction plate 10, and the plurality of cross patterns P0,0-P0,8 is changed to the ideal imaging position. The calculation of the surface shape of the specific distortion correction plate 10 will be described.

For example, the distortion correction plate 10 is arranged in the optical path between the projection optical system PL and the reticle R. This position is a position where a light beam having a comparatively smaller numerical aperture (N.A.) passes. Thus, in shifting the imaging positions by the distortion correction plate 10, only shifting of the principal ray of the beam shifted by changing the surface shape of the distortion correction plate 10 need be representatively considered.

A relationship expressed by equation (7):

w=β·LR(n−1)·θ (7)

is established where w denotes a distortion amount which is a shift amount between the ideal imaging position and the plurality of cross patterns P0,0 to P8,8 shown in FIG. 52, and θ denotes the angle change amount of the normal line of the surface of the distortion correction plate 10 at a principal ray passing point where the principal rays from the plurality of cross patterns M0,0 to M8,8 passes through the distortion correction plate 10.

Furthermore, the angle change amount θ concerns the normal line of the surface of the distortion correction plate 10 in a reference state before process, β denotes the lateral magnification of the projection optical system PL, LR denotes a distance along the optical axis between the reticle R and the surface in which the distortion correction plate 10 is processed, and n denotes the refractive index of the distortion correction plate 10. Additionally, in equation (7), the surface, in which the distortion correction plate 10 is processed, is the surface of the wafer W side.

In addition, when the distortion correction plate 10 is located in the optical path between the projection optical system PL and the wafer W, a relationship satisfying equation (8):

w=LW(n−1)·θ (8)

is established where LW is a distance along the optical axis between the wafer W and the surface in which the distortion correction plate 10 is processed.

Therefore, the plane normals at the principal ray passing points of the surface of the distortion correction plate 10 can be obtained from the distortion amount as a shift amount between the coordinates of the plurality of cross patterns P0,0 to P8,8 measured by the coordinate measuring machine described above and the ideal imaging position.

By so doing, the plane normals at the respective principal ray passing points of the distortion correction plate 10 are determined. However, the surface of the distortion correction plate 10 does not become a continuous shape. Therefore, in the second method, a continuous surface shape is obtained from the plane normals at the principal ray passing points of the distortion correction plate 10 that are obtained by equation (7), by using a curved surface interpolation equation.

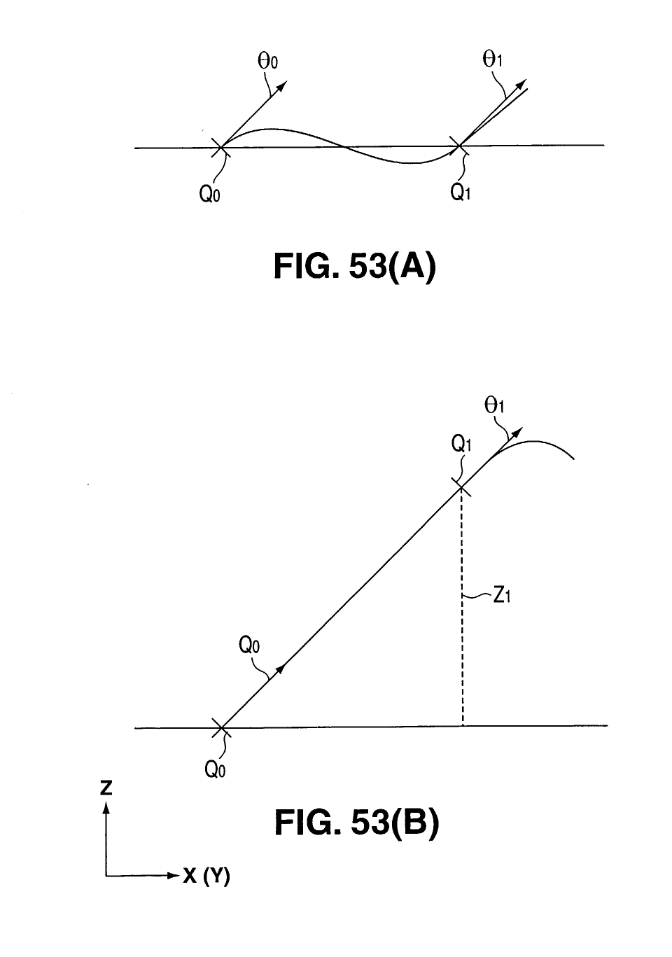

Here, various types of curved surface interpolation equations are available. Since plane normals are already known and the tangent vectors of the surface at the principal ray passing points can be calculated from the plane normals as the curved surface interpolation equation used in the second method, the Coons' equation is suitable which interpolates a curved surface with the coordinate points and tangent vectors in the coordinate points. However, for example, as shown in FIG. 53(a), if the tangent vectors θ0 and θ1 of adjacent coordinate points Q0 and Q2 are equal, there is a problem in which the interpolated curved line (curved surface) may wave.

In the second method, when the distortion amounts caused by the principal ray that pass through adjacent principal ray passing points are equal, it is effective to equalize the distortion amounts of these adjacent principal ray passing points as well. Here, if the interpolated curved line (curved surface) waves, as shown in FIG. 53(a), the amounts and directions of distortion at adjacent principal ray passing points consecutively change. Not only the random component of the distortion cannot be corrected, but also a random component of distortion between the measuring points might be further generated undesirably.

Hence, in the second method, in order to equalize the distortion amounts of adjacent principal ray passing points as well, as shown in FIG. 53(b), the vector component in the Z direction of a tangential vector θ0 at the coordinate point Q0 is added, as a height Z1 in the Z direction, to the coordinate point Q1 adjacent to the coordinate point Q0. By so doing, even if the tangential vectors of the adjacent coordinate points Q0 and Q1 are equal, the interpolated curved line becomes almost linear between these coordinate points Q0 and Q1, and the principal ray passing between these coordinate points Q0 and Q1 are refracted at almost the same angles. Accordingly, when the distortion amounts by the principal ray going through the adjacent principal ray passing points are equal, the distortion amounts can be equalized between these adjacent principal ray passing points as well.

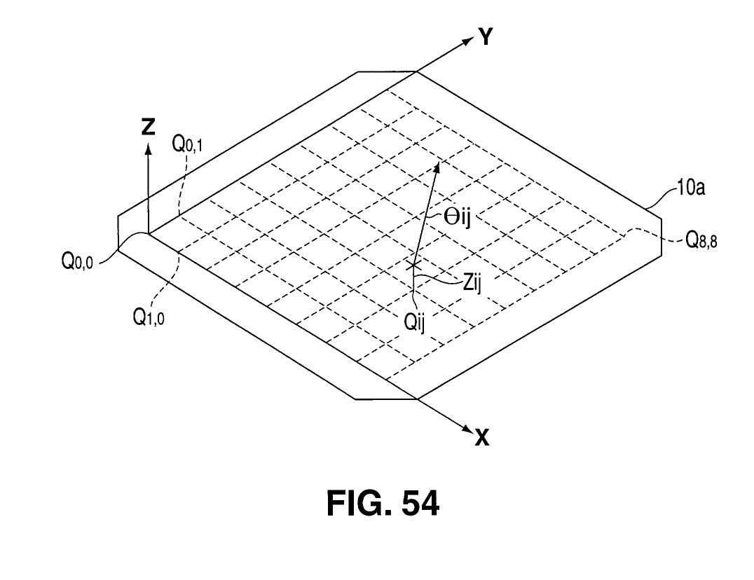

Next, the procedure of curved surface interpolation of the second method will be described in detail with reference to FIGS. 54 to 58. Furthermore, an XYZ coordinate system is used in FIGS. 54 to 58.

[Step 1]

First, as shown in FIG. 54, an XYZ coordinate is defined on a processing surface 10a of the distortion correction plate 10. Additionally, in FIG. 54, principal ray passing points Q0,0-Q8,8, through which the principal ray of the beams propagating from a plurality of cross marks M0,0 to M8,8 shown in FIG. 51 toward a plurality of cross patterns P0,0 to P8,8 shown in FIG. 52 pass, are expressed by intersection points of broken lines. Here, the normal vectors at the respective principal ray passing points Q0,0-Q8,8 obtained by the above equation (7) are expressed as θi, j(i=0-8, j=0-8, that is, θ0, 0-θ8,8 in this embodiment), and the heights of the normal vectors in the Z direction at the respective principal ray passing points Q0,0-Q8,8 are expressed as Zi, j(i=0-8, j=0-8, that is, Z0,0-Z8,8 in this method).

[Step 2]

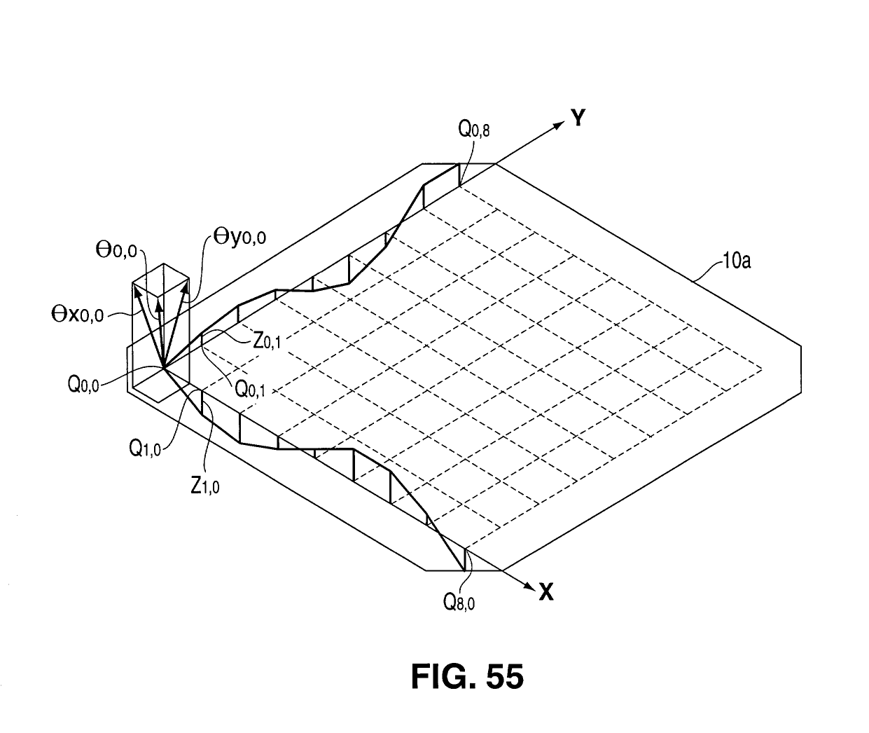

Next, as shown in FIG. 55, among the principal ray passing points, the principal ray passing point Q0,0 which is an end point on the Y axis is defined as the reference in the Z axis direction, and is set as Z0,0=0.

[Step 3]

The height Z0,1 in the Z direction in the principal ray passing point Q0,1 adjacent to the principal ray passing point Q0,0 on the Y axis is calculated, based on the normal vector θ0,0 of the principal ray passing point Q0,0 by the following equation (9):

Z0,j=Z0,j−1+θy0,j−1(y0,j−y0,j−1) (9).

Here, θy0,j denotes the vector component in the Y axis direction of the normal vector θ0,j at the principal ray passing point Q0,j and y0,j denotes the component in the Y axis direction of the coordinate value when the principal ray passing point Q0,0 on the principal ray passing point Q0,j is set as the origin.

In this step 3, the height Z0,1 in the Z direction on the principal ray passing point Q0,1 is calculated by the following equation (10) based on the above equation (9):

Z0,1=Z0,0+θy0,0(y0,1−y0,0) (10).

[Step 4]

With respect to the principal ray passing points Q0,2-Q0,8 on the Y axis, the heights Z0,2-Z0,8 in the Z direction are calculated based on the above equation (9).

[Step 5]

The height Z1,0 in the Z direction on the principal ray passing point Q1,0 adjacent to the principal ray passing point Q0,0 on the X axis is calculated by the following equation (11), based on the normal vector θ0,0 of the principal ray passing point Q0,0.

Zi,0=Zi−1,0+θxi−1,0(xi,0−xi−1,0) (11).

Here, θxi,0 denotes the vector component in the X axis direction of the normal vector θi,0 on the principal ray passing point Qi,0, and xi,0 denotes the component in the X axis direction of the coordinate value when the principal ray passing point Q0,0 on the principal ray passing point Qi,0 is set as the origin.

In this step 5, the height Z1,0 in the Z direction on the principal ray passing point Q1,0 is calculated by the following equation (12), based on equation (9)

Z1,0=Z0,0+θx0,0(x1,0−x0,0) (12).

[Step 6]

With respect to the principal ray passing points Q2,0 to Q8,0 on the X-axis, the heights Z2,0-Z8,0 in the Z direction are calculated based on the above equation (9).

[Step 7]

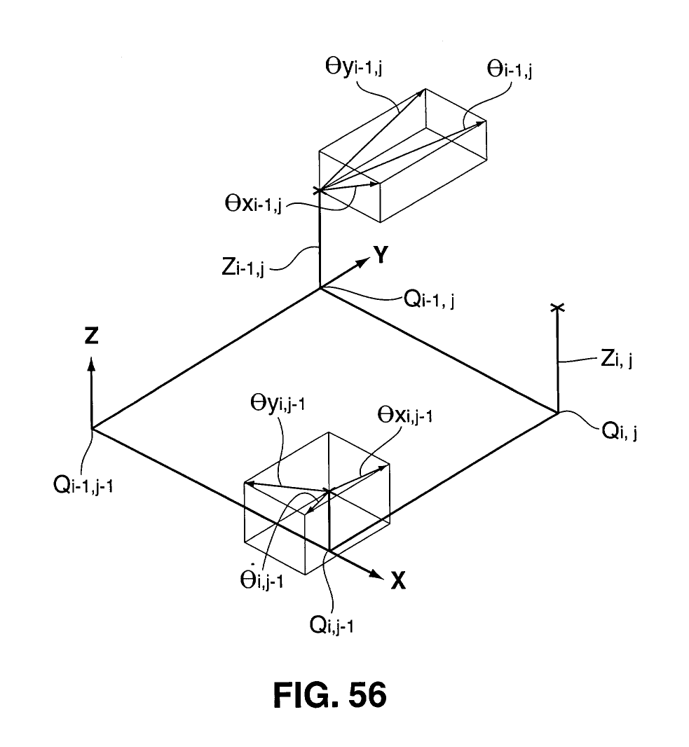

As shown in FIG. 56, the heights Zi,j in the Z direction among the principal ray passing points Q1,1-Q8,8 located between the X and Y axes are calculated starting with the one closer to the origin Q0,0 based on the following equation (13):

[Equation 4]

Zi,j={[Zi−1,j+θxi−1,J(xi,j−xi−1,j)]+[Zi,j−1+θyi,J−1(yi,j−yi,j−1)]}/2 (13).

In step 7, first, the height Z1,1 in the Z direction on the principal ray passing point Q1,1 closest to the origin Q0,0 is calculated. At this time, the height Z1,1 in the Z direction is calculated by the following equation (14) based on the above equation (13)

[Equation 5]

Z1,1={[Z0,1+θx0,1(xi,1−x0,1)]+[Z1,0+θy1,0(y1,1−y1,0)]}/2 (14).

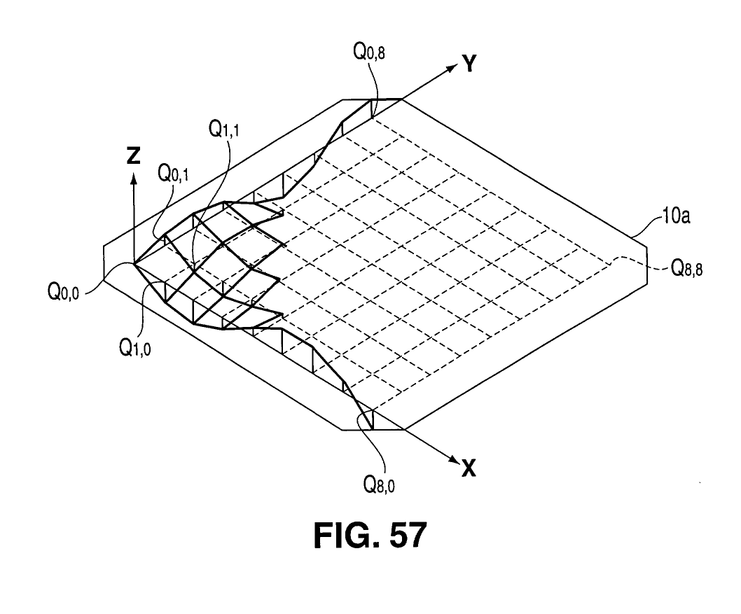

In step 7, as shown in FIG. 57, after the height Z1,1 in the Z direction of the principal ray passing point Q1,1 is calculated, the heights Z1,2, Z2,1, Z2,2 . . . Zi,j . . . Z8,8 in the Z direction of the principal ray passing points Q1,2, Q2,1, Q2,2, . . . Qi,j . . . Q8,8 are calculated starting with the one closer to the origin Q0,0 based on the above equation (13).

[Step 8]

Based on Z0,0 to Z8,8 at the principal ray passing points Q0,0-Q8,8 obtained through steps 1-7, the XY coordinates of the principal ray passing points Q0,0-Q8,8 and the tangential vectors at the principal ray passing points Q0,0-Q8,8 obtained from the plane normal vectors θ0,0-θ8,8 at the principal ray passing points Q0,0-Q8,8, a curved surface is formed in accordance with the Coons' patching method. That is, the control points of the Coons' patching method are the XYZ coordinates of the principal ray passing points Q0,0-Q8,8 and the tangent vectors are the tangent vectors calculated from the plane normal vectors θ0,0-θ8,8 at the principal ray passing points Q0,0-Q8,8.

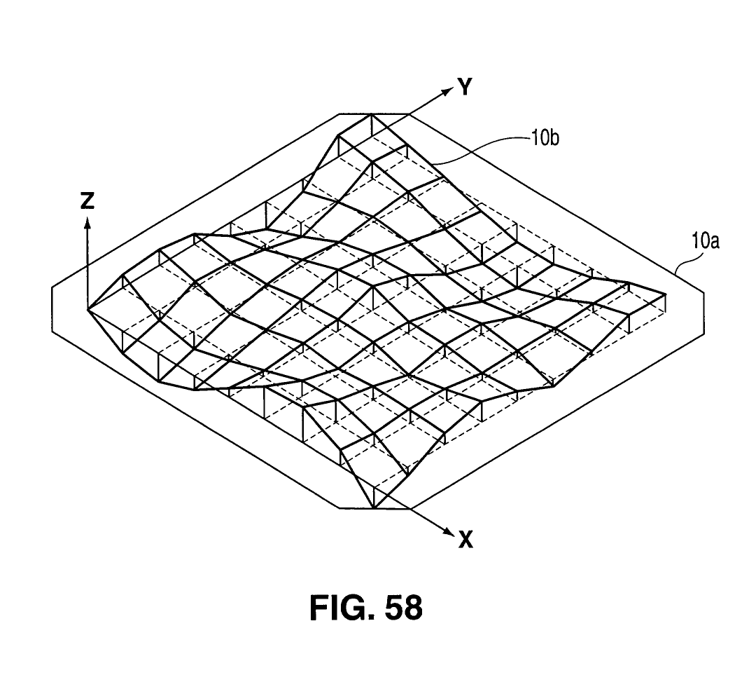

A curved surface as shown in, for example, FIG. 58 can be obtained by curved surface interpolation in accordance with the Coons' patching method of this step 8.

Furthermore, in steps 1 to 8 described above, although reference lines in X and Y directions obtained in steps 3 to 6 are on X and Y axes, respectively, it is possible that those reference lines pass through the optical axis. In this case, it is realized by the following step A between step 6 and step 7 described above.

[Step A]

An offset of the Z direction is mounted to the height of the Z direction at the principal ray passing point located on X and Y axes calculated in above-described steps 3 to 6 in order for the height in Z-direction at the optical axis passing point to become 0.

Furthermore, when the distortion measurement points, i.e., the marks on the test reticles, are not arranged on the lattice points of the square lattices, the heights in the Z direction and the plane normal vectors at lattice points on square lattices located in the interim point of the respective measurement points are interpolated. Specifically, the height of the Z direction and the plane normal vector at the distortion measurement point which surrounds the lattice point of square lattice in which the height of the Z direction and the plane normal vector should be obtained can be multiplied by the distance from the distortion measurement point to the lattice point of square lattice after the distance is weighted.

Additionally, in the above-described steps 1 to 8, only information inside the distortion measurement points is used. However, in order to further smooth the surface shape of the distortion correction plate 10 as a member to be processed, the lattice points may be set on the outermost side (a side remote from the optical axis) of the principal ray passing points among the principal ray passing points corresponding to the distortion measurement points, and the heights in the Z direction and the plane normal vector at this lattice point can be extrapolated from the height of the Z direction and the plane normal vector at the outermost principal ray passing point.

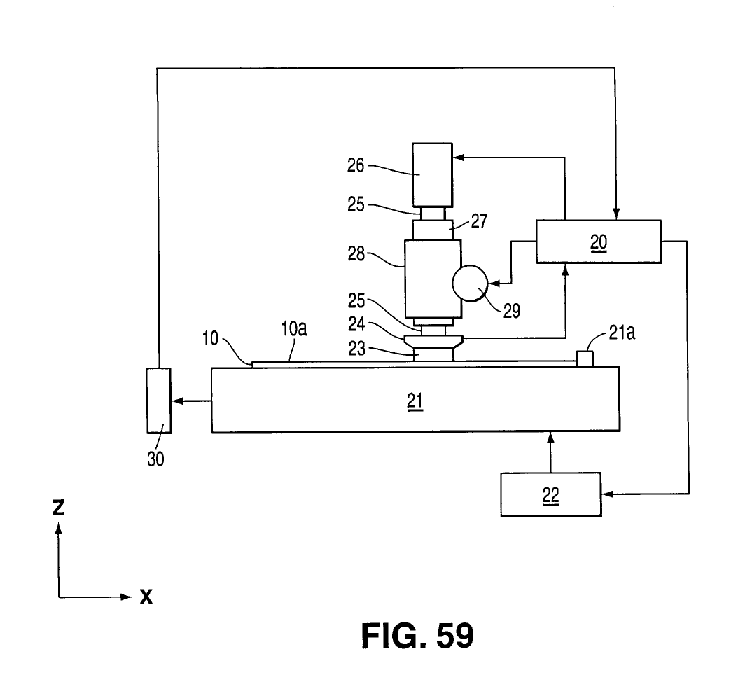

Next, the distortion correction plate 10 is removed from the projection exposure device, and processing of the surface shape of the removed distortion correction plate 10 is performed based on the surface shape data of the distortion correction plate 10 which was obtained by steps 1 to 8. Here, the distortion correction plate 10 of the second method has a random surface that waves irregularly, in order to correct the random component of the distortion. Accordingly, in the second method, a polishing device as shown in FIG. 59 is used in order to perform processing of the surface shape of the distortion correction plate 10. An XZ coordinate system as indicated in FIG. 59 is used.

Referring to FIG. 59, the distortion correction plate 10 is placed on a stage 21 movable in the X and Y directions, and the end portion is abutted against a pin 21a on the stage 21. Furthermore, a driver 22 for moving the stage 21 in the X and Y directions is controlled by a controller 20. A detector 30 comprising an encoder, an interferometer, and the like is provided to the stage 21 to detect the position of the stage 21 in the X and Y directions when the stage 21 is moved by the driver 22. A detection signal by this detector 30 is transmitted to the controller 20.

Additionally, a polisher 23 is attached to one end of a rotating shaft 25 through a holding portion 24 and is rotatable about the Z direction in the figure. A motor 26 controlled by the controller 20 is fixed to the other end of the rotating shaft 25. A bearing 27 that rotatably supports the rotating shaft 25 is provided to a support portion 28 fixed to a main body, which is not shown, to be moved in the Z direction. A motor 29 controlled by the controller 20 is fixed to the support portion 28. When the motor 29 is operated, the bearing 27 is moved in the Z direction, and accordingly the polisher 23 is moved in the Z direction, and accordingly the polisher 23 is moved in the Z direction. The holding portion 24 for holding the polisher 23 is provided with a sensor (not shown) which detects a contact pressure between the polisher 23 and the distortion correction plate 10. An output from this sensor is transmitted to the controller 20.

Next, the operation of the polishing device of FIG. 59 will be briefly described. First, surface shape data obtained by the above-described steps 1 to 8 is input to the controller 20. Thereafter, the controller 20 moves the stage 21 in the X and Y directions through the driver 22 while it rotates the polisher 23. That is, the polisher 23 is moved as the processing surface 10a of the distortion correction plate 10 is traced in the X and Y directions. At this time, the amount of abrasion of the processing surface 10a of the distortion correction plate 10 is determined by the contact pressure between the processing surface 10a and the polisher 23 and the holding time of the polisher 23.

After that, a reflection prevention film is coated, by evaporation deposition, on the distortion correction plate 10 processed by the polishing device of FIG. 59, and the processed distortion correction plate 10 is placed on the holing member of the projection optical apparatus. In the polishing device of FIG. 59, the polisher 23 is fixed in the X and Y directions. However, the polisher 23 may be moved in the X and Y directions in place of moving the stage 21 in the X and Y directions.

With the second method described above, correction of the random component of distortion, which has conventionally been impossible only with adjustment of the respective optical members constituting the projection optical system, can be performed easily.

Furthermore, in the above embodiment, as the plane-parallel plate having no refracting power is used as the distortion correction plate 10, the decentering precision of the distortion correction plate can be moderated. By so doing, even if positioning is performed by the holding member, i.e., even if positioning is determined by precision of a metallic material, sufficient optical performance can be achieved. Additionally, as the distortion correction plate 10 is a plane-parallel plate, there is an advantage in which it can be processed easily with respect to the distortion correction plate. In addition, when a lens having a predetermined curvature is used as the distortion correction plate 10, this lens preferably has a low refracting power due to the reason described above.

Furthermore, in the above embodiment, as the distortion correction plate 10 is arranged on the reticle R side (enlargement side) where the beam has a smaller numerical aperture, only shift of the principal ray is considered. However, when the distortion correction plate 10 is arranged on the wafer W side (reduction side), the processing amount for the distortion correction plate 10 is preferably determined by considering the effects of the size of the beam diameter of the position of the distortion correction plate 10. Also, in order to further improve the precision of distortion correction, even if the distortion correction plate 10 is arranged on the reticle R side, the processing amount is preferably determined in response to the beam diameter in the position of the distortion correction plate 10.

Additionally, in the above-described example, processing is performed for the distortion correction plate 10 which is mounted in the optical path during measurement to decrease the effects caused by the parts precision of the distortion correction plate 10. However, during measurement, a dummy part different from the distortion correction plate to be processed may be arranged in the optical path. In this case, however, the parts precision of the dummy part must be highly improved.

Additionally, in the above-described example, the distortion correction plate 10 is an optical member which is placed closest to the reticle of all the optical members constituting the projection optical system PL, there is an advantage that the operation of inserting and removing the distortion correction plate 10 in and from the optical path of the projection optical system PL can be performed easily.

In the above-described example, the distortion correction plate 10 is positioned with precision determined by a metallic material. In order to perform high-precision correction, a predetermined mark may be provided to part of the distortion correction plate 10, and the location with respect to the holding member (with respect to the projection optical system PL) can be optically detected. At this time, the mark is desirably provided to the distortion correction plate 10 at a position through which exposure light does not pass.

In the above examples, with respect to the correction plate, a spherical or an aspherical processing is performed for cutting or the like a surface of a plane-parallel plate having no refractive power in order to correct residual aberration (wave aberration, Seidel's five aberrations, rotational-symmetric aberration component, rotational-non-symmetric aberration component, random aberration component, and the like) in the projection optical system. By performing a spherical or an aspherical processing such as cutting of the surface of an optical member having a relatively weak refractive power, this can function as a correction plate which corrects residual aberration in the projection optical system. Further, in order to correct the residual aberrations of the projection optical system, process can also be performed in a correction surface of a correction plate without refractive power or relatively weak refractive power so that predetermined refractive power distribution can be obtained.

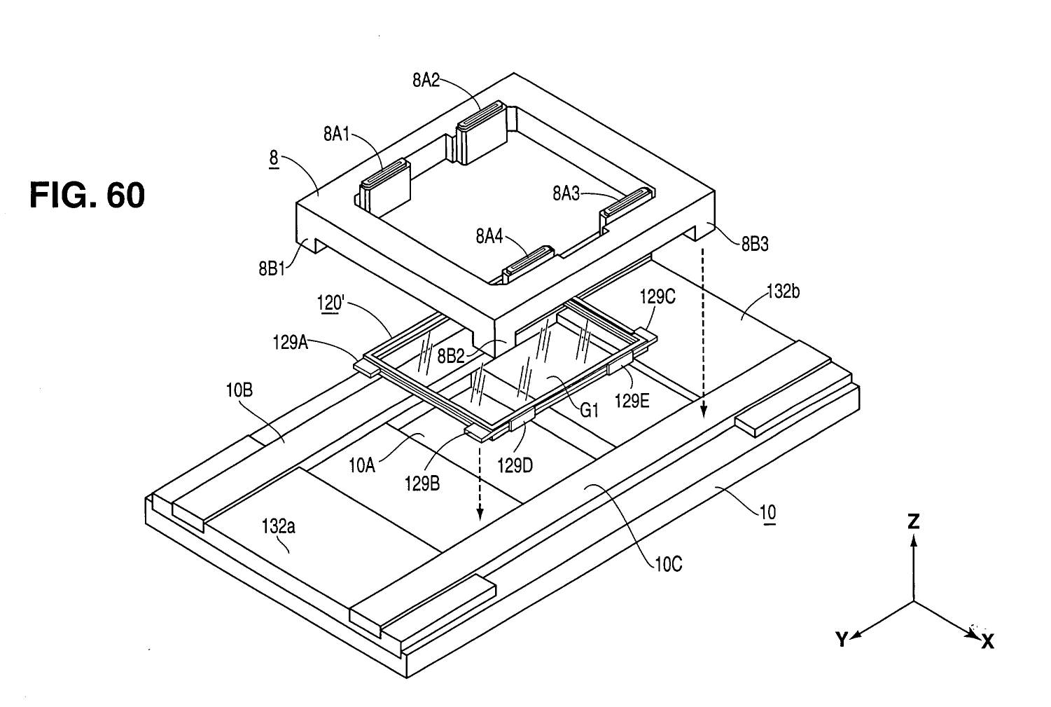

FIG. 60 is a modified example of a method for holding an image distortion correction plate G1 shown previously in FIG. 13 and is a perspective view intentionally separating each positional arrangement of the reticle stage 8, a support frame 120′ of the image distortion correction plate G1, and the surface plate 100 in the Z direction. The same symbols employed to members in the configuration of the apparatus shown in FIGS. 12 and 13 are employed to the same members. In FIG. 60, a plurality of projecting portions 8A1, 8A2, 8A3 and 8A4 for holding the reticle R horizontally are formed on the reticle stage 8 as shown previously in FIGS. 1 and 2, and vacuum-absorbing holes and grooves for adsorbing a lower surface of the reticle R are formed each upper portion of them.

Additionally, under the reticle stage 8, a plurality of air pads 8B1, 8B2, 8B3 and 8B4 (8B4 is not shown because of hiding) for forming hydrostatic gas bearing with respect to an upper guide surface of guide members 10B and 10C arranged on the surface plate 10 side are fixed. It is desirable that these air pads 8B1 to 8B4 exits air to the guide surface, a vacuum pre-loading method or combination with a magnetic pre-loading method is used, and the air bearing layer between the guide surface and the pad surface constantly has a constant gap.

The support frame 120′ of the processed image distortion correction plate G1, different from one shown in FIG. 12, is made of metallic or ceramic material forming a rectangular frame shape holding peripheral ends of the image distortion correction plate G1. The support frame 120′ is fixed horizontally to fixed (stationary) portions of the surface plate 10 through surrounding fixing parts 129A, 129B, 129C, 129D and 129E covering the opening 10A formed on the surface plate 10 between the guide members 10B and 10C on both sides.

Also, the opening 10A of the surface plate 10 is formed in a manner not to shield a rectangular-slit-shaped effective projection area EIA or a circular projection view field of the projection optical system PL located under it.

Since the surface plate 10 is arranged in a certain positional relation without moving in the Z direction with respect to the entire lens barrel of the projection optical system PL, the positional relation in the Z direction between the image distortion correction plate G1 fixed to the support frame 120′ and the lens barrel of the projection optical system PL can be made constant. However, when the support frame 120′ is fixed to the surface plate 10, the position and posture (each tilting changes about the X, Y, and Z axes, and each parallel changes in the X, Y, and Z directions) of the image distortion correction plate G1 need to be arranged accurately to a certain extent.

Therefore, adjusting a screw, which is not shown, is arranged on the respective fixing parts 129A, 129B, 129C, 129D and 129E. For example, an adjusting screw for infinitesimally adjusting a position in the Z direction individually is arranged on the respective fixing parts 129A to 129C, and an adjusting screw for infinitesimally adjusting a position in the X direction individually is arranged on the respective fixing parts 129D and 129E, so the support frame 120′ can be adjusted its position and posture with six-degree-of-freedom.

In each embodiment of the invention, one feature is that the reticle R can be adjusted in the Z direction in order to return the various aberrations with respect to imaging characteristics, which is secondary product caused by mounting the image distortion correction plate G1, to the state of aberration before mounting. Therefore, in the structure of FIG. 60, guide members 10B and 10C supporting the weight of the reticle stage 8 can be moved by several mm in the Z direction with respect to the surface plate 10.

In FIG. 60, driving mechanisms 132a and 132b for simultaneously infinitesimally moving guide members 10B and 10C are arranged both sides of guide members 10B and 10C extending in Y direction (scan exposure direction). Driving mechanisms 132a and 132b may be automatic type including actuators such as electric motor, air piston, and E core type electromagnet, or manual type combining adjusting screw, reduction link mechanism, and flexural member.

In the reticle stage structure which was described above, two methods can be considered in order to mount the support frame 120′ with the image distortion correction plate G1 to the stationary portion of the surface plate 10 from the back side. One is that the reticle stage 8 is removed from the surface plate 10, and, then, the support frame 120′ is placed from above. The other is that the reticle stage 8 is shifted to one side in Y direction on guide members 10B and 10C of the surface plate 10, and, in the state, the support frame 120′ is inserted between the reticle stage 8 and the surface plate 10.

In the former method, it is necessary to remove not only the reticle stage 8 assembled for precisely moving, but also needle of linear motor attached to it, a moving mirror receiving a laser beam from a laser interferometer for position measurement, various wiring, tubes for vacuum system, tubes for air pressure system, and the like. It is also necessary to restore and adjust these structural parts to an original state. The series of work becomes extremely large. Therefore, it is easier and more realistic work that the support frame 120′ is mounted by the latter method.

Therefore, an example of mounting the support frame 120′ by the latter method is briefly explained. The reticle stage 8 is largely shifted to one direction, the support frame 120′ is diagonally inserted to a space between the reticle stage 8 and the surface plate 10 from Y direction, and, then, the support frame 120′ is made horizontal above the opening 10A, and mounted in the stationary portion of the surface plate 10.

After that, the support frame 120′ is fixed to the surface plate 10 by applying a tool (such as screw driver or the like) to the adjusting and fixing screw attached to the respective fixing parts 129A to 129E of the support frame 120′ from the opening of the reticle stage 8 while changing position of the reticle stage 8 in the Y direction. However, in the case of retrofit, since there is no screwed hole suitable for fastening those screw in the stationary potion of the surface plate 10, another member for cramp (U shaped clipped leaf spring or the like) is prepared for fixing the respective fixing parts 129A to 129E to the surface plate 10, and the respective fixing parts 129A to 129E can be fastened to the edge portion of the opening 10A.

Thus, the image distortion correction plate G1 according to the present embodiment is prescribed its size in accordance with the reticle stage 8 and the structure of the surface plate 10, held in a rectangular shaped frame, compact support frame 120′, and is prepared for use. Therefore, the work for retrofit can be simplified, and, there are merits that downtime of the exposure apparatus becomes small and that the rate of operation does not significantly fall.

The support frame 120′ can be fixed directly within the opening of the reticle stage 8 and can be moved upward and downward (movement in Z direction) in accordance with the up and down movement (movement in Z direction) of the reticle stage 8. In such a configuration, it is advantageous for the optical characteristics of the projection system that the correction plate G1 can be approached near the reticle R. For example, it is advantageous because becomes hard to receive the side effects of the processing surface (correction surface) of the correction plate.

As described above, in the invention, a correction member for correcting residual aberrations in the projection optical system is inserted into a predetermined position in the projection optical path between the reticle and the photosensitive substrate. In order to correct optical characteristic of the projection optical system, which is degraded by inserting the optical correction plate into the projection optical path, the reticle or the photosensitive substrate is moved at a predetermined shift amount, change of the object-to-image distance is corrected, and various aberrations including spherical aberration are corrected. Additionally, the degradation of the optical characteristics of the projection optical system, which cannot be corrected enough by moving the reticle or the photosensitive substrate at a required shift amount, is corrected by adjusting optical members which structure the projection optical system.

Thus, various severely degraded aberrations such as spherical aberration and distortion caused by mounting the optical correction plate are preferably corrected, random component such as dynamic distortion characteristic is corrected, and other aberrations also return to a preferable state before mounting the optical correction plate. In other words, although a projection optical system is designed and assembled on the assumption of mounting no optical correction plate, the almost same state where a scheduled optical correction plate is mounted into a projection optical system designed on the assumption of mounting an optical correction plate is realized by moving a reticle or a photosensitive substrate at a predetermined shift amount.

Accordingly, in a projection optical system of an exposure apparatus designed on the assumption of mounting no optical correction plate, even if it is found after being assembled that unallowable random aberration component is left in the projection optical system, the imaging quality of the projection optical system can be adjusted to an extremely high degree by applying the invention.

In addition, even if a micro device with high specifications which has improved the degree of integration and minuteness can no longer be manufactured with respect to an exposure apparatus which has already been sold to device manufacturers, the specifications (imaging quality) of the projection optical system can be improved by further correcting the designed optical errors (designed residual aberration components) of the projection optical system by means of taking measures to meet to retrofit applying the invention.

Thus, even if an optical correction plate is mounted into a projection optical path to correct residual aberrations of the projection optical system, the invention makes it possible to manufacture an exposure apparatus equipped with a projection optical system adjusted in extremely high imaging quality, deterioration of optical characteristics of the projection optical system caused by mounting the optical correction plate is preferably corrected. Accordingly, it is possible to manufacture a preferable micro device, by using an exposure apparatus manufactured by the above-mentioned method, capable of exposing a reticle pattern on a photosensitive substrate with extremely high fidelity through a projection optical system with extremely high imaging quality.

What is claimed is:

1. A method for manufacturing an exposure apparatus comprising the steps of:
a providing step for providing a projection system projecting and exposing an image of a predetermined pattern formed on a reticle to a photosensitive substrate;
a setting step for setting a correction member correcting residual aberration in said projection system at a predetermined position between a reticle setting position where said reticle is set and a substrate setting position where said photosensitive substrate is set; and
a correcting step for correcting degradation of optical characteristic of said projection system caused by setting said correction member at said predetermined position;
wherein said correcting step includes a first adjusting step for adjusting at least one of said reticle setting position and said substrate setting position.

2. The method for manufacturing an exposure apparatus according to claim 1, wherein said correcting step further includes a second adjusting step for adjusting said projection system for correcting degradation of said optical characteristic unable to be corrected by said first adjusting step.

3. The method for manufacturing an exposure apparatus according to claim 1; wherein said correcting step further includes a first calculating step, prior to said setting step, for calculating an adjusting amount of at least one of said reticle setting position and said substrate setting position in order to correct degradation of said optical characteristic produced in accordance with the thickness of said correction member, and;
said first adjusting step includes a step for adjusting at least one of said reticle setting position and said substrate setting position based on first calculated information obtained in said first calculating step.

4. The method for manufacturing an exposure apparatus according to claim 1, and further comprising;
a support member arranging step, prior to said setting step, for arranging a support member supporting said correction member in order to set said correction member at said predetermined position.

5. The method for manufacturing an exposure apparatus according to claim 1; wherein said correcting step is performed prior to said setting step.

6. The method for manufacturing an exposure apparatus according to claim 1; wherein said first adjusting step includes a step for moving at least one of a reticle stage for setting said reticle to said reticle setting position and a substrate stage for setting said photosensitive substrate to said substrate setting position.

7. The method for manufacturing a micro device comprising the steps of:
a preparing step for preparing an exposure apparatus manufactured by using the method for manufacturing an exposure apparatus according to claim 1;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

8. A method for manufacturing a micro device comprising the steps of:
a preparing step for preparing an exposure apparatus manufactured by using the method for manufacturing an exposure apparatus according to claim 3;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

9. A method for manufacturing a micro device comprising the steps of:
a preparing step for preparing an exposure apparatus manufactured by using the method for manufacturing an exposure apparatus according to claim 4;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

10. The method for manufacturing a micro device comprising the steps of:
a preparing step for preparing an exposure apparatus manufactured by using the method for manufacturing an exposure apparatus according to claim 5;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

11. The method for manufacturing a micro device comprising the steps of:
a preparing step for preparing an exposure apparatus manufactured by using the method for manufacturing an exposure apparatus according to claim 6;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

12. The method for manufacturing an exposure apparatus according to claim 2;
wherein said correcting step further includes a first calculating step, prior to said setting step, for calculating an adjusting amount of at least one of said reticle setting position and said substrate setting position in order to correct degradation of said optical characteristic produced in accordance with the thickness of said correction member, and;
said first adjusting step includes a step for adjusting at least one of said reticle setting position and said substrate setting position based on first calculated information obtained in said first calculating step.

13. The method for manufacturing an exposure apparatus according to claim 2;
wherein said correcting step further includes a second calculating step, prior to said setting step, for calculating an adjusting amount of said projection system so as to correct degradation of said optical characteristic unable to be corrected by said first adjusting step; and
said second adjusting step includes a step for adjusting said projection system based on second calculated information obtained in said second calculating step.

14. The method for manufacturing an exposure apparatus according to claim 13; wherein said second adjusting step includes a step for adjusting at least one optical member of said projection system.

15. The method for manufacturing an exposure apparatus according to claim 2; wherein said second adjusting step includes a step for adjusting at least one member of said projection optical system.

16. The method for manufacturing a micro device comprising the steps of:
a preparing step for preparing an exposure apparatus manufactured by using the method for manufacturing an exposure apparatus according to claim 2;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

17. The method for manufacturing an exposure apparatus according to claim 12; wherein said correcting step further includes a second calculating step, prior to said setting step, for calculating an adjusting amount of said projection system so as to correct degradation of said optical characteristic unable to be corrected by said first adjusting step; and
said second adjusting step includes a step for adjusting said projection system based on second calculated information obtained in said second calculating step.

18. The method for manufacturing a micro device comprising the steps of:
a preparing step for preparing an exposure apparatus manufactured by using the method for manufacturing an exposure apparatus according to claim 12;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

19. The method for manufacturing an exposure apparatus according to claim 17; wherein said second adjusting step includes a step for adjusting at least one optical member of said projection system.

20. The method for manufacturing a micro device comprising the steps of:
a preparing step for preparing an exposure apparatus manufactured by using the method for manufacturing an exposure apparatus according to claim 17;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

21. The method for manufacturing an exposure apparatus according to claim 19, and further comprising;
a support member arranging step, prior to said setting step, for arranging a support member supporting said correction member in order to set said correction member at said predetermined position.

22. The method for manufacturing a micro device comprising the steps of:
a preparing step for preparing an exposure apparatus manufactured by using the method for manufacturing an exposure apparatus according to claim 19;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

23. The method for manufacturing an exposure apparatus according to claim 21; wherein said correcting step is performed prior to said setting step.

24. The method for manufacturing an exposure apparatus according to claim 23; wherein said first adjusting step further includes a step for moving at least one of a reticle stage for setting said reticle to said reticle setting position and a substrate stage for setting said photosensitive substrate to said substrate setting position.

25. A method for manufacturing an exposure apparatus comprising the steps of:
a providing step for providing a projection system projecting and exposing an image of a predetermined pattern formed on a reticle to a photosensitive substrate;
a measuring step for measuring residual aberration in said projection system;
a processing step for processing a correction member for correcting said residual aberration in said projection system based on measured information obtained in said measuring step;
an inserting step for inserting a correction member obtained in said processing step at a predetermined position between a reticle setting position where said reticle is set and a substrate setting position where said photosensitive substrate is set; and
a first adjusting step for adjusting at least one of said reticle setting position and said substrate setting position in accordance with a change in an object-to-image distance of said projection system produced by inserting said correction member.

26. The method for manufacturing an exposure apparatus according to claim 25, and further comprising;
a second adjusting step for adjusting said projection system so as to correct degradation of optical characteristic of said projection system produced by inserting said correction member in said inserting step.

27. The method for manufacturing an exposure apparatus according to claim 25, and further comprising;
a first calculating step, prior to said measuring step, said processing step and said inserting step, for calculating an amount of change in an object-to-image distance of said projection system produced by inserting said correction member;
wherein said first adjusting step includes a step, prior to said measuring step, said processing step and said inserting step, for adjusting at least one of said reticle setting position and said substrate setting position based on first calculated information obtained in said first calculating step.

28. The method for manufacturing an exposure apparatus according to claim 25, and further comprising;
a first calculating step, independent from said measuring step, said processing step and said inserting step, for calculating an amount of change in an object-to-image distance of said projection system produced by inserting said correction member;
wherein said first adjusting step includes a step for adjusting at least one of said reticle setting position and said substrate setting position based on first calculated information obtained by said first calculating step.

29. The method for manufacturing an exposure apparatus according to claim 25, and further comprising;
a support member arranging step, prior to said measuring step, for arranging a support member supporting said correction member in order to set said correction member at said predetermined position.

30. The method for manufacturing an exposure apparatus according to claim 25; wherein said first adjusting step includes a step for moving at least one of a reticle stage for setting said reticle to said reticle setting position and a substrate stage for setting said photosensitive substrate to said substrate arranging position.

31. The method for manufacturing a micro device comprising the steps of:
a preparing step for preparing an exposure apparatus manufactured by using the method for manufacturing an exposure apparatus according to claim 25;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

32. The method for manufacturing a micro device comprising the steps of:
a preparing step for preparing an exposure apparatus manufactured by using the method for manufacturing an exposure apparatus according to claim 27;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

33. The method for manufacturing a micro device comprising the steps of:
a preparing step for preparing an exposure apparatus manufactured by using the method for manufacturing an exposure apparatus according to claim 28;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

34. The method for manufacturing a micro device comprising the steps of:
a preparing step for preparing an exposure apparatus manufactured by using the method for manufacturing an exposure apparatus according to claim 29;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

35. The method for manufacturing a micro device comprising the steps of:
a preparing step for preparing an exposure apparatus manufactured by using the method for manufacturing an exposure apparatus according to claim 30;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus predetermine in said preparing step; and
a developing step for developing said photosensitive substrate exposed by said exposing step.

36. The method for manufacturing an exposure apparatus according to claim 26, and further comprising;
a first calculating step, prior to said measuring step, said processing step and said inserting step, for calculating an amount of change in an object-to-image distance of said projection system produced by inserting said correction member;
wherein said first adjusting step includes a step, prior to said measuring step, said processing step and said inserting step, for adjusting at least one of said reticle setting position and said substrate setting position based on first calculated information obtained in said first calculating step.

37. The method for manufacturing an exposure apparatus according to claim 26, and further comprising;
a second calculating step, prior to said measuring step, said processing step and said inserting step, for calculating an amount of adjustment for said projection system for correcting degradation of optical characteristic of said projection system produced by inserting said correction member;
wherein said second adjusting step includes a step, prior to said measuring step, said processing step and said inserting step, for adjusting said projection system based on second calculated information obtained in said second calculating step.

38. The method for manufacturing an exposure apparatus according to claim 26, and further comprising;
a first calculating step, independent from said measuring step, said processing step and said inserting step, for calculating an amount of change in an object-to-image distance of said projection system produced by inserting said correction member;
wherein said first adjusting step includes a step for adjusting at least one of said reticle setting position and said substrate setting position based on first calculated information obtained in said first calculating step.

39. The method for manufacturing an exposure apparatus according to claim 38, and further comprising;
a second calculating step, independent from said measuring step, said processing step and said inserting step, for calculating an amount of adjustment for said projection system so as to correct degradation of optical characteristic of said projection system produced by inserting said correction member;
wherein said second adjusting step includes a step for adjusting said projection system based on second calculated information obtained in said second calculating step.

40. The method for manufacturing a micro device comprising the steps of:
a preparing step for preparing an exposure apparatus manufactured by using the method for manufacturing an exposure apparatus according to claim 39;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

41. The method for manufacturing a micro device comprising the steps of:
a preparing step for preparing an exposure apparatus manufactured by using the method for manufacturing an exposure apparatus according to claim 26;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

42. The method for manufacturing an exposure apparatus according to claim 25, wherein said measuring step includes;
a step for measuring residual aberration in said projection system in a state in which an optical member exclusively for measurement having same optical thickness as said correction member is inserted at on said predetermined position.

43. The method for manufacturing a micro device comprising the steps of:
a preparing step for preparing an exposure apparatus manufactured by using the method for manufacturing an exposure apparatus according to claim 42;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

44. The method for manufacturing an exposure apparatus according to claim 25, wherein said measuring step includes;
a step for measuring residual aberration of said projection system in a state in which an unprocessed correction member in said processing step is being inserted into said predetermined position.

45. The method for manufacturing a micro device comprising the steps of:
a preparing step for preparing an exposure apparatus manufactured by using the method for manufacturing an exposure apparatus according to claim 44;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

46. The method for manufacturing an exposure apparatus according to claim 36, and further comprising;
a second calculating step, prior to said measuring step, said processing step and said inserting step, for calculating an amount of adjustment with respect to said projection system so as to correct degradation of optical characteristic of said projection system produced by inserting said correction member;
wherein said second adjusting step includes a step, prior to said measuring step, said processing step and said inserting step, for adjusting said projection system based on second calculated information obtained in said second calculating step.

47. The method for manufacturing an exposure apparatus according to claim 46, wherein said measuring step includes;
a step for measuring residual aberration in said projection system in a state in which an optical member exclusively for measurement having same optical thickness as said correction member is inserted into said predetermined position.

48. The method for manufacturing an exposure apparatus according to claim 46, wherein said measuring step includes;
a step for measuring residual aberration in said projection system in a state in which an unprocessed correction member in said processing step is being inserted into said predetermined position.

49. The method for manufacturing a micro device comprising the steps of:
a preparing step for preparing an exposure apparatus manufactured by using the method for manufacturing an exposure apparatus according to claim 46;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

50. A method for manufacturing an exposure apparatus comprising the steps of:
a measuring step for measuring optical capability of a projection system projecting and exposing an image of a predetermined pattern formed on a reticle to a photosensitive substrate;
an improving step for improving optical capability of said projection system based on measurement result by said measuring step;
an adjusting step for adjusting illumination characteristic for illuminating said reticle in accordance with said improving step.

51. The method for manufacturing an exposure apparatus according to claim 50, wherein said improving step includes;
an arranging step for arranging a processed correction member based on measurement result in said measuring step in order to correct residual aberration in said projection system.

52. The method for manufacturing an exposure apparatus according to claim 50, wherein said improving step includes;
a step for processing at least one optical member in said projection system based on measured result by said measuring step in order to correct residual aberration in said projection system.

53. The method for manufacturing a micro device comprising the steps of:
a preparing step for preparing an exposure apparatus manufactured by using the method for manufacturing an exposure apparatus according to claim 50;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

54. The method for manufacturing a micro device comprising the steps of:
a preparing step for preparing an exposure apparatus manufactured by using the method for manufacturing an exposure apparatus according to claim 51;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.

55. The method for manufacturing a micro device comprising the steps of:
a preparing step for preparing an exposure apparatus manufactured by using the method for manufacturing an exposure apparatus according to claim 52;
a reticle setting step for setting a reticle at said reticle setting position;
a substrate setting step for setting a photosensitive substrate at said substrate setting position;
an exposing step for exposing a pattern image of said reticle to said photosensitive substrate by using a projection system of an exposure apparatus prepared in said preparing step; and
a developing step for developing said photosensitive substrate exposed by said exposing step.
